(19) United States
(12) Patent Application Publication
(10) Pub. No.: US 2020/0285118 A1
(43) Pub. Date: Sep. 10, 2020

(54) LIQUID CRYSTAL DISPLAY

(71) Applicant: Mitsubishi Electric Corporation, Chiyoda-ku (JP)

(72) Inventors: Taro YOSHINO, Tokyo (JP); Toshiaki FUJINO, Tokyo (JP)

(73) Assignee: Mitsubishi Electric Corporation, Qhiyoda-ku (JP)

(21) Appl. No.: 16/607,239

(22) PCT Filed: Apr. 19, 2018
(86) PCT No.: PCT/JP2018/016145

§ 371 Date: Oct. 22, 2019

(30) Foreign Application Priority Data
Jun. 12, 2017 (JP) 2017-114995

(51) Int. Cl. G02F 1/1337; G02F 1/1368; G02F 1/1343

(52) U.S. Cl. CPC G02F 1/133707; G02F 2201/123; G02F 1/134309; G02F 1/1368

(57) ABSTRACT

To shorten the response time during falling time of making a transition from a state in which a horizontal field passes through a liquid crystal layer to a state in which the horizontal field does not pass through the liquid crystal layer without necessitating a complicated structure of an electrode for generating the horizontal field. A first alignment film has a main surface having an alignment capability of aligning liquid crystal molecules in a particular alignment direction. A partition is arranged on at least a first field concentrated part at a first pixel electrode, and a second field concentrated part at the second pixel electrode. A surface of a second alignment film covering the partition has an alignment capability of aligning the liquid crystal molecules in the particular alignment direction. The partition partitions the liquid crystal layer in a direction parallel to an extension direction of the liquid crystal layer.

### TECHNICAL FIELD

The present invention relates to a liquid crystal display.

### BACKGROUND ART

In a common liquid crystal display of a horizontal field system, a liquid crystal layer is arranged between a polarizer adjacent to an incoming surface and a polarizer adjacent to an outgoing surface. The polarizer adjacent to the outgoing surface has a polarizing axis perpendicular to the polarizing axis of the polarizer adjacent to the incoming surface. Thus, as the birefringence amount of a liquid crystal layer becomes greater, light having been transmitted through the polarizer adjacent to the incoming surface and the liquid crystal layer sequentially becomes capable of being transmitted through the polarizer adjacent to the outgoing surface more easily. In this way, the light transmittance of a liquid crystal panel is increased.

In the liquid crystal display of the horizontal field system, an alignment film is provided for alignment of liquid crystal molecules in such a manner that a liquid crystal director, which shows an alignment direction for liquid crystal molecules which forms the liquid crystal layer and is a uniaxial and optical index ellipsoid, is placed in an extinction position. Hence, when a horizontal field does not pass through the liquid crystal layer, the liquid crystal director is in the extinction position and the birefringence amount of the liquid crystal layer becomes minimum. In this case, the light transmittance of the liquid crystal panel becomes minimum. Meanwhile, when the horizontal field passes through the liquid crystal layer, the liquid crystal director is rotated from the extinction position in a horizontal plane and the birefringence amount of the liquid crystal layer is increased, thereby increasing the light transmittance of the liquid crystal panel.

In the liquid crystal display of the horizontal field system, the light transmittance of the liquid crystal panel is increased by rotating the liquid crystal director in a horizontal plane. This characteristically results in small change between directions of observation in terms of the brightness or contrast of image displayed on the liquid crystal panel. For this reason, the liquid crystal display of the horizontal field system has a wide viewing angle.

The horizontal field system includes an in-plane switching (IPS (registered trademark)) system, a fringe-field switching (FFS) system, and systems derived from these systems.

In a liquid crystal display of the IPS system, two line-like electrodes forming a slit electrode are in the same layer, extend in the same extension direction, face each other, and function as liquid crystal driving electrodes. One of the two line-like electrodes is given a signal potential. The other of the two line-like electrodes is given a ground potential. A horizontal field responsive to the applied signal potential is generated between the two line-like electrodes. The generated horizontal field rotates the liquid crystal director from the extinction position in a horizontal plane to increase the birefringence amount of the liquid crystal layer, thereby increasing the light transmittance of the liquid crystal panel.

In the liquid crystal display of the IPS system, however, the liquid crystal director is rotated from the extinction position mainly by the horizontal field generated between the two line-like electrodes. Hence, a field for rotating the liquid crystal director from the extinction position is not generated on the two line-like electrodes, so that the liquid crystal director is always in the extinction position on the two line-like electrodes. This causes substantially no passage of light through a region where the two line-like electrodes are arranged after the light enters the liquid crystal panel from a backlight, for example. Further, an electric line of force of the horizontal field does not follow a completely horizontal line but it follows a upwardly convex gentle curve. This fails to provide the liquid crystal layer with a birefringence amount uniform between the two line-like electrodes. Hence, even if the signal potential becomes a potential for maximizing the light transmittance of the liquid crystal panel, the light transmittance of the liquid crystal panel still has a drop between the two line-like electrodes. Due to these circumstances, the liquid crystal display of the IPS system finds difficulty in increasing the maximum light transmittance of the liquid crystal panel.

In a liquid crystal display of the FFS system, a line-like electrode forming a slit electrode is in a layer above an insulating layer and a sheet-like electrode is in a layer below the insulating layer. The line-like electrode and the sheet-like electrode function as liquid crystal driving electrodes. The line-like electrode is given a signal potential. The sheet-like electrode is given a ground potential. A fringe field responsive to the applied signal potential is generated between the line-like electrode and the sheet-like electrode. The generated fringe field rotates the liquid crystal director from the extinction position in a horizontal plane to increase the birefringence amount of the liquid crystal layer, thereby increasing the light transmittance of the liquid crystal panel.

Additionally, in the liquid crystal display of the FFS system, the liquid crystal director is rotated from the extinction position by the fringe field generated between the line-like electrode and the sheet-like electrode, extending over a wide range, and following an upwardly convex curve. This generates a field on the line-like electrode for rotating the liquid crystal director from the extinction position, so that the liquid crystal director can be placed in a position other than the extinction position, also on the line-like electrode. For this reason, the liquid crystal display of the FFS system makes it possible to increase the maximum light transmittance of the liquid crystal panel more easily than the liquid crystal display of the IPS system.

In the liquid crystal display of the horizontal field system, an angle of rotation of the liquid crystal director is large. This causes a disadvantage that response speed is low, compared to a liquid crystal display of a system such as a twisted nematic (TN) system or a vertical alignment (VA) system, for example. This advantage becomes notable particularly during the falling time of making a transition from a state in which a horizontal field passes through a liquid crystal layer to a state in which the horizontal field does not pass through the liquid crystal layer.

The following explains reason why the disadvantage of low response speed notable particularly during the falling time. In a common liquid crystal display of the horizontal field system in which a driving voltage is set at 0 V for display of black and the driving voltage is set at a maximum driving voltage for display of white, during rising time of making a transition from a state in which a horizontal field does not pass through a liquid crystal layer to a state in which the horizontal field passes through the liquid crystal layer, response speed can be increased by applying an overdrive voltage to a liquid crystal driving electrode for generating a horizontal field. During the falling time, however, response speed is governed by anchoring energy for aligning liquid crystal molecules in such a manner as to place the liquid crystal director in the extinction position and by the elasticity and viscosity of liquid crystal forming the liquid crystal layer, making it difficult to increase response speed.

A technique disclosed in patent document 1 is an example of a technique used for eliminating such a disadvantage.

In the technique disclosed in patent document 1, a plurality of rectangular openings (26A) is provided at a common electrode (26). The rectangular openings (26A) extend in the same extension direction and face a pixel electrode (24). One long side of the opening (26A) faces the other long side of the opening (26A) in the width direction of the opening (26A). Liquid crystal molecules in a neighboring region of the one long side of the opening (26A) are rotated and aligned in the opposite direction to liquid crystal molecules in a neighboring region of the other long side of the opening (26A). By doing so, response speed is increased (paragraph 0018).

### PRIOR ART DOCUMENTS

### Patent Documents

Patent Document 1: Japanese Patent Application Laid-Open No. 2013-109309

### SUMMARY

### Problem to be Solved by the Invention

The conventional technique represented by the technique disclosed in patent document 1 allows increase in response speed, even during the falling time of making a transition from a state in which a horizontal field passes through the liquid crystal layer to a state in which the horizontal field does not pass through the liquid crystal layer.

However, the conventional technique represented by the technique disclosed in patent document 1 necessitates a complicated structure of the liquid crystal driving electrode for generating a horizontal field, so that an advanced patterning technique is required for forming the liquid crystal driving electrode.

The present invention is intended to solve this problem. The problem to be solved by the present invention is to shorten response time during falling time of making a transition from a state in which a horizontal field passes through a liquid crystal layer to a state in which the horizontal field does not pass through the liquid crystal layer in a liquid crystal display of a horizontal field system without necessitating a complicated structure of an electrode for generating a horizontal field.

### Means to Solve the Problem

A first aspect of the present invention relates to a liquid crystal display.

The liquid crystal display includes a first substrate, a second substrate, and a liquid crystal layer. The liquid crystal layer is caught between the first substrate and the second substrate and contains liquid crystal molecules.

The first substrate includes a first pixel electrode, a second pixel electrode, and an insulating film. The first pixel electrode includes line-like segments extending in a particular direction. The second pixel electrode includes a sheet-like electrode involved in a field from the first pixel electrode. The insulating film separates the first pixel electrode from the second pixel electrode in the thickness direction of the first substrate to insulate the first pixel electrode from the second pixel electrode.

The first substrate includes a first alignment film. The first alignment film has a main surface forming a main surface of the first substrate, contacting the liquid crystal layer, and having an alignment capability of aligning the liquid crystal molecules in a particular alignment direction.

The first substrate includes first line-like partitions and second line-like partitions. The first line-like partitions are arranged on the line-like segments of the first pixel electrode and extend in a direction substantially parallel to a direction of the first alignment film. The second line-like partitions are arranged between the line-like segments of the first pixel electrode and extend in a direction substantially parallel to the direction of the first alignment film.

The first substrate includes a second alignment film. The second alignment film covers the first line-like partitions and the second line-like partitions, and has a surface contacting the liquid crystal layer and having an alignment capability of aligning the liquid crystal molecules in the particular alignment direction.

A second aspect of the present invention relates to a liquid crystal display.

The liquid crystal display includes a first substrate, a second substrate, and a liquid crystal layer. The liquid crystal layer is caught between the first substrate and the second substrate and contains liquid crystal molecules.

The first substrate includes a first pixel electrode and a second pixel electrode. The first pixel electrode includes line-like segments extending in a particular direction. The second pixel electrode extends in an extension direction substantially parallel to the first pixel electrode and includes line-like segments arranged alternately with the line-like segments of the first pixel electrode.

The first substrate includes a first alignment film. The first alignment film has a main surface forming a main surface of the first substrate, contacting the liquid crystal layer, and having an alignment capability of aligning the liquid crystal molecules in a particular alignment direction.

The first substrate includes first line-like partitions and second line-like partitions. The first line-like partitions are arranged on the line-like segments of the first pixel electrode and substantially parallel to a direction of the first alignment film. The second line-like partitions are arranged on the line-like segments of the second pixel electrode and substantially parallel to the direction of the first alignment film.

The first substrate includes a second alignment film. The second alignment film covers the first line-like partitions and the second line-like partitions, and has a surface contacting the liquid crystal layer and having an alignment capability of aligning the liquid crystal molecules in the particular alignment direction.

A third aspect of the present invention relates to a liquid crystal display.

The liquid crystal display includes a first substrate, a second substrate, and a liquid crystal layer. The liquid crystal layer is caught between the first substrate and the second substrate and contains liquid crystal molecules.

The first substrate includes a first pixel electrode and a second pixel electrode. The first pixel electrode includes line-like segments extending in a particular direction. The second pixel electrode extends in an extension direction substantially parallel to the first pixel electrode and includes line-like segments arranged alternately with the line-like segments of the first pixel electrode.

The first substrate includes a first alignment film. The first alignment film has a main surface forming a main surface of the first substrate, contacting the liquid crystal layer, and having an alignment capability of aligning the liquid crystal molecules in a particular alignment direction.

The first substrate includes line-like partitions. The line-like partitions are arranged on the line-like segments of the first pixel electrode and substantially parallel to a direction of the first alignment film.

The first substrate includes a second alignment film. The second alignment film covering the line-like partitions, and has a surface contacting the liquid crystal layer and having an alignment capability of aligning the liquid crystal molecules in the particular alignment direction.

A fourth aspect of the present invention relates to a liquid crystal display.

The liquid crystal display includes a first substrate, a second substrate, and a liquid crystal layer. The liquid crystal layer is caught between the first substrate and the second substrate and contains liquid crystal molecules.

The first substrate includes line-like partitions. The line-like partitions are arranged on line-like segments of a first pixel electrode and extend in a direction substantially parallel to a direction of a first alignment film.

The first substrate includes the first pixel electrode, a second pixel electrode, and an insulating film. The first pixel electrode includes the line-like segments extending in a particular direction. The second pixel electrode includes a sheet-like electrode involved in a field from the first pixel electrode. The insulating film separates the first pixel electrode from the second pixel electrode in the thickness direction of the first substrate to insulate the first pixel electrode from the second pixel electrode.

The first substrate includes the first alignment film. The first alignment film has a main surface forming a main surface of the first substrate, contacting the liquid crystal layer, and having an alignment capability of aligning the liquid crystal molecules in a particular alignment direction.

The first substrate includes the line-like partitions. The line-like partitions are arranged on the line-like segments of the first pixel electrode and extend in the direction substantially parallel to the direction of the first alignment film.

The first substrate includes a second alignment film. The second alignment film covers the line-like partitions, and has a surface contacting the liquid crystal layer and having an alignment capability of aligning the liquid crystal molecules in the particular alignment direction.

A fifth aspect of the present invention relates to a liquid crystal display.

The liquid crystal display includes a first substrate, a second substrate, and a liquid crystal layer. The liquid crystal layer is caught between the first substrate and the second substrate and contains liquid crystal molecules.

The first substrate includes a first pixel electrode, a second pixel electrode, and an insulating film. The first pixel electrode includes line-like segments extending in a particular direction. The second pixel electrode includes a sheet-like electrode involved in a field from the first pixel electrode. The insulating film separates the first pixel electrode from the second pixel electrode in the thickness direction of the first substrate to insulate the first pixel electrode from the second pixel electrode.

The first substrate includes a first alignment film. The first alignment film has a main surface forming a main surface of the first substrate, contacting the liquid crystal layer, and having an alignment capability of aligning the liquid crystal molecules in a particular alignment direction.

The substrate includes line-like partitions. The line-like partitions are arranged between the line-like segments of the first pixel electrode and extend in a direction substantially parallel to a direction of the first alignment film.

The first substrate includes a second alignment film. The second alignment film covers the line-like partitions, and has a surface contacting the liquid crystal layer and having an alignment capability of aligning the liquid crystal molecules in the particular alignment direction.

### Effects of the Invention

According to the present invention, in the liquid crystal display of the horizontal field system, return of a liquid crystal director to an extinction position is encouraged by the alignment capability of the surface of the alignment film covering the partition during falling time of making a transition from a state in which a horizontal field passes through the liquid crystal layer to a state in which the horizontal field does not pass through the liquid crystal layer. This makes it possible to shorten response time during the falling time without necessitating a complicated structure of an electrode for generating the horizontal field.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a perspective view illustrating a liquid crystal display of each of a first to sixth embodiments.

FIG. 2 is a sectional view illustrating a section of a liquid crystal panel provided in the liquid crystal display of each of the first to sixth embodiments.

FIG. 3 is a plan view illustrating a thin film transistor (TFT) substrate, a printed board, and an integrated circuit chip provided in the liquid crystal display of each of the first to sixth embodiments.

FIG. 4 is a plan view illustrating planar arrangement of a line, an electrode, and a semiconductor channel layer provided in the liquid crystal display of each of the first and third embodiments.

FIG. 5 is a plan view illustrating planar arrangement of an organic planarizing film, a partition, and an alignment film provided in the liquid crystal display of the first embodiment.

FIG. 6 is a sectional view illustrating a TFT substrate and a liquid crystal layer provided in the liquid crystal display of the first embodiment.

FIG. 7 is a sectional view illustrating the TFT substrate and the liquid crystal layer provided in the liquid crystal display of the first embodiment.

FIG. 8 is a sectional view illustrating the TFT substrate and the liquid crystal layer provided in the liquid crystal display of the first embodiment.

FIG. 9 is a schematic view illustrating a structure model used for theoretically analyzing response speed during falling time in the absence of a partition such as the partition provided in the liquid crystal display of the first embodiment.

FIG. 10 is a schematic view illustrating a structure model used for theoretically analyzing response speed during the falling time in the absence of a partition such as the partition provided in the liquid crystal display of the first embodiment.

FIG. 11 is a schematic view illustrating a structure model used for theoretically analyzing response speed during the falling time in the presence of a partition such as the partition provided in the liquid crystal display of the first embodiment.

FIG. 12 is a schematic view illustrating a structure model used for theoretically analyzing response speed during the falling time in the presence of a partition such as the partition provided in the liquid crystal display of the first embodiment.

FIG. 13 is a sectional view illustrating a section of a structure model used for analyzing response speed during the falling time by simulation in the absence of a partition such as the partition provided in the liquid crystal display of the first embodiment.

FIG. 14 is a sectional view illustrating a section of a structure model used for analyzing response speed during the falling time by simulation in the presence of a partition such as the partition provided in the liquid crystal display of the first embodiment.

FIG. 15 is a graph showing response curves obtained by evaluating response characteristics using the structure model in the absence of a partition illustrated in FIG. 13 and the structure model in the presence of a partition illustrated in FIG. 14.

FIG. 16 is a sectional view illustrating a section of a structure model used for analyzing response speed during the falling time by simulation in the presence of a partition such as the partition provided in the liquid crystal display of the first embodiment.

FIG. 17 is a graph showing change in a rising period and a falling period resulting from the height of a partition determined by evaluating response characteristics using the structure model illustrated in FIG. 16.

FIG. 18 is a plan view illustrating planar arrangement of a line, an electrode, and a semiconductor channel layer provided in the liquid crystal display of each of the second and fourth to sixth embodiments.

FIG. 19 is a plan view illustrating planar arrangement of an organic planarizing film, a partition, and an alignment film provided in the liquid crystal display of the second embodiment.

FIG. 20 is a sectional view illustrating a TFT substrate and a liquid crystal layer provided in the liquid crystal display of the second embodiment.

FIG. 21 is a sectional view illustrating the TFT substrate and the liquid crystal layer provided in the liquid crystal display of the second embodiment.

FIG. 22 is a sectional view illustrating the TFT substrate and the liquid crystal layer provided in the liquid crystal display of the second embodiment.

FIG. 23 is a sectional view illustrating a section of a structure model used for analyzing response speed during the falling time by simulation in the absence of a partition such as the partition provided in the liquid crystal display of the second embodiment.

FIG. 24 is a sectional view illustrating a section of a structure model used for analyzing response speed during the falling time by simulation in the presence of a partition such as the partition provided in the liquid crystal display of the second embodiment.

FIG. 25 is a graph showing response curves obtained by evaluating response characteristics using the structure model in the absence of a partition illustrated in FIG. 23 and the structure model in the presence of a partition illustrated in FIG. 24.

FIG. 26 is a plan view illustrating planar arrangement of an organic planarizing film, an electrode, a partition, and an alignment film provided in the liquid crystal display of the third embodiment.

FIG. 27 is a sectional view illustrating a TFT substrate and a liquid crystal layer provided in the liquid crystal display of the third embodiment.

FIG. 28 is a sectional view illustrating the TFT substrate and the liquid crystal layer provided in the liquid crystal display of the third embodiment.

FIG. 29 is a sectional view illustrating the TFT substrate and the liquid crystal layer provided in the liquid crystal display of the third embodiment.

FIG. 30 is a sectional view illustrating a section of a structure model used for analyzing response speed during the falling time by simulation in the presence of a partition such as the partition provided in the liquid crystal display of the third embodiment.

FIG. 31 is a graph showing response curves obtained by evaluating response characteristics using the structure model in the absence of a partition illustrated in FIG. 13 and the structure model in the presence of a partition illustrated in FIG. 30.

FIG. 32 is a plan view illustrating planar arrangement of an organic planarizing film, a partition, and an alignment film provided in the liquid crystal display of the fourth embodiment.

FIG. 33 is a sectional view illustrating a TFT substrate and a liquid crystal layer provided in the liquid crystal display of the fourth embodiment.

FIG. 34 is a sectional view illustrating the TFT substrate and the liquid crystal layer provided in the liquid crystal display of the fourth embodiment.

FIG. 35 is a sectional view illustrating the TFT substrate and the liquid crystal layer provided in the liquid crystal display of the fourth embodiment.

FIG. 36 is a sectional view illustrating a section of a structure model used for analyzing response speed during the falling time by simulation in the presence of a partition such as the partition provided in the liquid crystal display of the fourth embodiment.

FIG. 37 is a graph showing response curves obtained by evaluating response characteristics using the structure model in the absence of a partition illustrated in FIG. 23 and the structure model in the presence of a partition illustrated in FIG. 36.

FIG. 38 is a plan view illustrating planar arrangement of an organic planarizing film, an electrode, a partition, and an alignment film provided in the liquid crystal display of the fifth embodiment.

FIG. 39 is a sectional view illustrating a TFT substrate and a liquid crystal layer provided in the liquid crystal display of the fifth embodiment.

FIG. 40 is a sectional view illustrating the TFT substrate and the liquid crystal layer provided in the liquid crystal display of the fifth embodiment.

FIG. 41 is a sectional view illustrating the TFT substrate and the liquid crystal layer provided in the liquid crystal display of the fifth embodiment.

FIG. 42 is a sectional view illustrating a section of a structure model used for analyzing response speed during the falling time by simulation in the presence of a partition such as the partition provided in the liquid crystal display of the fifth embodiment.

FIG. 43 is a graph showing response curves obtained by evaluating response characteristics using the structure model in the absence of a partition illustrated in FIG. 23 and the structure model in the presence of a partition illustrated in FIG. 42.

FIG. 44 is a graph showing response curves resulting from replacement with a liquid crystal layer made of negative-type liquid crystal and obtained by evaluating response characteristics using the structure model in the absence of a partition illustrated in FIG. 23 and the structure model in the presence of a partition illustrated in FIG. 24.

### DESCRIPTION OF EMBODIMENT(S)

### 1. First Embodiment

1.1 Liquid Crystal Display

A first embodiment relates to a liquid crystal display of a horizontal field system (lateral field system).

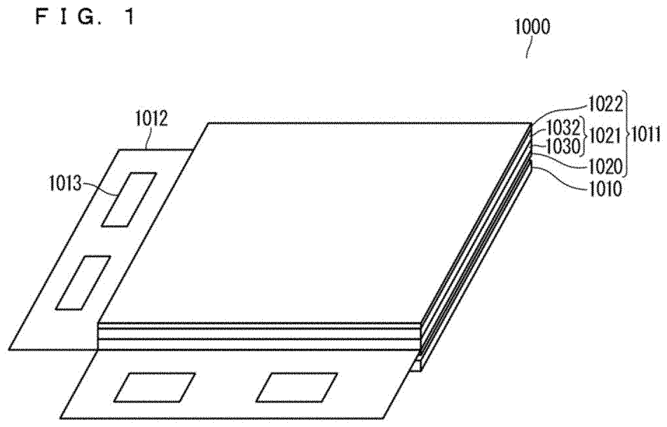

The schematic view of FIG. 1 is a perspective view illustrating the liquid crystal display of the first embodiment.

A liquid crystal display 1000 illustrated in FIG. 1 is a transmissive liquid crystal display and includes a backlight 1010, a liquid crystal panel 1011, a printed board 1012, and an integrated circuit chip 1013. The liquid crystal display 1000 may include a structure other than these structures. A technique described below may be employed in a reflective or semi-transmissive liquid crystal display.

For display of an image on the liquid crystal display 1000, the backlight 1010 emits light. The emitted light enters one main surface of the liquid crystal panel 1011. After entering the one main surface of the liquid crystal panel 1011, the light is transmitted through the liquid crystal panel 1011. After being transmitted through the liquid crystal panel 1011, the light exits through the other main surface of the liquid crystal panel 1011.

For display of an image on the liquid crystal display 1000, an image signal is input to the liquid crystal display 1000, and the light transmittance of the liquid crystal panel 1011 is controlled using the input image signal.

As a result of the foregoing, the image responsive to the input image signal is displayed on the other main surface of the liquid crystal panel 1011.

1.2 Liquid Crystal Panel

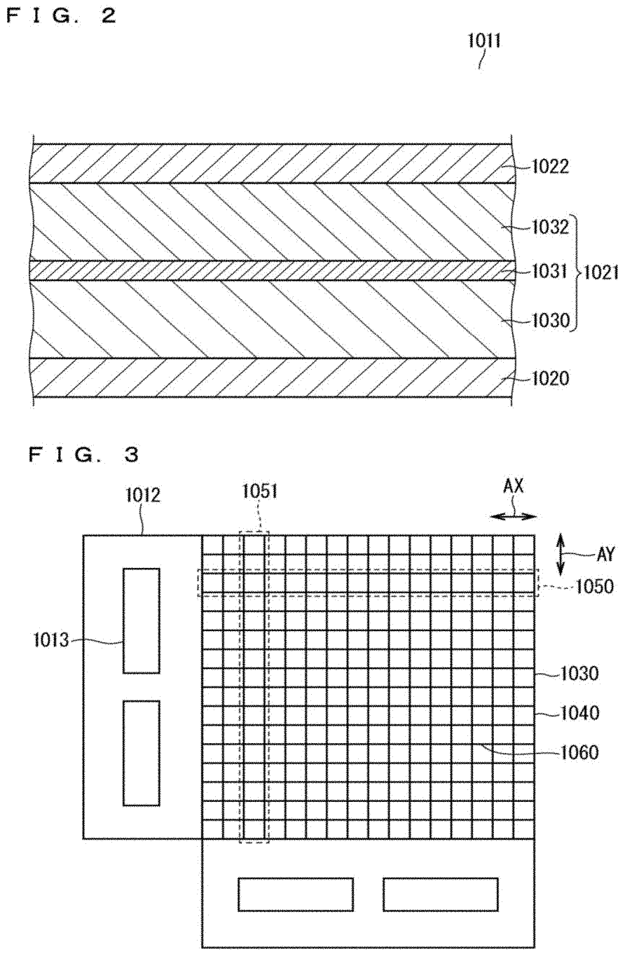

The schematic view of FIG. 2 is a sectional view illustrating a section of the liquid crystal panel provided in the liquid crystal display of the first embodiment.

As illustrated in FIGS. 1 and 2, the liquid crystal panel 1011 includes a polarizer 1020, a liquid crystal cell 1021, and a polarizer 1022. The liquid crystal panel 1011 may include a structure other than these structures.

As illustrated in FIGS. 1 and 2, the liquid crystal cell 1021 includes a thin film transistor (TFT) substrate 1030 as a first substrate, a liquid crystal layer 1031, and a color filter (CF) substrate 1032 as a second substrate. The liquid crystal cell 1021 may include a structure other than these structures.

The liquid crystal layer 1031 is made of positive-type liquid crystal and caught between the inner main surface of the TFT substrate 1030 and the inner main surface of the CF substrate 1032. The polarizer 1020 is affixed to the outer main surface of the TFT substrate 1030. The polarizer 1022 is affixed to the outer main surface of the CF substrate 1032.

For display of an image on the liquid crystal display 1000, light emitted from the backlight 1010 is transmitted through the polarizer 1020, the TFT substrate 1030, the liquid crystal layer 1031, the CF substrate 1032, and the polarizer 1022 sequentially.

For display of an image on the liquid crystal display 1000, a horizontal field to be applied to the liquid crystal layer 1031 is controlled using an image signal input to the liquid crystal display 1000. The birefringence amount of the liquid crystal layer 1031 is controlled using the applied horizontal field, and the light transmittance of the liquid crystal panel 1011 is controlled using the birefringence amount of the liquid crystal layer 1031. In this way, the light transmittance of the liquid crystal panel 1011 is controlled using the input image signal.

The printed board 1012 and the integrated circuit chip 1013 are arranged on the periphery of the TFT substrate 1030.

1.3 Display Region

The schematic view of FIG. 3 is a plan view illustrating the TFT substrate, the printed board, and the integrated circuit chip provided in the liquid crystal display of the first embodiment.

As illustrated in FIG. 3, the TFT substrate 1030 has a display region 1040 for display of images.

The display region 1040 includes a plurality of pixel regions arranged in a matrix. More specifically, the display region 1040 includes each pixel-regions-array 1050 consists of a plurality of pixel regions arranged in a direction indicated by an arrow AX, and each pixel-regions-array 1051 consists of a plurality of pixel regions arranged in a direction indicated by an arrow AY. Directions indicated by the arrows AX and AY are parallel to extension directions of the TFT substrate 1030, the liquid crystal layer 1031, and the CF substrate 1032. The direction indicated by the arrow AY is perpendicular to the direction indicated by the arrow AX. The maxis arrangement may be replaced with arrangement not in a matrix pattern.

1.4 TFT Substrate

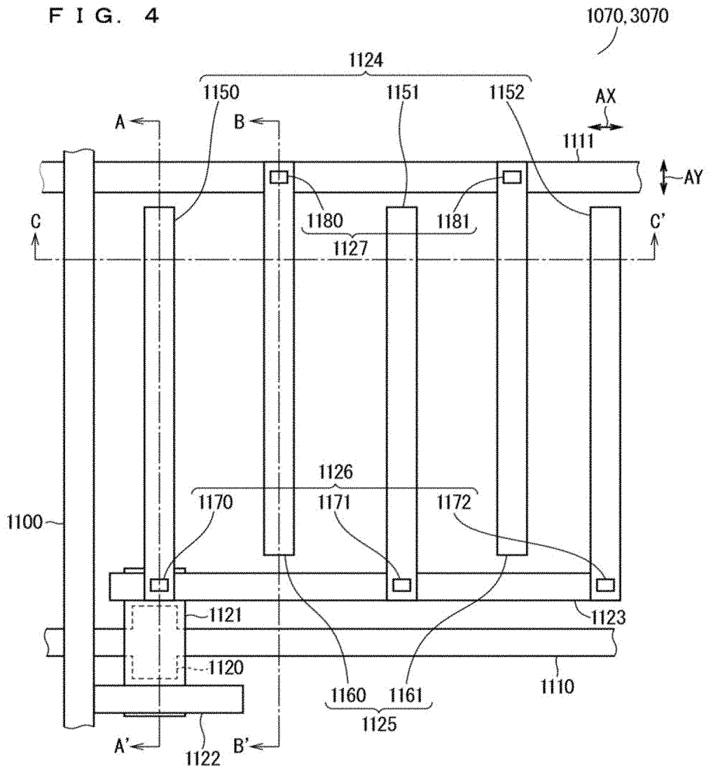

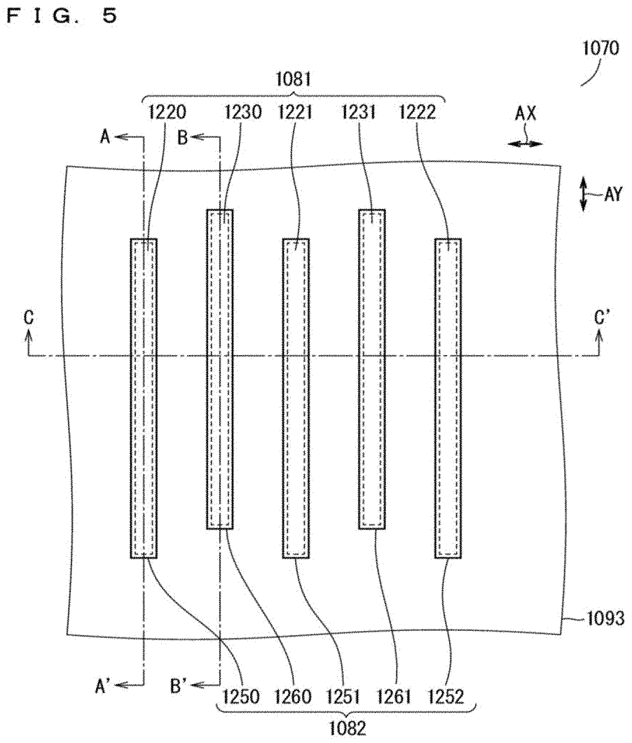

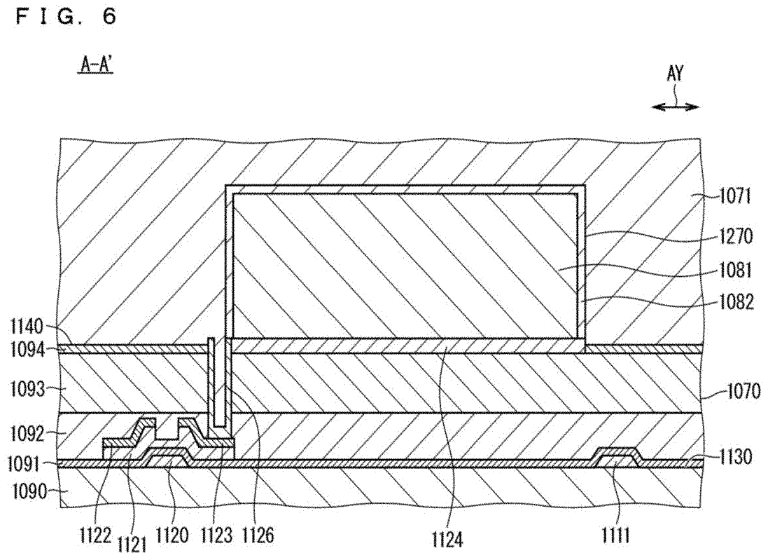

The schematic view of FIG. 4 is a plan view illustrating planar arrangement of a line, an electrode, and a semiconductor channel layer provided in the liquid crystal display of the first embodiment. The schematic view of FIG. 5 is a plan view illustrating planar arrangement of an organic planarizing film, a partition, and an alignment film provided in the liquid crystal display of the first embodiment. FIGS. 6, 7, and 8 are sectional views each illustrating sections of the TFT substrate and the liquid crystal layer provided in the liquid crystal display of the first embodiment.

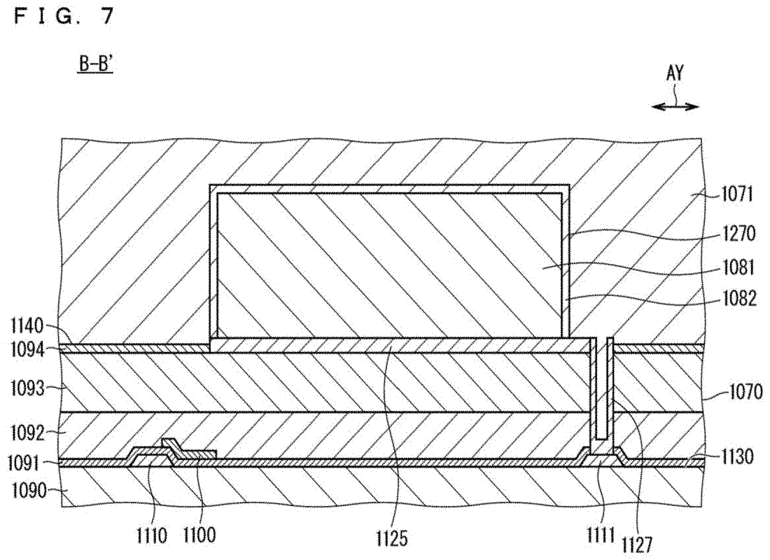

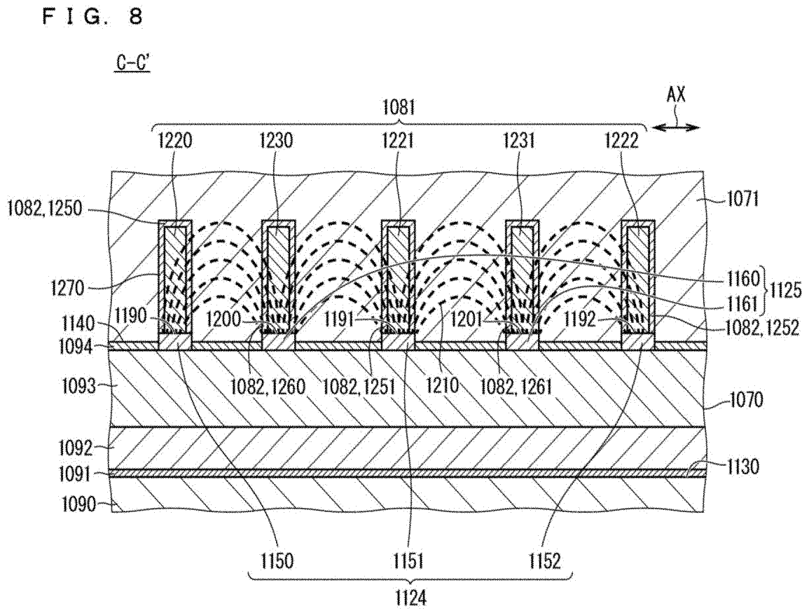

FIG. 6 illustrates a section taken at a position along a cutting line A-A′ in FIGS. 4 and 5. FIG. 7 illustrates a section taken at a position along a cutting line B-B′ in FIGS. 4 and 5. FIG. 8 illustrates a section taken at a position along a cutting line C-C′ in FIGS. 4 and 5.

FIGS. 4, 5, 6, 7, and 8 illustrate each pixel region 1060 forming the display region 1040 illustrated in FIG. 3.

A TFT substrate 1070 illustrated in FIGS. 4, 5, 6, 7, and 8 becomes the TFT substrate 1030 illustrated in FIGS. 1, 2, and 3. A liquid crystal layer 1071 illustrated in FIGS. 6, 7, and 8 becomes the liquid crystal layer 1031 illustrated in FIG. 2.

FIG. 4 illustrates an image signal line 1100, a scanning line 1110, a common potential line 1111, a scanning line electrode 1120, a semiconductor channel layer 1121, an image signal line electrode 1122, an image signal line electrode 1123, an image signal line slit electrode 1124, a common potential line slit electrode 1125, an image signal line through hole group 1126, and a common potential line through hole group 1127 provided in the TFT substrate 1070.

FIG. 5 illustrates an organic planarizing film 1093, a partition 1081, and an alignment film 1082 provided in the TFT substrate 1070.

FIG. 6 illustrates a glass substrate 1090, a scanning line insulating film 1091, an interlayer insulating film 1092, the organic planarizing film 1093, an alignment film 1094, the common potential line 1111, the scanning line electrode 1120, the semiconductor channel layer 1121, the image signal line electrode 1122, the image signal line electrode 1123, the image signal line slit electrode 1124, the image signal line through hole group 1126, the partition 1081, and the alignment film 1082 provided in the TFT substrate 1070.

FIG. 7 illustrates the glass substrate 1090, the scanning line insulating film 1091, the interlayer insulating film 1092, the organic planarizing film 1093, the alignment film 1094, the image signal line 1100, the scanning line 1110, the common potential line 1111, the common potential line slit electrode 1125, the common potential line through hole group 1127, the partition 1081, and the alignment film 1082 provided in the TFT substrate 1070.

FIG. 8 illustrates the glass substrate 1090, the scanning line insulating film 1091, the interlayer insulating film 1092, the organic planarizing film 1093, the alignment film 1094, the image signal line slit electrode 1124, the common potential line slit electrode 1125, the partition 1081, and the alignment film 1082 provided in the TFT substrate 1070.

The image signal line 1100 is at each pixel-regions-array 1051 illustrated in FIG. 3. The scanning line 1110 and the common potential line 1111 are at each pixel-regions-array 1050 illustrated in FIG. 3. The scanning line electrode 1120, the semiconductor channel layer 1121, the image signal line electrode 1122, the image signal line electrode 1123, the image signal line slit electrode 1124, the common potential line slit electrode 1125, the image signal line through hole group 1126, the common potential line through hole group 1127, the partition 1081, and the alignment film 1082 are at each pixel region 1060 illustrated in FIG. 3.

The TFT substrate 1070 may include a structure other than these structures. The scanning line insulating film 1091, the scanning line electrode 1120, the semiconductor channel layer 1121, the image signal line electrode 1122, and the image signal line electrode 1123 form a TFT. The TFT may be replaced with a switching element other than a TFT. The image signal line slit electrode 1124 and the common potential line slit electrode 1125 form a pixel electrode.

The glass substrate 1090 illustrated in FIGS. 6, 7, and 8 is made of glass and have transparency and insulating properties. The glass substrate 1090 may be replaced with a substrate made of a material other than glass and having transparency and insulating properties.

The scanning line 1110 is arranged on an upper main surface 1130 of the glass substrate 1090 as illustrated in FIG. 7, extends in the direction indicated by the arrow AX as illustrated in FIG. 4, and extends across a plurality of pixel regions forming each pixel-regions-array 1050 illustrated in FIG. 3.

The common potential line 1111 is arranged on the upper main surface 1130 of the glass substrate 1090 as illustrated in FIGS. 6 and 7, extends in the direction indicated by the arrow AX as illustrated in FIG. 4, and extends across a plurality of pixel regions forming each pixel-regions-array 1050 illustrated in FIG. 3.

The scanning line electrode 1120 is arranged on the upper main surface 1130 of the glass substrate 1090 as illustrated in FIG. 6. As illustrated in FIG. 4, the scanning line electrode 1120 contacts the scanning line 1110 and is electrically connected to the scanning line 1110.

The scanning line insulating film 1091 is stacked on the scanning line 1110, the common potential line 1111, and the scanning line electrode 1120 and arranged over the upper main surface 1130 of the glass substrate 1090 as illustrated in FIGS. 6, 7, and 8, and extends across a plurality of pixel regions forming the display region 1040 illustrated in FIG. 3. The scanning line insulating film 1091 separates the scanning line 1110, the common potential line 1111, and the scanning line electrode 1120 under the scanning line insulating film 1091 in the thickness direction of the TFT substrate 1070 from the image signal line 1100, the semiconductor channel layer 1121, the image signal line electrode 1122, and the image signal line electrode 1123 over the scanning line insulating film 1091, thereby insulating the scanning line 1110, the common potential line 1111, and the scanning line electrode 1120 from the image signal line 1100, the semiconductor channel layer 1121, the image signal line electrode 1122, and the image signal line electrode 1123.

The image signal line 1100 is stacked on the scanning line insulating film 1091 and arranged over the upper main surface 1130 of the glass substrate 1090 as illustrated in FIG. 7, and extends across a plurality of pixel regions forming each pixel-regions-array 1051 illustrated in FIG. 3.

As illustrated in FIG. 6, the semiconductor channel layer 1121 is stacked on the scanning line insulating film 1091 and arranged over the upper main surface 1130 of the glass substrate 1090. The semiconductor channel layer 1121 faces the scanning line electrode 1120 across the scanning line insulating film 1091.

As illustrated in FIG. 6, the image signal line electrode 1122 is stacked on the scanning line insulating film 1091 and the semiconductor channel layer 1121 and arranged over the upper main surface 1130 of the glass substrate 1090. As illustrated in FIG. 4, the image signal line electrode 1122 contacts the image signal line 1100 and the semiconductor channel layer 1121 and is electrically connected to the image signal line 1100 and the semiconductor channel layer 1121.

As illustrated in FIG. 6, the image signal line electrode 1123 is stacked on the scanning line insulating film 1091 and the semiconductor channel layer 1121 and arranged over the upper main surface 1130 of the glass substrate 1090. As illustrated in FIG. 4, the image signal line electrode 1123 contacts the semiconductor channel layer 1121 and is electrically connected to the semiconductor channel layer 1121.

As illustrated in FIGS. 6, 7, and 8, the interlayer insulating film 1092 is stacked on the scanning line insulating film 1091, the image signal line 1100, the semiconductor channel layer 1121, the image signal line electrode 1122, and the image signal line electrode 1123 and arranged over the upper main surface 1130 of the glass substrate 1090. The interlayer insulating film 1092 separates the image signal line 1100, the semiconductor channel layer 1121, the image signal line electrode 1122, and the image signal line electrode 1123 under the interlayer insulating film 1092 in the thickness direction of the TFT substrate 1070 from the image signal line slit electrode 1124 and the common potential line slit electrode 1125 over the interlayer insulating film 1092, thereby insulating the image signal line 1100, the semiconductor channel layer 1121, the image signal line electrode 1122, and the image signal line electrode 1123 from the image signal line slit electrode 1124 and the common potential line slit electrode 1125.

As illustrated in FIGS. 6, 7, and 8, the organic planarizing film 1093 is stacked on the interlayer insulating film 1092 and arranged over the upper main surface 1130 of the glass substrate 1090.

As illustrated in FIGS. 6, 7, and 8, the alignment film 1094 is stacked on the organic planarizing film 1093 and arranged over the upper main surface 1130 of the glass substrate 1090. The alignment film 1094 has an upper main surface 1140 forming the upper main surface of the TFT substrate 1070 and contacting the liquid crystal layer 1071. The upper main surface 1140 of the alignment film 1094 is subjected to alignment process by means of a rubbing or photo-alignment method, for example. Thus, the upper main surface 1140 of the alignment film 1094 has an alignment capability of aligning liquid crystal molecules in the liquid crystal layer 1071 in a particular alignment direction.

As illustrated in FIGS. 6 and 8, the image signal line slit electrode 1124 is stacked on the organic planarizing film 1093 and arranged over the upper main surface 1130 of the glass substrate 1090. The image signal line slit electrode 1124 is a comb-like electrode and includes a line-like electrode 1150, a line-like electrode 1151, and a line-like electrode 1152 illustrated in FIGS. 4 and 8. The three line-like electrodes including the line-like electrodes 1150, 1151, and 1152 may be replaced with two line-like electrodes or less, or four line-like electrodes or more. As illustrated in FIG. 4, each of the line-like electrodes 1150, 1151, and 1152 is a line-like segment having a line-like planar shape as viewed in the thickness direction of the TFT substrate 1070 and extending in a particular extension direction indicated by the arrow AY. As illustrated in FIGS. 4 and 8, the line-like electrodes 1150, 1151, and 1152 are arranged in an arrangement direction indicated by the arrow AX.

As illustrated in FIGS. 7 and 8, the common potential line slit electrode 1125 is stacked on the organic planarizing film 1093 and arranged over the upper main surface 1130 of the glass substrate 1090. The common potential line slit electrode 1125 is a comb-like electrode extending in a direction substantially parallel to the image signal line slit electrode 1124, and includes a line-like electrode 1160 and a line-like electrode 1161 illustrated in FIGS. 4 and 8. The two line-like electrodes including the line-like electrodes 1160 and 1161 may be replaced with one line-like electrode, or three line-like electrodes or more. As illustrated in FIG. 4, each of the line-like electrodes 1160 and 1161 is a line-like segment having a line-like planar shape as viewed in the thickness direction of the TFT substrate 1070 and extending in a particular extension direction indicated by the arrow AY, like each of the line-like electrodes 1150, 1151, and 1152. As illustrated in FIGS. 4 and 8, like the line-like electrodes 1150, 1151, and 1152, the line-like electrodes 1160 and 1161 are arranged in an arrangement direction indicated by the arrow AX.

As illustrated in FIGS. 4 and 8, the image signal line slit electrode 1124 and the common potential line slit electrode 1125 are arranged in such a manner that the line-like electrodes belonging to the image signal line slit electrode 1124 and the line-like electrodes belonging to the common potential line slit electrode 1125 are arranged alternately as viewed in the thickness direction of the TFT substrate 1070.

As illustrated in FIG. 6, the image signal line through hole group 1126 penetrates the interlayer insulating film 1092, the organic planarizing film 1093, and the alignment film 1094. The image signal line through hole group 1126 includes an image signal line through hole 1170, an image signal line through hole 1171, and an image signal line through hole 1172 illustrated in FIG. 4. Each of the image signal line through holes 1170, 1171, and 1172 extends in the thickness direction of the TFT substrate 1070. As illustrated in FIG. 4, the image signal line through holes 1170, 1171, and 1172 contact the image signal line electrode 1123, contact the line-like electrodes 1150, 1151, and 1152 respectively at their one end portions, and electrically connect the line-like electrodes 1150, 1151, and 1152 respectively to the image signal line electrode 1123.

As illustrated in FIG. 7, the common potential line through hole group 1127 penetrates the interlayer insulating film 1092, the organic planarizing film 1093, and the alignment film 1094. The common potential line through hole group 1127 includes a common potential line through hole 1180 and a common potential line through hole 1181 illustrated in FIG. 4. Each of the common potential line through holes 1180 and 1181 extends in the thickness direction of the TFT substrate 1070. As illustrated in FIG. 4, the common potential line through holes 1180 and 1181 contact the common potential line 1111, contact the line-like electrodes 1160 and 1161 respectively at their one end portions, and electrically connect the line-like electrodes 1160 and 1161 respectively to the common potential line 1111.

1.5 Generation of Horizontal Field

In the TFT, in response to application of an ON signal to the scanning line electrode 1120 to become a gate electrode illustrated in FIGS. 4 and 6, the image signal line electrode 1122 to become a drain illustrated in FIGS. 4 and 6 and the image signal line electrode 1123 to become a source illustrated in FIGS. 4 and 6 become electrically continuous with each other. In response to application of an OFF signal to the scanning line electrode 1120 to become the gate, the image signal line electrode 1122 to become the drain and the image signal line electrode 1123 to become the source become electrically discontinuous with each other.

When the image signal line electrode 1122 and the image signal line electrode 1123 become electrically continuous with each other, the image signal line slit electrode 1124 illustrated in FIGS. 4, 6, and 8 is given a signal potential as a first potential applied from the image signal line 1100 illustrated in FIGS. 4 and 7 through the image signal line electrode 1122, the semiconductor channel layer 1121, the image signal line electrode 1123, and the image signal line through hole group 1126 illustrated in FIGS. 4 and 6.

The common potential line slit electrode 1125 illustrated in FIGS. 4, 7, and 8 is given a common potential as a second potential different from the first potential and applied from the common potential line 1111 illustrated in FIGS. 4, 6 and 7 through the common potential line through hole group 1127 illustrated in FIGS. 4 and 7.

Thus, in response to application of an ON signal to the scanning line electrode 1120, a driving voltage is applied between the image signal line slit electrode 1124 and the common potential line slit electrode 1125.

When the driving voltage is applied between the image signal line slit electrode 1124 as a first pixel electrode and the common potential line slit electrode 1125 as a second pixel electrode, a horizontal field is generated between a field concentrated part 1200 as a second field concentrated part occupying a substantially entire upper surface of the line-like electrode 1160, and a field concentrated part 1190 and a field concentrated part 1191 as a first field concentrated part respectively occupying substantially entire upper surfaces of the line-like electrodes 1150 and 1151 adjacent to the line-like electrode 1160, as illustrated in FIG. 8. Further, a horizontal field is generated between a field concentrated part 1201 as the second field concentrated part occupying a substantially entire upper surface of the line-like electrode 1161, and the field concentrated part 1191 and a field concentrated part 1192 as the first field concentrated part respectively occupying substantially entire upper surfaces of the line-like electrodes 1151 and 1152 adjacent to the line-like electrode 1161. The generated horizontal fields pass through the liquid crystal layer 1071, as indicated by electric lines of force 1210 illustrated in FIG. 8.

1.6 Partition

The partition 1081 includes a line-like partition 1220, a line-like partition 1221, and a line-like partition 1222 illustrated in FIGS. 5 and 8. The line-like partitions 1220, 1221, and 1222 as a first line-like partition are arranged on the line-like electrodes 1150, 1151, and 1152 respectively and are substantially parallel to the direction of the alignment film 1094. The line-like partitions 1220, 1221, and 1222 may be formed only in partial regions on the line-like electrodes 1150, 1151, and 1152 respectively. As illustrated in FIG. 5, each of the line-like partitions 1220, 1221, and 1222 has a line-like planar shape as viewed in the thickness direction of the TFT substrate 1070 and extends in the extension direction indicated by the arrow AY, like the field concentrated parts 1190, 1191, and 1192. As illustrated in FIG. 8, the line-like partitions 1220, 1221, and 1222 are arranged on the field concentrated parts 1190, 1191, and 1192 respectively. As illustrated in FIG. 8, each of the line-like partitions 1220, 1221, and 1222 partitions the liquid crystal layer 1071 in a partitioning direction indicated by the arrow AX.

The partition 1081 further includes a line-like partition 1230 and a line-like partition 1231 illustrated in FIGS. 5 and 8. The line-like partitions 1230 and 1231 as a second line-like partition are arranged on the line-like electrodes 1160 and 1161 respectively and are substantially parallel to the direction of the alignment film 1094. The line-like partitions 1230 and 1231 may be formed only in partial regions on the line-like electrodes 1160 and 1161 respectively. As illustrated in FIG. 5, each of the line-like partitions 1230 and 1231 has a line-like planar shape as viewed in the thickness direction of the TFT substrate 1070 and extends in the extension direction indicated by the arrow AY, like the field concentrated parts 1200 and 1201. As illustrated in FIG. 8, the line-like partitions 1230 and 1231 are arranged on the field concentrated parts 1200 and 1201 respectively. As illustrated in FIG. 8, each of the line-like partitions 1230 and 1231 partitions the liquid crystal layer 1071 in a partitioning direction indicated by the arrow AX.

The alignment film 1082 includes a line-like alignment film 1250, a line-like alignment film 1251, a line-like alignment film 1252, a line-like alignment film 1260, and a line-like alignment film 1261 illustrated in FIGS. 5 and 8. As illustrated in FIGS. 5 and 8, the line-like alignment films 1250, 1251, 1252, 1260, and 1261 cover the line-like partitions 1220, 1221, 1222, 1230, and 1231 respectively. As illustrated in FIGS. 6, 7, and 8, the alignment film 1082 has a surface 1270 contacting the liquid crystal layer 1071. The surface 1270 of the alignment film 1082 is subjected to alignment process by means of a rubbing or photo-alignment method, for example. Thus, the surface 1270 of the alignment film 1082 has an alignment capability of aligning liquid crystal molecules in the liquid crystal layer 1071 in a particular direction. A direction in which liquid crystal molecules are aligned in the surface 1270 of the alignment film 1082 as a second alignment film agrees with a direction in which liquid crystal molecules are aligned in the upper main surface 1140 of the alignment film 1094 as a first alignment film. The alignment film 1082 is desirably a photo-alignment film subjected to alignment process by means of a photo-alignment method.

The partition 1081 illustrated in FIGS. 5, 6, 7, and 8 desirably has a height of two-thirds or more of a liquid crystal cell gap as a gap between a part of the TFT substrate 1070 other than the partition 1081 and the alignment film 1082, and the CF substrate 1032. The reason for this will be described later.

1.7 Alignment of Liquid Crystal Molecules

When a driving voltage is not applied between the image signal line slit electrode 1124 illustrated in FIGS. 4, 6, and 8 and the common potential line slit electrode 1125 illustrated in FIGS. 4, 7, and 8 so a horizontal field does not pass through the liquid crystal layer 1071 illustrated in FIGS. 6, 7 and 8, liquid crystal molecules in the liquid crystal layer 1071 are aligned in a pixel direction by the alignment capabilities of the upper main surface 1140 of the alignment film 1094 and the surface 1270 of the alignment film 1082 illustrated in FIGS. 6, 7, and 8 and a liquid crystal director is in an extinction position. This minimizes the birefringence amount of the liquid crystal layer 1071 to minimize the light transmittance of each pixel region 1060 illustrated in FIG. 3.

When a driving voltage is applied between the image signal line slit electrode 1124 and the common potential line slit electrode 1125 so a horizontal field passes through the liquid crystal layer 1071, the liquid crystal molecules in the liquid crystal layer 1071 are rotated from the pixel direction using the horizontal field to rotate the liquid crystal director from the extinction position in a horizontal plane. This increases the birefringence amount of the liquid crystal layer 1071 to increase the light transmittance of each pixel region 1060.

In the liquid crystal display 1000, during falling time of making a transition from a state in which a horizontal field passes through the liquid crystal layer 1071 to a state in which the horizontal field does not pass through the liquid crystal layer 1071, return of the liquid crystal director to the extinction position is encouraged not only by the alignment capability of the upper main surface 1140 of the alignment film 1094 but also by the alignment capability of the surface 1270 of the alignment film 1082, thereby shortening response time during the falling time. Further, this effect can be achieved without necessitating a complicated structure of the pixel electrode.

1.8 Replacement with Line-Like Partition Having Forward Tapered Shape

If the alignment capability of the surface 1270 of the alignment film 1082 illustrated in FIGS. 6, 7, and 8 is achieved by employing a photo-alignment system, the line-like partitions 1220, 1221, 1222, 1230, and 1231 each having a side surface pointed in the extension direction of the TFT substrate 1070 may be replaced, according to an alignment condition, with line-like partitions each having a side surface pointed in a direction tilted from the extension direction of the TFT substrate 1070. Namely, each of the line-like partitions 1220, 1221, 1222, 1230, and 1231 may be replaced with a line-like partition having a forward tapered shape with a width that gets smaller with a greater distance from the TFT substrate 1070. This replacement causes light to easily impinge on a part of the alignment film 1082 covering a side surface of the line-like partition, making it possible to give an alignment capability to the surface 1270 of the alignment film 1082 easily by means of alignment process using an ultraviolet ray.

1.9 Replacement with Line-Like Electrode or Line-Like Partition Further Functioning as Light Shield

To suppress leakage of light due to instability of the direction of the liquid crystal director occurring near the line-like partitions 1220, 1221, 1222, 1230, and 1231 illustrated in FIGS. 5 and 8, the line-like electrodes 1150, 1151, 1152, 1160, and 1161 illustrated in FIGS. 5 and 8 having the same widths as the line-like partitions 1220, 1221, 1222, 1230, and 1231 respectively may be replaced with line-like electrodes having greater widths than the line-like partitions 1220, 1221, 1222, 1230, and 1231. This replacement makes the line-like electrode further function as a light shield to suppress leakage of light. Alternatively, each of the line-like partitions 1220, 1221, 1222, 1230, and 1231 may be replaced with a line-like partition having a forward tapered shape made of a non-transparent material. This replacement makes the line-like partition further function as a light shield to suppress leakage of light.

1.10 Theoretical Analysis of Response Speed During Falling Time

As described above, in the liquid crystal display 1000, return of the liquid crystal director to the extinction position is encouraged during the falling time not only by the alignment capability of the upper main surface 1140 of the alignment film 1094 illustrated in FIGS. 6, 7, and 8 but also by the alignment capability of the surface 1270 of the alignment film 1082 illustrated in FIGS. 6, 7, and 8, thereby increasing response speed during the falling time. In the following description, response speed during the falling time in the absence of a partition such as the partition 1081 and response speed during the falling time in the presence of a partition such as the partition 1081 are theoretically analyzed to show that response time during the falling time in the presence of a partition such as the partition 1081 is about half of response time during the falling time in the absence of a partition such as the partition 1081.

1.11 Theoretical Analysis of Response Speed During Falling Time in the Absence of Partition

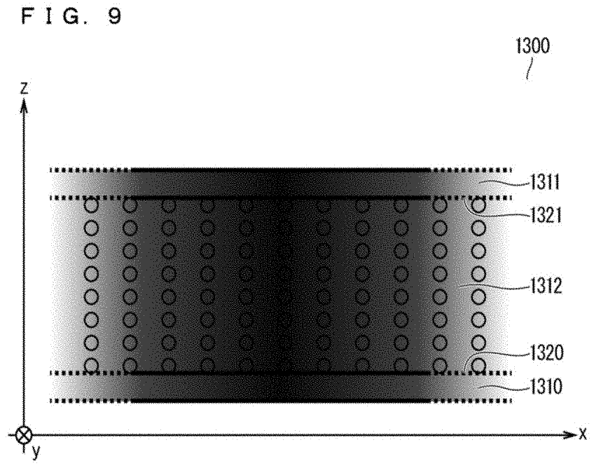

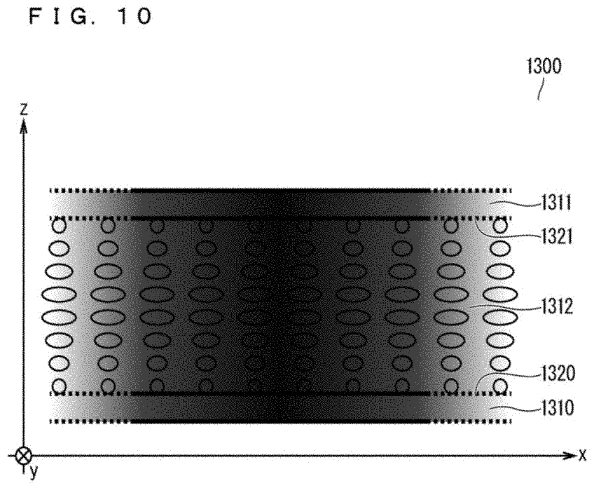

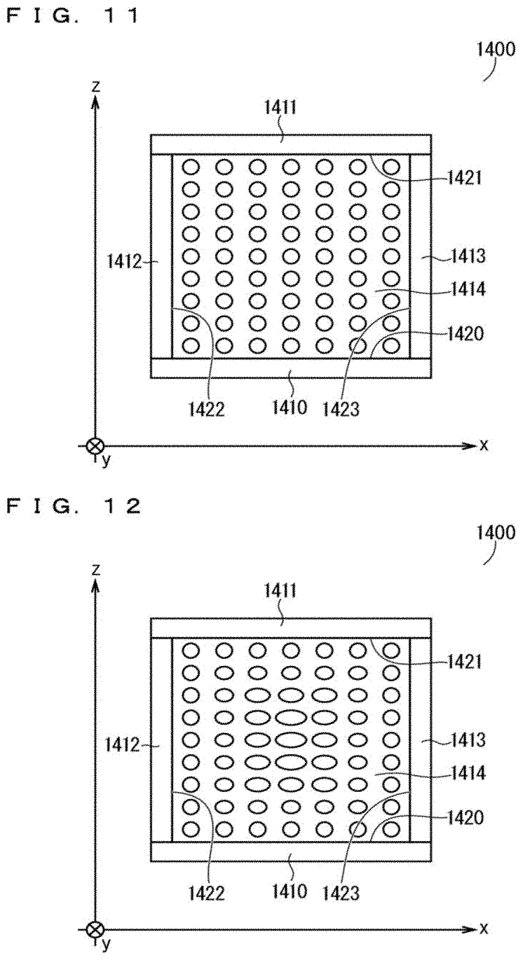

FIGS. 9 and 10 are schematic views each illustrating a structure model used for theoretically analyzing response speed during the falling time in the absence of a partition.

FIGS. 9 and 10 each show a state on an xz plane (xz two-dimensional space) in xyz three-dimensional space in which an xyz three-dimensional orthogonal coordinate system is defined. FIG. 9 shows a state in which a horizontal field in a direction parallel to the x axis does not pass through a liquid crystal layer. FIG. 10 shows a state in which a horizontal field in the direction parallel to the x axis passes through the liquid crystal layer.

A structure model 1300 illustrated in FIGS. 9 and 10 is produced by modeling a liquid crystal cell, and includes a lower substrate 1310, an upper substrate 1311, and a liquid crystal layer 1312. The liquid crystal layer 1312 is caught between an upper main surface 1320 of the lower substrate 1310 and a lower main surface 1321 of the upper substrate 1311. The upper main surface 1320 of the lower substrate 1310 is located at a position where a coordinate value z is 0. The lower main surface 1321 of the upper substrate 1311 is located at a position where a coordinate value z is d. Namely, the liquid crystal layer 1312 has a thickness d. The upper main surface 1320 of the lower substrate 1310 and the lower main surface 1321 of the upper substrate 1311 are each covered with an alignment film not illustrated for aligning liquid crystal molecules in the liquid crystal layer 1312 in a direction parallel to an initial alignment axis parallel to the y axis, namely, an alignment film having an alignment capability of pointing a liquid crystal director for the liquid crystal molecules in the liquid crystal layer 1312 toward a direction parallel to the initial alignment axis.

When a horizontal field does not pass through the liquid crystal layer 1312, the liquid crystal director is pointed in a direction parallel to the initial alignment axis, as illustrated in FIG. 9.

When the horizontal field passes through the liquid crystal layer 1312, the liquid crystal director is bound by anchoring energy in the vicinity of the upper main surface 1320 of the lower substrate 1310 and the lower main surface 1321 of the upper substrate 1311 to be pointed in a direction parallel to the initial alignment axis. Meanwhile, in an area other than the vicinity of the upper main surface 1320 of the lower substrate 1310 and the lower main surface 1321 of the upper substrate 1311, the liquid crystal director is influenced by the horizontal field to be pointed in a direction rotated in a horizontal plane parallel to the xy plane from the direction parallel to the initial alignment axis, as illustrated in FIG. 10. An angle of the rotation from the initial alignment axis becomes greater with greater distances from the upper main surface 1320 of the lower substrate 1310 and the lower main surface 1321 of the upper substrate 1311 to become π/2 radian(90°) as a maximum rotation angle at an intermediate position between the upper main surface 1320 of the lower substrate 1310 and the lower main surface 1321 of the upper substrate 1311 at which a coordinate value z is d/2.

Falling process is a transient period in which, as application of a driving voltage for generating a horizontal field is stopped in the state shown in FIG. 10, a transition is made from the state shown in FIG. 10 to the state shown in FIG. 9 to finally produce a stable state shown in FIG. 9.

In the structure model 1300 illustrated in FIGS. 9 and 10, an angle of rotation of the liquid crystal director depends on a position in a direction parallel to the z axis but does not depend on a position in a direction parallel to the x axis and a position in a direction parallel to the y axis. Hence, a one-dimensional equation of motion of the liquid crystal director giving consideration only to a coordinate value z among a coordinate value x, a coordinate value y, and the coordinate value z is used for quantitative analysis of response speed during the falling time. This one-dimensional equation of motion of the liquid crystal director is expressed by a formula (1) using a viscosity constant γ1, a twist elastic modulus K22 of liquid crystal forming the liquid crystal layer 1312, an electric flux density D, and an angle of rotation θ of the liquid crystal director.

$$[ Formula 1 ]$$

$$γ1 \frac{\partial θ}{\partial t} = K 22 \frac{{\partial }^{2} θ}{\partial {z}^{2}} + {ɛ}^{- 1} Δ {xD}^{2} sin ( θ ) cos ( θ ) \qquad ( 1 )$$

A driving voltage is not applied in the falling process, so that the second term in the right side of the formula (1) including the electric flux density D is ignorable. Hence, the formula (1) is simplified and written as a formula (2).

$$[ Formula 2 ]$$

$$γ1 \frac{\partial θ}{\partial t} = K 22 \frac{{\partial }^{2} θ}{\partial {z}^{2}} \qquad ( 2 )$$

In the state shown in FIG. 10, with a twist angle of the liquid crystal director at a position indicated by an optional coordinate value z defined as θzs, the twist angle θzs takes 0 radian if a coordinate value z is 0, the twist angle θzs takes π/2 radian if a coordinate value z is d/2, and the twist angle θzs takes π radian if a coordinate value z is d.

Thus, a maximum rotation angle θm of the liquid crystal director at time t and a twist angle θz of the liquid crystal director at a position indicated by a coordinate value z at the time t satisfy a formula (3).

$$[ Formula 3 ]$$

$$θ z = θ m * sin ( \frac{π}{d} * z ) \qquad ( 3 )$$

A formula (4) is obtained by substituting θz in the formula (3) into θ in the formula (2).

$$[ Formula 4 ]$$

$$γ1 \frac{\partial θ z}{\partial t} = \frac{- K 22 {π}^{2}}{{d}^{2}} θ m * sin ( \frac{π}{d} * z ) \qquad ( 4 )$$

A falling period is a relaxation period in which the liquid crystal director having a maximum twist angle within a range of a coordinate value z from 0 to d is returned to a state of pointing in a direction parallel to the initial alignment axis. Hence, the falling period can be determined by giving consideration only to a position where a coordinate value z is d/2.

The element θz in the left side of the formula (3) becomes θm. Thus, a differential equation in a formula (5) is obtained by replacing θz in the left side of the formula (3) with θm and substituting d/2 into z in the formula (3).

$$[ Formula 5 ]$$

$$\frac{θ m}{dt} = - K 22 \frac{{π}^{2}}{γ1 * {d}^{2}} * θ m \qquad ( 5 )$$

A formula (6) is obtained by solving the differential equation in the formula (5).

$$[ Formula 6 ]$$

$$\frac{θ m}{dt} = \frac{- K 22 * θ m * {π}^{2}}{γ1 * {d}^{2}} * t \qquad ( 6 )$$

Like a formula used for obtaining time of discharging a charged capacitor, a falling response formula for obtaining the falling period is given by a formula (7) using an initial condition defining that the maximum rotation angle θm takes θm(0) when the time t is 0.

$$[ Formula 7 ]$$

$$θ ( t ) = θ m ( 0 ) {e}^{\frac{t}{time constant}} \qquad ( 7 )$$

The time constant in the formula (7) is defined as (−K22*π²)/(γ1*d²). Hence, a falling response formula in the absence of a partition is given by a formula (8) and a formula (9).

$$\begin{matrix}[ Formula 8 ] & \\ θ ( t ) = θ m ( 0 ) {e}^{\frac{- t}{τ}} & ( 8 ) \\ [ Formula 9 ] & \\ τ = \frac{γ1 * {d}^{2}}{K 22 * π} & ( 9 )\end{matrix}$$

1.12 Theoretical Analysis of Response Speed During Falling Time in the Presence of Partition

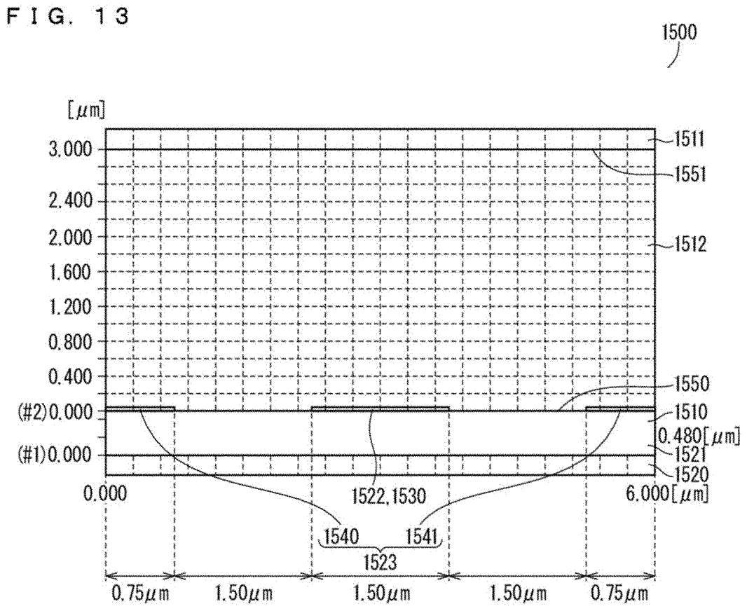

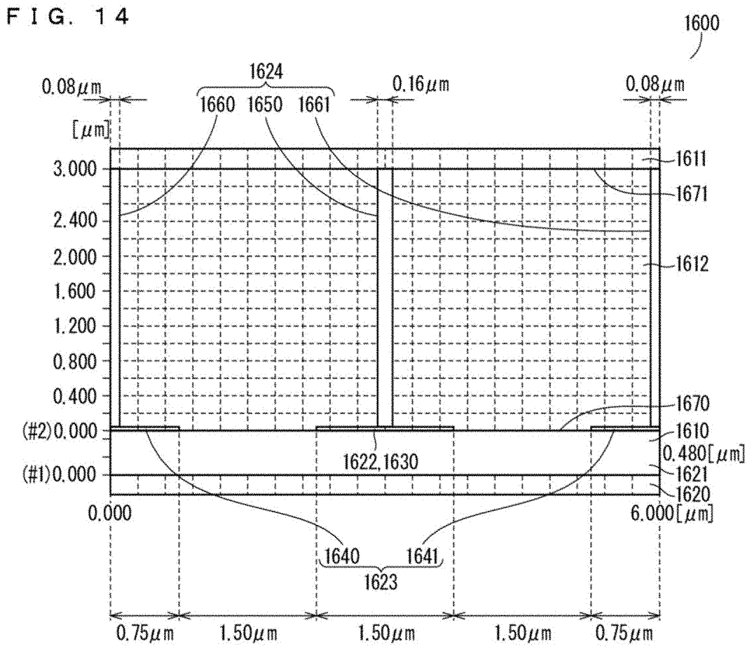

FIGS. 11 and 12 are schematic views each illustrating a structure model used for theoretically analyzing response speed during the falling time in the presence of a partition.

FIGS. 11 and 12 each show a state on an xz plane (xz two-dimensional space) in xyz three-dimensional space in which an xyz three-dimensional orthogonal coordinate system is defined. FIG. 11 shows a state in which a horizontal field in a direction parallel to the x axis does not pass through a liquid crystal layer. FIG. 12 shows a state in which a horizontal field in the direction parallel to the x axis passes through the liquid crystal layer.

A structure model 1400 illustrated in FIGS. 11 and 12 is produced by modeling a minimum constitutional unit of a liquid crystal cell, and includes a lower substrate 1410, an upper substrate 1411, a left partition 1412, a right partition 1413, and a liquid crystal layer 1414. The liquid crystal layer 1414 is caught between an upper main surface 1420 of the lower substrate 1410 and a lower main surface 1421 of the upper substrate 1411, and between a right main surface 1422 of the left partition 1412 and a left main surface 1423 of the right partition 1413. The upper main surface 1420 of the lower substrate 1410 is located at a position where a coordinate value z is 0. The lower main surface 1421 of the upper substrate 1411 is located at a position where a coordinate value z is d. The right main surface 1422 of the left partition 1412 is located at a position where a coordinate value x is 0. The left main surface 1423 of the right partition 1413 is located at a position where a coordinate value x is 1. Namely, the liquid crystal layer 1414 has a thickness d and a width 1. The upper main surface 1420 of the lower substrate 1410, the lower main surface 1421 of the upper substrate 1411, the right main surface 1422 of the left partition 1412, and the left main surface 1423 of the right partition 1413 are each covered with an alignment film not illustrated for aligning liquid crystal molecules in the liquid crystal layer 1414 in a direction parallel to an initial alignment axis parallel to the y axis, namely, an alignment film having an alignment capability of pointing a liquid crystal director for the liquid crystal molecules in the liquid crystal layer 1414 toward a direction parallel to the initial alignment axis.

When a horizontal field does not pass through the liquid crystal layer 1414, the liquid crystal director is pointed in a direction parallel to the initial alignment axis, as illustrated in FIG. 11.

When the horizontal field passes through the liquid crystal layer 1414, the liquid crystal director is bound by anchoring energy in the vicinity of the upper main surface 1420 of the lower substrate 1410, the lower main surface 1421 of the upper substrate 1411, the right main surface 1422 of the left partition 1412, and the left main surface 1423 of the right partition 1413 to be pointed in a direction parallel to the initial alignment axis, as illustrated in FIG. 12. Meanwhile, in an area other than the vicinity of the upper main surface 1420 of the lower substrate 1410, the lower main surface 1421 of the upper substrate 1411, the right main surface 1422 of the left partition 1412, and the left main surface 1423 of the right partition 1413, the liquid crystal director is influenced by the horizontal field to be pointed in a direction rotated in a horizontal plane parallel to the xy plane from the direction parallel to the initial alignment axis, as illustrated in FIG. 12. An angle of the rotation from the initial alignment axis becomes greater with greater distances from the upper main surface 1420 of the lower substrate 1410, the lower main surface 1421 of the upper substrate 1411, the right main surface 1422 of the left partition 1412, and the left main surface 1423 of the right partition 1413 to become π/2 radian (90°) as a maximum at an intermediate position between the upper main surface 1420 of the lower substrate 1410 and the lower main surface 1421 of the upper substrate 1411 and at an intermediate position between the right main surface 1422 of the left partition 1412 and the left main surface 1423 of the right partition 1413 at which a coordinate value x is ½ and a coordinate value z is d/2.

In the structure model 1400 illustrated in FIGS. 11 and 12, an angle of rotation of the liquid crystal director depends on a position in a direction parallel to the x axis and on a position in a direction parallel to the z axis but does not depend on a position in a direction parallel to the y axis. Hence, a two-dimensional equation of motion of the liquid crystal director giving consideration only to a coordinate value x and a coordinate value z among the coordinate value x, a coordinate value y, and the coordinate value z is used for quantitative analysis of response speed during the falling time. This two-dimensional equation of motion of the liquid crystal director is obtained by modifying the one-directional equation of motion of the liquid crystal director expressed by the formula (2), and is expressed by a formula (10).

$$[ Formula 10 ]$$

$$γ1 \frac{\partial θ ( x , z )}{\partial t} = K 11 \frac{{\partial }^{2} θ x}{\partial {x}^{2}} + K 22 \frac{{\partial }^{2} θ z}{\partial {z}^{2}} \qquad ( 10 )$$

A maximum rotation angle θm of the liquid crystal director at time t, a twist angle θx of the liquid crystal director at a position indicated by a coordinate value x at the time t, and a twist angle θz of the liquid crystal director at a position indicated by a coordinate value z at the time t satisfy a formula (11) and a formula (12).

$$\begin{matrix}[ Formula 11 ] & \\ θ x = θ m * sin ( \frac{π}{l} * x ) & ( 11 ) \\ [ Formula 12 ] & \\ θ z = θ m * sin ( \frac{π}{d} * z ) & ( 12 )\end{matrix}$$

A formula (13) is obtained by respectively substituting θx in the formula (11) and θz in the formula (12) into θx and θz in the formula (10).

$$[ Formula 13 ]$$

$$\frac{γ1 * \partial θ ( x , z )}{\partial t} = K 11 * \frac{{π}^{2}}{{l}^{2}} * θ m * sin ( \frac{π}{l} * x ) + K 22 * \frac{{π}^{2}}{{d}^{2}} * θ m * sin ( \frac{π}{d} * z ) \qquad ( 13 )$$

A falling period is relaxation time in which the liquid crystal director having a maximum twist angle within a range of a coordinate value x from 0 to 1 and a range of a coordinate value z from 0 to d is returned to a state of pointing in a direction parallel to the initial alignment axis. Hence, the falling period can be determined by giving consideration only to a position where a coordinate value x is ½ and a coordinate value z is d/2.

A formula (14) is obtained by respectively substituting ½ and d/2 into x and z in the formula (13).

$$[ Formula 14 ]$$

$$\frac{θ ( x , z )}{dt} = \frac{θ m * {π}^{2}}{γ1} * ( \frac{K 11}{{l}^{2}} + \frac{K 22}{{d}^{2}} ) \qquad ( 14 )$$

Like in the case in the absence of a partition, a falling response formula for obtaining the falling period is given by a formula (15) and a formula (16).

$$\begin{matrix}[ Formula 15 ] & \\ θ ( t ) = θ ( 0 ) {e}^{\frac{- t}{τ}} & ( 15 ) \\ [ Formula 16 ] & \\ τ = \frac{γ1}{{π}^{2} * ( \frac{K 11}{{l}^{2}} + \frac{K 22}{{d}^{2}} )} & ( 16 )\end{matrix}$$

In liquid crystal forming a liquid crystal layer provided in a liquid crystal display of the horizontal field system, the splay elastic modulus K11 is generally about twice the twist elastic modulus K22.

On the assumption that the splay elastic modulus K11 is twice the twist elastic modulus K22 and the width 1 of the liquid crystal layer 1414 is equal to the thickness d of the liquid crystal layer 1414, a time constant T is expressed by a formula (17).

$$[ Formula 17 ]$$

$$τ = \frac{γ1}{{π}^{2} * ( \frac{K 11}{{l}^{2}} + \frac{K 22}{{d}^{2}} )} = \frac{γ1}{{π}^{2} * ( \frac{2 * K 22}{{d}^{2}} + \frac{K 22}{{d}^{2}} )} = \frac{γ1}{{π}^{2} * ( \frac{K 22}{{d}^{2}} )} * \frac{1}{3} \qquad ( 17 )$$

1.13 Comparison Between the Absence of Partition and the Presence of Partition

The time constant τ in the absence of a partition is expressed by the formula (9). Under the foregoing assumption, the time constant t in the presence of a partition is expressed by the formula (17).

Thus, if the foregoing assumption is adopted, a ratio of the falling period in the presence of a partition to the falling period in the absence of a partition is expressed by a formula (18).

$$[ Formula 18 ]$$

$$\frac{{e}^{( \frac{1}{3} )}}{e} \approx \frac{1}{2} \qquad ( 18 )$$

As understood from the foregoing ratio, response time during the falling time in the presence of a partition is about half of response time during the falling time in the absence of a partition.

If the splay elastic modulus K11 is not twice the twist elastic modulus K22, the foregoing ratio changes from ½. This ratio also changes from ½ if the width 1 of the liquid crystal layer 1414 is not equal to the thickness d of the liquid crystal layer 1414. In such cases, however, response time during the falling time in the presence of a partition is still shorter than response time during the falling time in the absence of a partition.

In the foregoing analysis, the maximum rotation angle is described as π/2 radian (90°) corresponding to a theoretical upper limit. In an actual liquid crystal display of the horizontal field system, however, a maximum rotation angle for display of white is about π/4 radian (45°). Thus, in the actual liquid crystal display of the horizontal field system, the foregoing ratio may take a value different from ½. In such a case, however, response during the falling time in the presence of a partition is still shorter than response time during the falling time in the absence of a partition.

1.14 Analysis of Response Speed During Falling Time by Simulation

In the following description, response speed during the falling time in the absence of a partition such as the partition 1081 and response speed during the falling time in the presence of a partition such as the partition 1081 are analyzed by simulation to show that response time during the falling time in the presence of a partition such as the partition 1081 is about one-third of response time during the falling time in the absence of a partition such as the partition 1081.

A used simulator is LCDMaster 2D (Ver. 8.5.2) available from SHINTECH, Inc. Table 1 shows the physical property values of a liquid crystal material MS-5355XX-K forming a liquid crystal layer in a structure model used in the simulation. Table 2 shows common parameters common to structure models used in the simulation. The structure models used in the simulation were simplified to a maximum within a range in which the appropriateness of the structure models can be guaranteed.

TABLE 1

| | Wavelength | | |
|---|---|---|---|
| | (nm) | Ordinary light (no) | Extraordinary light (ne) |
| Refractive index | 450 | 1.504 | 1.638 |
| | 550 | 1.492 | 1.614 |
| | 650 | 1.486 | 1.602 |

| | | |
|---|---|---|
| Relative | εp | 7.5 |
| permittivity | εS | 2.9 |
| Elastic constant | K11 | 14.6 |
| (pN) | K22 | 7.3 |
| | K33 | 19.1 |
| Viscosity | γ1 | 0.099 |
| constant (Pa · s) | | |

TABLE 2

| | |
|---|---|
| Cell gap | 3.0 μm |
| Lower substrate rubbing angle | 83° |
| Lower polarizing axis | 83° - (retardation) |
| Alignment film | Independent of model |
| Backlight source | Light source C |

1.15 Analysis of Response Speed During Falling Time by Simulation in the Absence of Partition

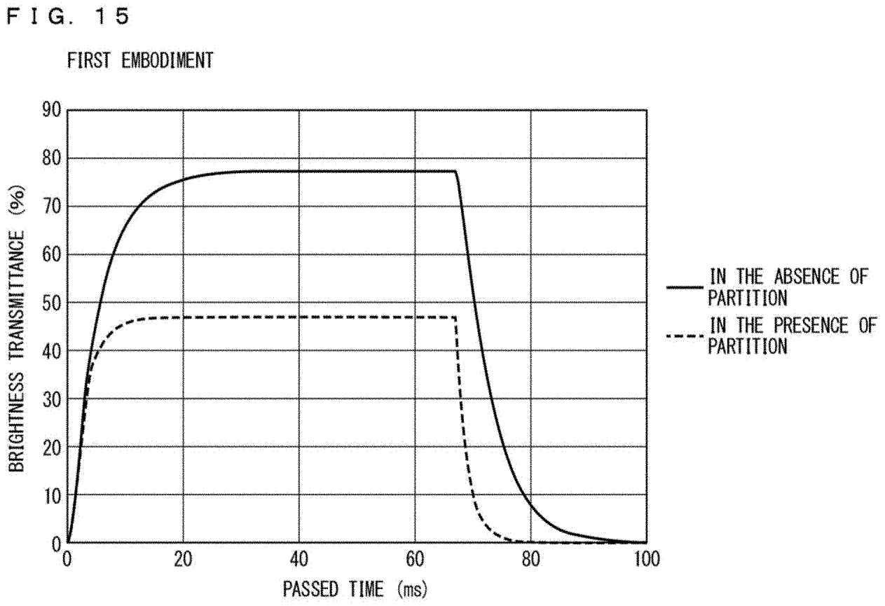

FIG. 13 is a sectional view illustrating a section of a structure model used for analyzing response speed during the falling time by simulation in the absence of a partition.

A structure model 1500 illustrated in FIG. 13 is produced by modeling a minimum recurring unit of a liquid crystal cell of the in-plane switching (IPS) system, and includes a lower substrate 1510, an upper counter substrate 1511, and a liquid crystal layer 1512. The lower substrate 1510 includes a lower glass substrate 1520, an organic planarizing film 1521, an image signal line slit electrode 1522, and a common potential line slit electrode 1523. The image signal line slit electrode 1522 includes a line-like electrode 1530. The common potential line slit electrode 1523 includes a line-like electrode 1540 and a line-like electrode 1541.

The liquid crystal material MS-5355XX-K is poured in between an upper main surface 1550 of the lower substrate 1510 and a lower main surface 1551 of the upper counter substrate 1511 to form the liquid crystal layer 1512 made of the liquid crystal material MS-5355XX-K. An alignment film not illustrated covering the upper main surface 1550 of the lower substrate 1510 is subjected to alignment process for aligning liquid crystal molecules in the liquid crystal layer 1512 in a first direction. An alignment film not illustrated covering the lower main surface 1551 of the upper counter substrate 1511 is subjected to alignment process for aligning the liquid crystal molecules in the liquid crystal layer 1512 in a second direction perpendicular to the first direction. Each of the line-like electrodes 1530, 1540, and 1541 has a width of 1.5 μm. A gap between two adjacent ones of the line-like electrodes 1530, 1540, and 1541 is 1.5 μm. A liquid crystal cell gap, which is a distance from the upper main surface 1550 of the lower substrate 1510 to the lower main surface 1551 of the upper counter substrate 1511, is 3.0

1.16 Analysis of Response Speed During Falling Time by Simulation in the Presence of Partition

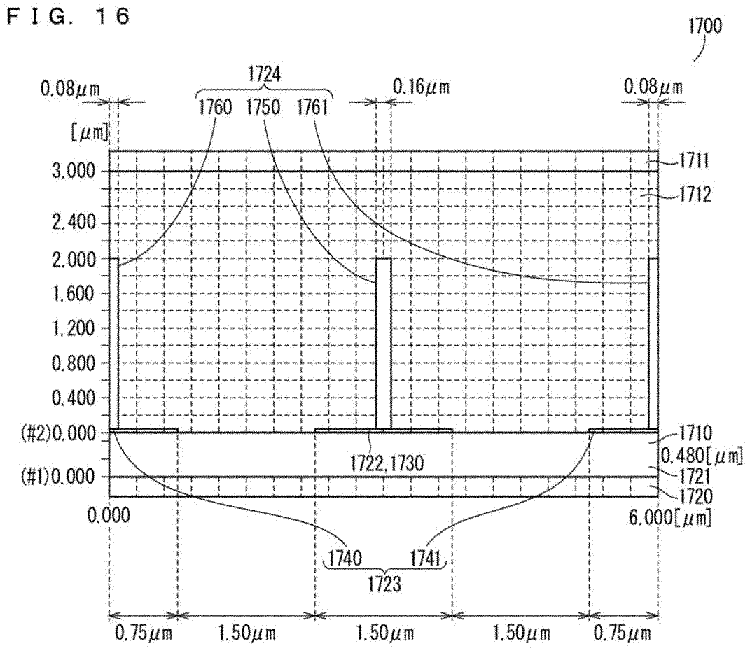

FIG. 14 is a sectional view illustrating a section of a structure model used for analyzing response speed during the falling time by simulation in the presence of a partition.

A structure model 1600 illustrated in FIG. 14 is produced by modeling a minimum recurring unit a liquid crystal cell of the IPS system to which partition is added, and includes a lower substrate 1610, an upper counter substrate 1611, and a liquid crystal layer 1612. The lower substrate 1610 includes a lower glass substrate 1620, an organic planarizing film 1621, an image signal line slit electrode 1622, a common potential line slit electrode 1623, and a partition 1624. The image signal line slit electrode 1622 includes a line-like electrode 1630. The common potential line slit electrode 1623 includes a line-like electrode 1640 and a line-like electrode 1641. The partition 1624 includes a line-like partition 1650, a line-like partition 1660, and a line-like partition 1661.

The liquid crystal material MS-5355XX-K is poured in between an upper main surface 1670 of the lower substrate 1610 and a lower main surface 1671 of the upper counter substrate 1611 to form the liquid crystal layer 1612 made of the liquid crystal material MS-5355XX-K. The upper main surface 1670 of the lower substrate 1610 is subjected to alignment process for aligning liquid crystal molecules in the liquid crystal layer 1612 in a first direction. The lower main surface 1671 of the upper counter substrate 1611 is subjected to alignment process for aligning the liquid crystal molecules in the liquid crystal layer 1612 in a second direction perpendicular to the first direction. Each of the line-like electrodes 1630, 1640, and 1641 has a width of 1.5 μm. A gap between two adjacent ones of the line-like electrodes 1630, 1640, and 1641 is 1.5 μm. A liquid crystal cell gap is 3.0 μm.

The line-like partitions 1650, 1660, and 1661 are arranged on the line-like electrodes 1630, 1640, and 1641 respectively.

Each of the line-like partitions 1650, 1660, and 1661 has a height of 3.0 μm corresponding to the liquid crystal cell gap to partition the liquid crystal layer 1612 completely in a direction parallel to an extension direction of the lower substrate 1610.

In the structure model 1600, to prevent reduction in liquid crystal caused by addition of the partition 1624 from making disturbance in a result of the simulation, the width of each of the line-like partitions 1650, 1660, and 1661 is set at a lower limit of 0.16 μm.

1.17 Comparison Between the Absence of Partition and the Presence of Partition

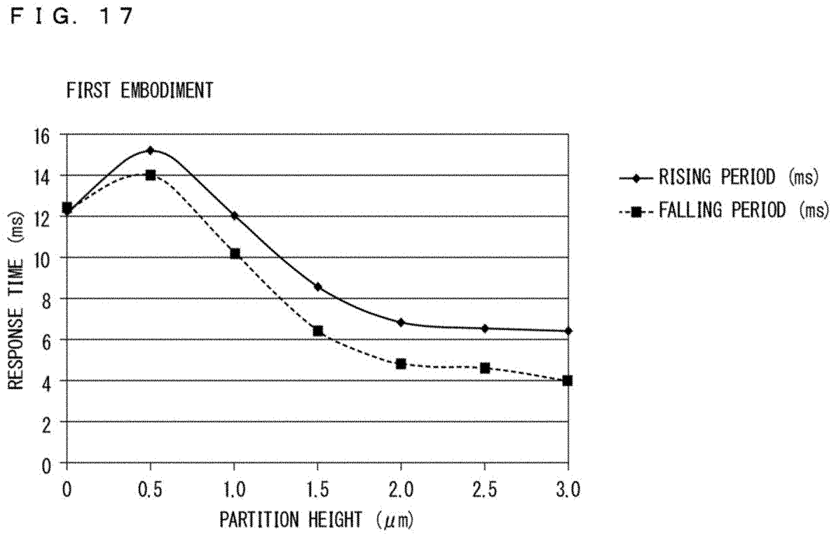

FIG. 15 is a graph showing response curves obtained by evaluating response characteristics using the structure model in the absence of a partition illustrated in FIG. 13 and the structure model in the presence of a partition illustrated in FIG. 14.

For evaluation of the response characteristics, a driving signal at a frequency of 30 Hz having an optimum voltage was applied in two cycles in a period from a point in time when passed time is 0 ms to a point in time when passed time is 66.67 ms to display white having maximum brightness. Next, in a period from the point in time when passed time is 66.67 ms to a point in time when passed time is 100 ms, 0 V was applied. Change in brightness transmittance with passed time was evaluated in a period from the point in time when passed time is 0 ms to the point in time when passed time is 100 ms.

As shown in FIG. 15, rising and falling of a response curve corresponding to use of the structure model 1600 in the presence of the partition 1624 illustrated in FIG. 14 are respectively steeper than rising and falling of a response curve corresponding to use of the structure model 1500 in the absence of a partition illustrated in FIG. 13.

A period from a point in time when application of a driving signal was started to a point in time when brightness transmittance has increased to 90% of a maximum is defined as a rising period. A period from a point in time when application of the driving signal was finished to a point in time when brightness transmittance has decreased to 10% of the maximum is defined as a falling period. In this case, as a result of use of the structure model 1500 illustrated in FIG. 13 in the absence of a partition and use of the structure model 1600 illustrated in FIG. 14 in the presence of the partition 1624, the rising period and the falling period in each of these uses are determined as shown in Table 3.

TABLE 3
First embodiment

| | Electrode | Gap between | Cell | Rising | Falling | Brightness |
|---|---|---|---|---|---|---|
| System | width | electrodes | gap | period | period | transmittance |
| Without partition | 1.5 μm | 1.5 μm | 3.0 μm | 12.2 ms | 12.4 ms | 77.0% |
| With partition | 1.5 μm | 1.5 μm | 3.0 μm | 6.4 ms | 4.0 ms | 46.8% |

As understood from Table 3, the falling period determined by the use of the structure model 1600 illustrated in FIG. 14 in the presence of the partition 1624 is about one-third of the falling period determined by the use of the structure model 1500 illustrated in FIG. 13 in the absence of a partition.

1.18 Partition Height

In the structure model 1600 illustrated in FIG. 14, the partition 1624 has a height of 3.0 μm corresponding to the liquid crystal cell gap, so that the partition 1624 extends from the image signal line slit electrode 1622 and the common potential line slit electrode 1623 to reach as far as the upper counter substrate 1611. However, extension of the partition 1624 from the image signal line slit electrode 1622 and the common potential line slit electrode 1623 to the upper counter substrate 1611 may cause difficulty in pouring a liquid crystal material in between the upper main surface 1670 of the lower substrate 1610 and the lower main surface 1671 of the upper counter substrate 1611.

The partition 1624 is provided to fix the direction of the liquid crystal director by means of anchoring energy. In the vicinity of the lower main surface 1671 of the upper counter substrate 1611, however, the lower main surface 1671 of the upper counter substrate 1611 functions to fix the direction of the liquid crystal director. Hence, the partition 1624 is not required to reach as far as the upper counter substrate 1611, so that replacing the partition 1624 with a partition having a smaller height than the liquid crystal cell gap is considered to be allowable.

To demonstrate the applicability of replacement of the partition 1624 with a partition having a smaller height than the liquid crystal cell gap, analysis by simulation was conducted.

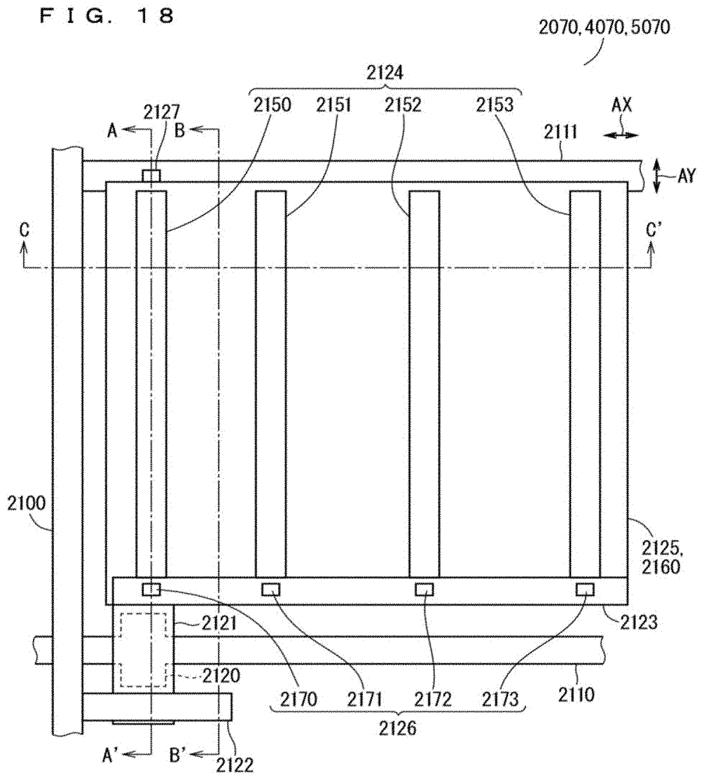

FIG. 16 is a sectional view illustrating a section of a structure model used for analyzing response speed during the falling time by simulation in the presence of a partition such as the partition 1081.

A structure model 1700 illustrated in FIG. 16 is produced by modeling a minimum recurring unit of a liquid crystal cell of the IPS system to which partition is added, and includes a lower substrate 1710, an upper counter substrate 1711, and a liquid crystal layer 1712. The lower substrate 1710 includes a lower glass substrate 1720, an organic planarizing film 1721, an image signal line slit electrode 1722, a common potential line slit electrode 1723, and a partition 1724. The image signal line slit electrode 1722 includes a line-like electrode 1730. The common potential line slit electrode 1723 includes a line-like electrode 1740 and a line-like electrode 1741. The partition 1724 includes a line-like partition 1750, a line-like partition 1760, and a line-like partition 1761. The structure model 1700 illustrated in FIG. 16 is similar to the structure model 1600 illustrated in FIG. 14, except that the partition 1724 does not reach as far as the upper counter substrate 1711.

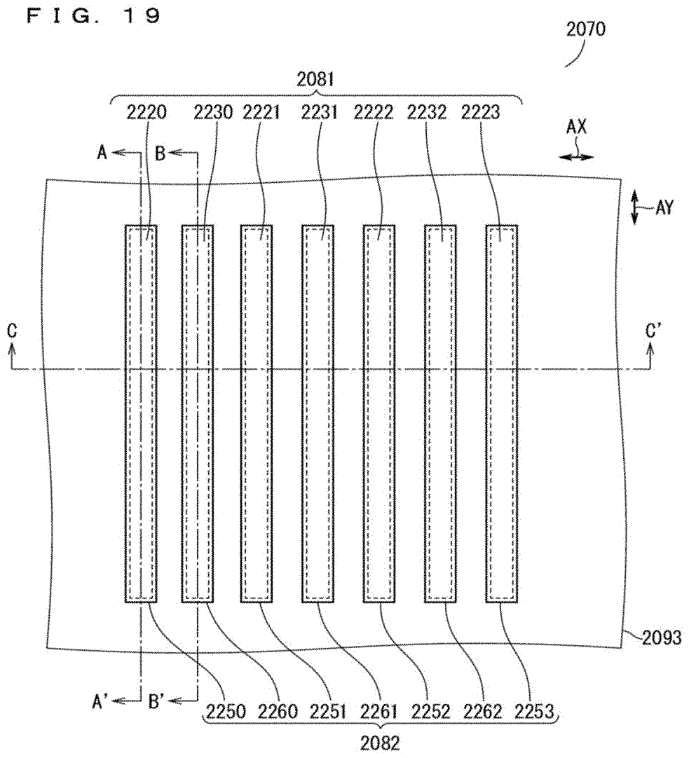

FIG. 17 is a graph showing change in the rising period and the falling period resulting from the height of a partition determined by evaluating response characteristics using the structure model illustrated in FIG. 16.

As shown in FIG. 17, the rising period and the falling period tend to be reduced with increase in the height of the partition 1724, but are practically saturated in a range where the height of the partition 1724 is 2 μm or more. This shows that the partition 1724 is not required to reach as far as the upper counter substrate 1711 and the effect of shortening the rising period and the falling period can be achieved sufficiently with the partition 1724 having a height of two-thirds or more of the liquid crystal cell gap.

### 2. Second Embodiment

2.1 Main Difference Between First Embodiment and Second Embodiment

A second embodiment relates to a liquid crystal display of the horizontal field system.

The first embodiment and the second embodiment differ from each other mainly in the following. In the first embodiment, the image signal line slit electrode 1124 and the common potential line slit electrode 1125 form a pixel electrode, and the common potential line slit electrode 1125 is arranged in the same layer as the image signal line slit electrode 1124, as illustrated in FIG. 8. In the second embodiment, an image signal line slit electrode and a common potential line lower electrode form a pixel electrode, the common potential line lower electrode is arranged in a different layer from the image signal line slit electrode, and a generated horizontal field becomes a fringe field. Structures or modifications thereof employed in liquid crystal displays of the other embodiments may also be employed in the liquid crystal display of the second embodiment within a range in which structures resulting in the foregoing main difference can be employed without any interference.

2.2 Liquid Crystal Display, Liquid Crystal Panel, and Display Region

The schematic view of FIG. 1 is also a perspective view illustrating the liquid crystal display of the second embodiment. The schematic view of FIG. 2 is also a sectional view illustrating a section of a liquid crystal panel provided in the liquid crystal display of the second embodiment. The schematic view of FIG. 3 is also a plan view illustrating a TFT substrate, a printed board, and an integrated circuit chip provided in the liquid crystal display of the second embodiment.

2.3 TFT Substrate

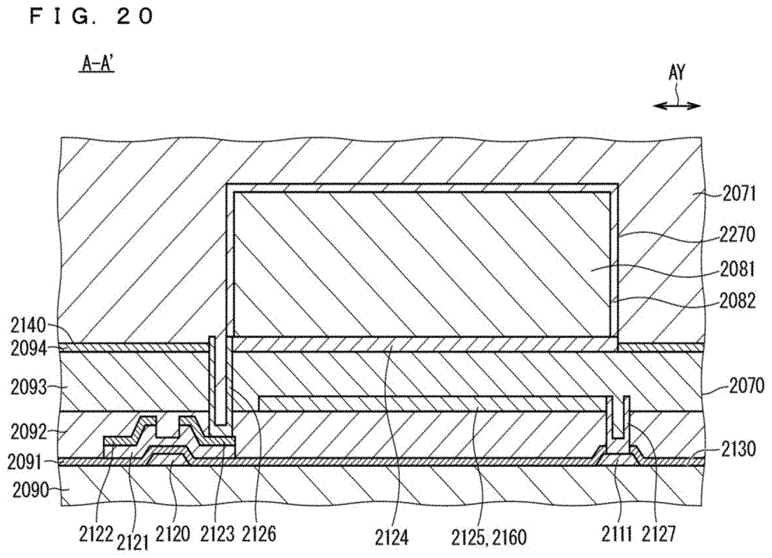

The schematic view of FIG. 18 is a plan view illustrating planar arrangement of a line, an electrode, and a semiconductor channel layer provided in the liquid crystal display of the second embodiment. The schematic view of FIG. 19 is a plan view illustrating planar arrangement of an organic planarizing film, a partition, and an alignment film provided in the liquid crystal display of the second embodiment. FIGS. 20, 21, and 22 are sectional views each illustrating sections of the TFT substrate and a liquid crystal layer provided in the liquid crystal display of the second embodiment.

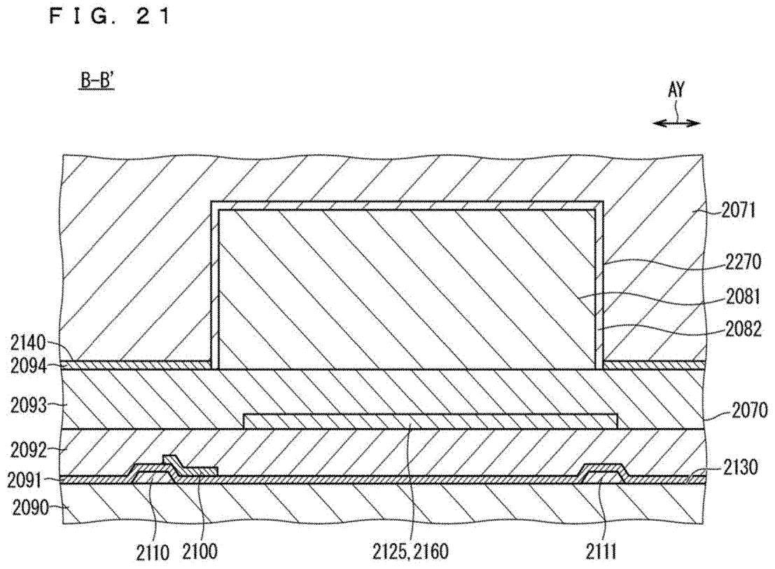

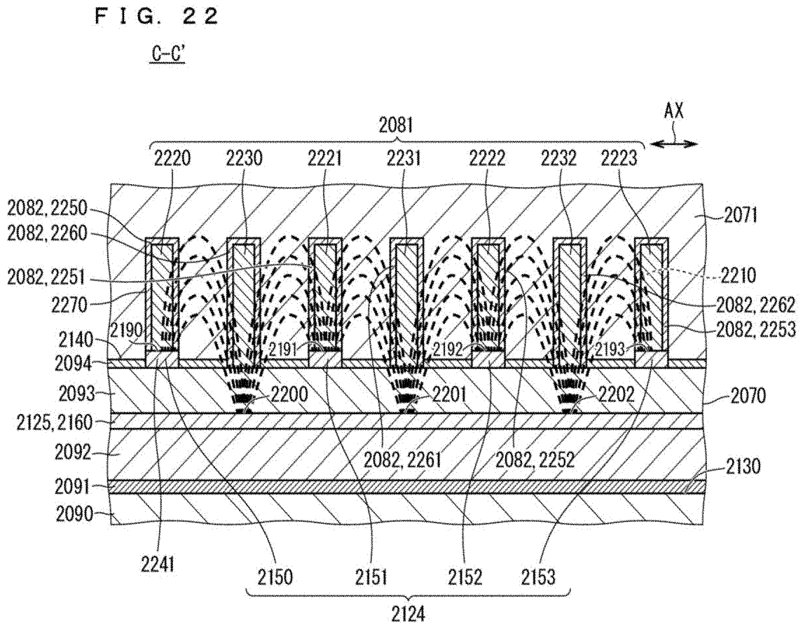

FIG. 20 illustrates a section taken at a position along a cutting line A-A′ in FIGS. 18 and 19. FIG. 21 illustrates a section taken at a position along a cutting line B-B′ in FIGS. 18 and 19. FIG. 22 illustrates a section taken at a position along a cutting line C-C′ in FIGS. 18 and 19.

FIGS. 18, 19, 20, 21, and 22 illustrate the pixel region 1060 illustrated in FIG. 3.

A TFT substrate 2070 illustrated in FIGS. 18, 19, 20, 21, and 22 becomes the TFT substrate 1030 illustrated in FIGS. 1, 2, and 3. A liquid crystal layer 2071 illustrated in FIGS. 20, 21, and 22 becomes the liquid crystal layer 1031 illustrated in FIG. 2.

FIG. 18 illustrates an image signal line 2100, a scanning line 2110, a common potential line 2111, a scanning line electrode 2120, a semiconductor channel layer 2121, an image signal line electrode 2122, an image signal line electrode 2123, an image signal line slit electrode 2124, a common potential line lower electrode 2125, an image signal line through hole group 2126, and a common potential line through hole 2127 provided in the TFT substrate 2070.

FIG. 19 illustrates an organic planarizing film 2093, a partition 2081, and an alignment film 2082 provided in the TFT substrate 2070.

FIG. 20 illustrates a glass substrate 2090, a scanning line insulating film 2091, an interlayer insulating film 2092, the organic planarizing film 2093, an alignment film 2094, the common potential line 2111, the scanning line electrode 2120, the semiconductor channel layer 2121, the image signal line electrode 2122, the image signal line electrode 2123, the image signal line slit electrode 2124, the common potential line lower electrode 2125, the image signal line through hole group 2126, the common potential line through hole 2127, the partition 2081, and the alignment film 2082 provided in the TFT substrate 2070.

FIG. 21 illustrates the glass substrate 2090, the scanning line insulating film 2091, the interlayer insulating film 2092, the organic planarizing film 2093, the alignment film 2094, the image signal line 2100, the scanning line 2110, the common potential line 2111, the common potential line lower electrode 2125, the partition 2081, and the alignment film 2082 provided in the TFT substrate 2070.

FIG. 22 illustrates the glass substrate 2090, the scanning line insulating film 2091, the interlayer insulating film 2092, the organic planarizing film 2093, the image signal line slit electrode 2124, the common potential line lower electrode 2125, the alignment film 2094, the partition 2081, and the alignment film 2082 provided in the TFT substrate 2070.

The image signal line 2100 is at each pixel-regions-array 1051 illustrated in FIG. 3. The scanning line 2110 and the common potential line 2111 are at each pixel-regions-array 1050 illustrated in FIG. 3. The scanning line electrode 2120, the semiconductor channel layer 2121, the image signal line electrode 2122, the image signal line electrode 2123, the image signal line slit electrode 2124, the common potential line lower electrode 2125, the image signal line through hole group 2126, the common potential line through hole 2127, the partition 2081, and the alignment film 2082 are at each pixel region 1060 illustrated in FIG. 3.

The scanning line insulating film 2091, the scanning line electrode 2120, the semiconductor channel layer 2121, the image signal line electrode 2122, and the image signal line electrode 2123 form a TFT. The image signal line slit electrode 2124 and the common potential line lower electrode 2125 form a pixel electrode.

The glass substrate 2090, the scanning line 2110, the common potential line 2111, and the scanning line electrode 2120 respectively correspond to the glass substrate 1090, the scanning line 1110, the common potential 1111, and the scanning line electrode 1120 of the first embodiment.

The scanning line insulating film 2091 is stacked on the scanning line 2110, the common potential line 2111, and the scanning line electrode 2120 and arranged over an upper main surface 2130 of the glass substrate 2090 as illustrated in FIGS. 20, 21, and 22, and extends across a plurality of pixel regions forming the display region 1040 illustrated in FIG. 3. The scanning line insulating film 2091 separates the scanning line 2110, the common potential line 2111, and the scanning line electrode 2120 under the scanning line insulating film 2091 in the thickness direction of the TFT substrate 2070 from the image signal line 2100, the semiconductor channel layer 2121, the image signal line electrode 2122, and the image signal line electrode 2123 over the scanning line insulating film 2091, thereby insulating the scanning line 2110, the common potential line 2111, and the scanning line electrode 2120 from the image signal line 2100, the semiconductor channel layer 2121, the image signal line electrode 2122, and the image signal line electrode 2123.

The image signal line 2100 is stacked on the scanning line insulating film 2091 and arranged over the upper main surface 2130 of the glass substrate 2090 as illustrated in FIG. 21, and extends across a plurality of pixel regions forming each pixel-regions-array 1051 illustrated in FIG. 3.

As illustrated in FIG. 20, the semiconductor channel layer 2121 is stacked on the scanning line insulating film 2091 and arranged over the upper main surface 2130 of the glass substrate 2090. The semiconductor channel layer 2121 faces the scanning line electrode 2120 across the scanning line insulating film 2091.

As illustrated in FIG. 20, the image signal line electrode 2122 is stacked on the scanning line insulating film 2091 and the semiconductor channel layer 2121 and arranged over the upper main surface 2130 of the glass substrate 2090. As illustrated in FIG. 18, the image signal line electrode 2122 contacts the image signal line 2100 and the semiconductor channel layer 2121 and is electrically connected to the image signal line 2100 and the semiconductor channel layer 2121.

As illustrated in FIG. 20, the image signal line electrode 2123 is stacked on the scanning line insulating film 2091 and the semiconductor channel layer 2121 and arranged over the upper main surface 2130 of the glass substrate 2090. As illustrated in FIG. 18, the image signal line electrode 2123 contacts the semiconductor channel layer 2121 and is electrically connected to the semiconductor channel layer 2121.

As illustrated in FIGS. 20, 21, and 22, the interlayer insulating film 2092 is stacked on the scanning line insulating film 2091, the image signal line 2100, the semiconductor channel layer 2121, the image signal line electrode 2122, and the image signal line electrode 2123 and arranged over the upper main surface 2130 of the glass substrate 2090. The interlayer insulating film 2092 separates the image signal line 2100, the semiconductor channel layer 2121, the image signal line electrode 2122, and the image signal line electrode 2123 under the interlayer insulating film 2092 in the thickness direction of the TFT substrate 2070 from the image signal line slit electrode 2124 and the common potential line lower electrode 2125 over the interlayer insulating film 2092, thereby insulating the image signal line 2100, the semiconductor channel layer 2121, the image signal line electrode 2122, and the image signal line electrode 2123 from the image signal line slit electrode 2124 and the common potential line lower electrode 2125.

As illustrated in FIGS. 20, 21, and 22, the common potential line lower electrode 2125 is stacked on the interlayer insulating film 2092 and arranged over the upper main surface 2130 of the glass substrate 2090. The common potential line lower electrode 2125 includes a sheet-like electrode 2160 illustrated in FIGS. 18, 20, 21, and 22. As illustrated in FIG. 18, the sheet-like electrode 2160 has a sheet-like planar shape as viewed in the thickness direction of the TFT substrate 2070.

As illustrated in FIGS. 20, 21, and 22, the organic planarizing film 2093 is stacked on the interlayer insulating film 2092 and the common potential line lower electrode 2125 and arranged over the upper main surface 2130 of the glass substrate 2090. The organic planarizing film 2093 functions as an insulating film for separating the common potential line lower electrode 2125 under the organic planarizing film 2093 in the thickness direction of the TFT substrate 2070 from the image signal line slit electrode 2124 over the organic planarizing film 2093, thereby insulating the common potential line lower electrode 2125 from the image signal line slit electrode 2124.

As illustrated in FIGS. 20, 21, and 22, the alignment film 2094 is stacked on the organic planarizing film 2093 and arranged over the upper main surface 2130 of the glass substrate 2090. The alignment film 2094 has an upper main surface 2140 forming the upper main surface of the TFT substrate 2070 and contacting the liquid crystal layer 2071. The upper main surface 2140 of the alignment film 2094 is subjected to alignment process by means of a rubbing or photo-alignment method, for example. Thus, the upper main surface 2140 of the alignment film 2094 has an alignment capability of aligning liquid crystal molecules in the liquid crystal layer 2071 in a particular alignment direction.

As illustrated in FIGS. 20 and 22, the image signal line slit electrode 2124 is stacked on the organic planarizing film 2093 and arranged over the upper main surface 2130 of the glass substrate 2090. The image signal line slit electrode 2124 is a comb-like electrode and includes a line-like electrode 2150, a line-like electrode 2151, a line-like electrode 2152, and a line-like electrode 2153 illustrated in FIGS. 18 and 22. As illustrated in FIG. 18, each of the line-like electrodes 2150, 2151, 2152, and 2153 is a line-like segment having a line-like planar shape as viewed in the thickness direction of the TFT substrate 2070 and extending in a particular extension direction indicated by the arrow AY. As illustrated in FIGS. 18 and 22, the line-like electrodes 2150, 2151, 2152, and 2153 are arranged in an arrangement direction indicated by the arrow AX.

As illustrated in FIGS. 18, 20, and 22, the image signal line slit electrode 2124 and the common potential line lower electrode 2125 are arranged in such a manner as to overlap each other as viewed in the thickness direction of the TFT substrate 2070.

As illustrated in FIG. 20, the image signal line through hole group 2126 penetrates the interlayer insulating film 2092, the organic planarizing film 2093, and the alignment film 2094. The image signal line through hole group 2126 includes an image signal line through hole 2170, an image signal line through hole 2171, an image signal line through hole 2172, and an image signal line through hole 2173 illustrated in FIG. 18. Each of the image signal line through holes 2170, 2171, 2172, and 2173 extends in the thickness direction of the TFT substrate 2070. As illustrated in FIG. 18, the image signal line through holes 2170, 2171, 2172, and 2173 contact the image signal line electrode 2123, respectively contact the line-like electrodes 2150, 2151, 2152, and 2153 at their one end portions, and electrically connect the line-like electrodes 2150, 2151, 2152, and 2153 to the image signal line electrode 2123 respectively.

As illustrated in FIG. 20, the common potential line through hole 2127 penetrates the interlayer insulating film 2092. The common potential line through hole 2127 extends in the thickness direction of the TFT substrate 2070. As illustrated in FIG. 18, the common potential line through hole 2127 contacts the common potential line 2111, contacts the common potential line lower electrode 2125, and electrically connects the common potential line lower electrode 2125 to the common potential line 2111.

2.4 Generation of Horizontal Field

In the TFT, in response to application of an ON signal to the scanning line electrode 2120 to become a gate electrode illustrated in FIGS. 18 and 20, the image signal line electrode 2122 to become a drain illustrated in FIGS. 18 and 20 and the image signal line electrode 2123 to become a source illustrated in FIGS. 18 and 20 become electrically continuous with each other. In response to application of an OFF signal to the scanning line electrode 2120 to become the gate, the image signal line electrode 2122 to become the drain and the image signal line electrode 2123 to become the source become electrically discontinuous with each other.

When the image signal line electrode 2122 and the image signal line electrode 2123 become electrically continuous with each other, the image signal line slit electrode 2124 illustrated in FIGS. 18, 20, and 22 is given a signal potential as a first potential applied from the image signal line 2100 illustrated in FIGS. 18 and 21 through the image signal line electrode 2122, the semiconductor channel layer 2121, the image signal line electrode 2123, and the image signal line through hole group 2126 illustrated in FIGS. 18 and 20.

The common potential line lower electrode 2125 illustrated in FIGS. 18, 20, 21, and 22 is given a common potential as a second potential different from the first potential and applied from the common potential line 2111 illustrated in FIGS. 18, 20, and 21 through the common potential line through hole 2127 illustrated in FIGS. 18 and 20.

Thus, in response to application of an ON signal to the scanning line electrode 2120, a driving voltage is applied between the image signal line slit electrode 2124 and the common potential line lower electrode 2125.

When the driving voltage is applied between the image signal line slit electrode 2124 as a first pixel electrode and the common potential line lower electrode 2125 as a second pixel electrode, the common potential line lower electrode 2125 becomes involved in a field from the image signal line slit electrode 2124, as illustrated in FIG. 22. More specifically, a fringe field is generated between a field concentrated part 2200 as a second field concentrated part occupying a part of an upper main surface of the sheet-like electrode 2160, and a field concentrated part 2190 and a field concentrated part 2191 as a first field concentrated part respectively occupying substantially entire upper surfaces of the line-like electrodes 2150 and 2151 adjacent to the field concentrated part 2200. A fringe field is generated between a field concentrated part 2201 as the second field concentrated part occupying a part of the upper main surface of the sheet-like electrode 2160, and the field concentrated part 2191 and a field concentrated part 2192 as the first field concentrated part respectively occupying substantially entire upper surfaces of the line-like electrodes 2151 and 2152 adjacent to the field concentrated part 2201. Further, a fringe field is generated between a field concentrated part 2202 as the second field concentrated part occupying a part of the upper main surface of the sheet-like electrode 2160, and the field concentrated part 2192 and a field concentrated part 2193 as the first field concentrated part respectively occupying substantially entire upper surfaces of the line-like electrodes 2152 and 2153 adjacent to the field concentrated part 2202. Each of the field concentrated parts 2200, 2201, and 2202 has a line-like planar shape as viewed in the thickness direction of the TFT substrate 2070 and extends in an extension direction indicated by the arrow AY. As illustrated in FIG. 22, the field concentrated parts 2200, 2201, and 2202 are arranged in a direction indicated by the arrow AX. As illustrated in FIG. 22, the field concentrated part 2200 is at an intermediate position between the line-like electrode 2150 and the line-like electrode 2151. The field concentrated part 2201 is at an intermediate position between the line-like electrode 2151 and the line-like electrode 2152. The field concentrated part 2202 is at an intermediate position between the line-like electrode 2152 and the line-like electrode 2153. The generated fringe fields pass through the liquid crystal layer 2071, as indicated by electric lines of force 2210 illustrated in FIG. 22.

2.5 Partition

The partition 2081 includes a line-like partition 2220, a line-like partition 2221, a line-like partition 2222, and a line-like partition 2223 illustrated in FIGS. 19 and 22. The line-like partitions 2220, 2221, 2222, and 2223 as a first line-like partition are arranged on the line-like electrodes 2150, 2151, 2152, and 2153 respectively and extend in a direction substantially parallel to the direction of the alignment film 2094. The line-like partitions 2220, 2221, 2222, and 2223 may be formed only in partial regions on the line-like electrodes 2150, 2151, 2152, and 2153 respectively. As illustrated in FIG. 19, each of the line-like partitions 2220, 2221, 2222, and 2223 has a line-like planar shape as viewed in the thickness direction of the TFT substrate 2070 and extends in the extension direction indicated by the arrow AY, like the field concentrated parts 2190, 2191, 2192, and 2193. As illustrated in FIG. 22, the line-like partitions 2220, 2221, 2222, and 2223 are arranged on the field concentrated parts 2190, 2191, 2192, and 2193 respectively. As illustrated in FIG. 22, each of the line-like partitions 2220, 2221, 2222, and 2223 partitions the liquid crystal layer 2071 in a partitioning direction indicated by the arrow AX.

The partition 2081 further includes a line-like partition 2230, a line-like partition 2231, and a line-like partition 2232 illustrated in FIGS. 19 and 22. The line-like partitions 2230, 2231, and 2232 as a second line-like partition are arranged between the line-like electrodes 2150, 2151, 2152, and 2153 and extend in a direction substantially parallel to the direction of the alignment film 2094. As illustrated in FIG. 19, each of the line-like partitions 2230, 2231, and 2232 has a line-like planar shape as viewed in the thickness direction of the TFT substrate 2070 and extends in the extension direction indicated by the arrow AY, like each of the field concentrated parts 2200, 2201, and 2202. As illustrated in FIG. 22, the line-like partitions 2230, 2231, and 2232 are arranged on the field concentrated parts 2200, 2201, ands 2202 respectively. As illustrated in FIG. 22, each of the line-like partitions 2230, 2231, and 2232 partitions the liquid crystal layer 2071 in a partitioning direction indicated by the arrow AX.

The alignment film 2082 includes a line-like alignment film 2250, a line-like alignment film 2251, a line-like alignment film 2252, a line-like alignment film 2253, a line-like alignment film 2260, a line-like alignment film 2261, and a line-like alignment film 2262. As illustrated in FIGS. 19 and 22, the line-like alignment films 2250, 2251, 2252, 2253, 2260, 2261, and 2262 cover the line-like partitions 2220, 2221, 2222, 2223, 2230, 2231, and 2232 respectively. As illustrated in FIGS. 20, 21, and 22, the alignment film 2082 has a surface 2270 contacting the liquid crystal layer 2071. The surface 2270 of the alignment film 2082 is subjected to alignment process by means of a rubbing or photo-alignment method, for example. Thus, the surface 2270 of the alignment film 2082 has an alignment capability of aligning liquid crystal molecules in the liquid crystal layer 2071 in a particular direction. A direction in which liquid crystal molecules are aligned in the surface 2270 of the alignment film 2082 as a second alignment film agrees with a direction in which liquid crystal molecules are aligned in the upper main surface 2140 of the alignment film 2094 as a first alignment film. The alignment film 2082 is desirably a photo-alignment film subjected to alignment process by means of a photo-alignment method.

The partition 2081 desirably has a height of two-thirds or more of a liquid crystal cell gap as a gap between a part of the TFT substrate 2070 other than the partition 2081 and the alignment film 2082, and the CF substrate 1032.

2.6 Replacement with Line-Like Partition Having Forward Tapered Shape

If the alignment capability of the surface 2270 of the alignment film 2082 illustrated in FIGS. 20, 21, and 22 is achieved by employing a photo-alignment system, the line-like partitions 2220, 2221, 2222, 2223, 2230, 2231, and 2232 each having a side surface pointed in the extension direction of the TFT substrate 2070 may be replaced, according to an alignment condition, with line-like partitions each having a side surface pointed in a direction tilted from the extension direction of the TFT substrate 2070. Namely, each of the line-like partitions 2220, 2221, 2222, 2223, 2230, 2231, and 2232 may be replaced with a line-like partition having a forward tapered shape with a width that gets smaller with a greater distance from the TFT substrate 2070. This replacement causes light to easily impinge on a part of the alignment film 2082 covering a side surface of the line-like partition, making it possible to give an alignment capability to the surface 2270 of the alignment film 2082 easily by means of alignment process using an ultraviolet ray.

2.7 Replacement with Line-Like Electrode or Line-Like Partition Further Functioning as Light Shield

To suppress leakage of light due to instability of the direction of the liquid crystal director occurring near the line-like partitions 2220, 2221, 2222, and 2223 illustrated in FIGS. 19 and 22, the line-like electrodes 2150, 2151, 2152, and 2153 having the same widths as the line-like partitions 2220, 2221, 2222, and 2223 respectively may be replaced with line-like electrodes made of a non-transparent material and having greater widths than the line-like partitions 2220, 2221, 2222, and 2223. This replacement makes the line-like electrode further function as a light shield to suppress leakage of light. Alternatively, each of the line-like partitions 2220, 2221, 2222, 2223, 2230, 2231, and 2232 may be replaced with a line-like partition having a forward tapered shape made of a non-transparent material. This replacement makes the line-like partition further function as a light shield to suppress leakage of light.

2.8 Analysis of Response Speed During Falling Time by Simulation

In the following description, response speed during the falling time in the absence of a partition such as the partition 2081 and response speed during the falling time in the presence of a partition such as the partition 2081 are analyzed by simulation to show that response time during the falling time in the presence of a partition such as the partition 2081 is about one-third of response time during the falling time in the absence of a partition such as the partition 2081.

A used simulator is LCDMaster 2D (Ver. 8.5.2) available from SHINTECH, Inc. Table 1 given above shows the physical property values of the liquid crystal material MS-5355XX-K forming a liquid crystal layer in a structure model used in the simulation. Table 2 given above shows common parameters common to structure models used in the simulation. The structure models used in the simulation were simplified to a maximum within a range in which the appropriateness of the structure models can be guaranteed.

2.9 Analysis of Response Speed During Falling Time by Simulation in the Absence of Partition

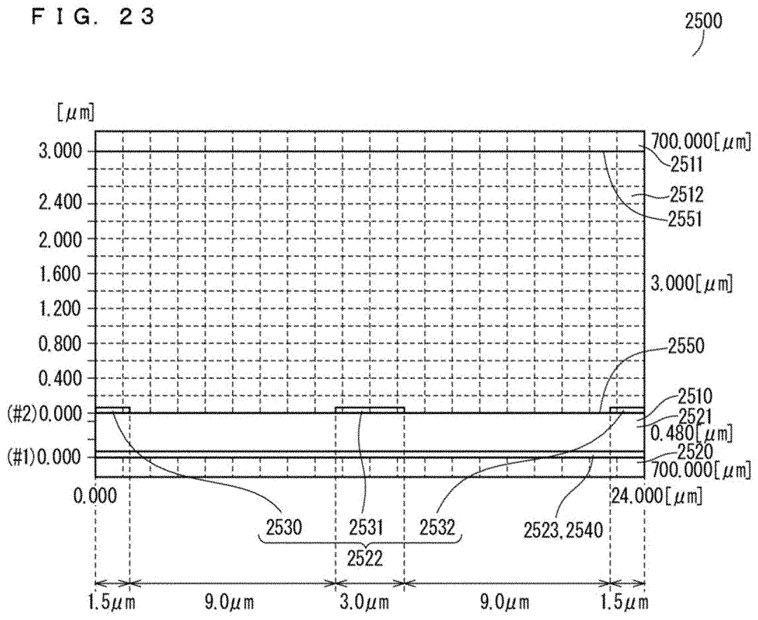

FIG. 23 is a sectional view illustrating a section of a structure model used for analyzing response speed during the falling time by simulation in the absence of a partition.

A structure model 2500 illustrated in FIG. 23 is produced by modeling a minimum recurring unit of a liquid crystal cell of the fringe field switching (FFS) system, and includes a lower substrate 2510, an upper counter substrate 2511, and a liquid crystal layer 2512. The lower substrate 2510 includes a lower glass substrate 2520, an organic planarizing film 2521, an image signal line slit electrode 2522, and a common potential line lower electrode 2523. The image signal line slit electrode 2522 includes a line-like electrode 2530, a line-like electrode 2531, and a line-like electrode 2532. The common potential line lower electrode 2523 includes a sheet-like electrode 2540.

The liquid crystal material MS-5355XX-K is poured in between an upper main surface 2550 of the lower substrate 2510 and a lower main surface 2551 of the upper counter substrate 2511 to form the liquid crystal layer 2512 made of the liquid crystal material MS-5355XX-K. An alignment film not illustrated covering the upper main surface 2550 of the lower substrate 2510 is subjected to alignment process for aligning liquid crystal molecules in the liquid crystal layer 2512 in a first direction. An alignment film not illustrated covering the lower main surface 2551 of the upper counter substrate 2511 is subjected to alignment process for aligning the liquid crystal molecules in the liquid crystal layer 2512 in a second direction perpendicular to the first direction. Each of the line-like electrodes 2530, 2531, and 2532 has a width of 3.0 μm. A gap between two adjacent ones of the line-like electrodes 2530, 2531, and 2532 is 9.0 μm. A liquid crystal cell gap, which is a distance from the upper main surface 2550 of the lower substrate 2510 to the lower main surface 2551 of the upper counter substrate 2511, is 3.0 μm.

2.10 Analysis of Response Speed During Falling Time by Simulation in the Presence of Partition

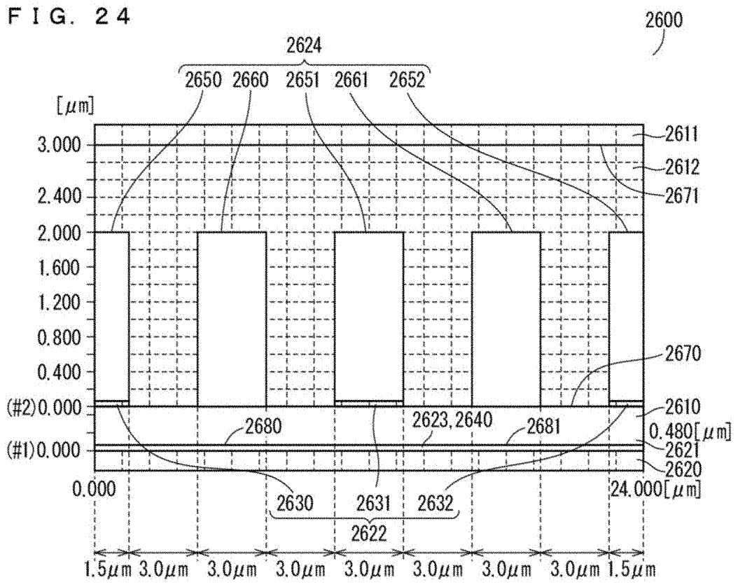

FIG. 24 is a sectional view illustrating a section of a structure model used for analyzing response speed during the falling time by simulation in the presence of a partition.

A structure model 2600 illustrated in FIG. 24 is produced by modeling a minimum recurring unit of a liquid crystal cell of the FFS system to which partition is added, and includes a lower substrate 2610, an upper counter substrate 2611, and a liquid crystal layer 2612. The lower substrate 2610 includes a lower glass substrate 2620, an organic planarizing film 2621, an image signal line slit electrode 2622, a common potential line lower electrode 2623, and a partition 2624. The image signal line slit electrode 2622 includes a line-like electrode 2630, a line-like electrode 2631, and a line-like electrode 2632. The common potential line lower electrode 2623 includes a sheet-like electrode 2640. The partition 2624 includes a line-like partition 2650, a line-like partition 2651, a line-like partition 2652, a line-like partition 2660, and a line-like partition 2661.

The liquid crystal material MS-5355XX-K is poured in between an upper main surface 2670 of the lower substrate 2610 and a lower main surface 2671 of the upper counter substrate 2611 to form the liquid crystal layer 2612 made of the liquid crystal material MS-5355XX-K. An alignment film not illustrated covering the upper main surface 2670 of the lower substrate 2610 is subjected to alignment process for aligning liquid crystal molecules in the liquid crystal layer 2612 in a first direction. An alignment film not illustrated covering the lower main surface 2671 of the upper counter substrate 2611 is subjected to alignment process for aligning the liquid crystal molecules in the liquid crystal layer 2612 in a second direction perpendicular to the first direction. Each of the line-like electrodes 2630, 2631, and 2632 has a width of 3.0 μm. A gap between two adjacent ones of the line-like electrodes 2630, 2631, and 2632 is 9.0 μm. A liquid crystal cell gap is 3.0 μm.

The line-like partitions 2650, 2651, and 2652 are arranged on the line-like electrodes 2630, 2631, and 2632 respectively.

The line-like partition 2660 is arranged on a field concentrated part 2680 at an intermediate position between the position of the line-like electrode 2630 and the position of the line-like electrode 2631. The line-like partition 2661 is arranged on a field concentrated part 2681 at an intermediate position between the position of the line-like electrode 2631 and the position of the line-like electrode 2632.

Each of the line-like partitions 2650, 2651, 2652, 2660, and 2661 has a height of 2.0 μm lower than the liquid crystal cell gap. This forms a gap of a height of 1.0 μm between each of the line-like partitions 2650, 2651, 2652, 2660, and 2661 and the upper counter substrate 2611.

2.11 Comparison Between the Absence of Partition and the Presence of Partition

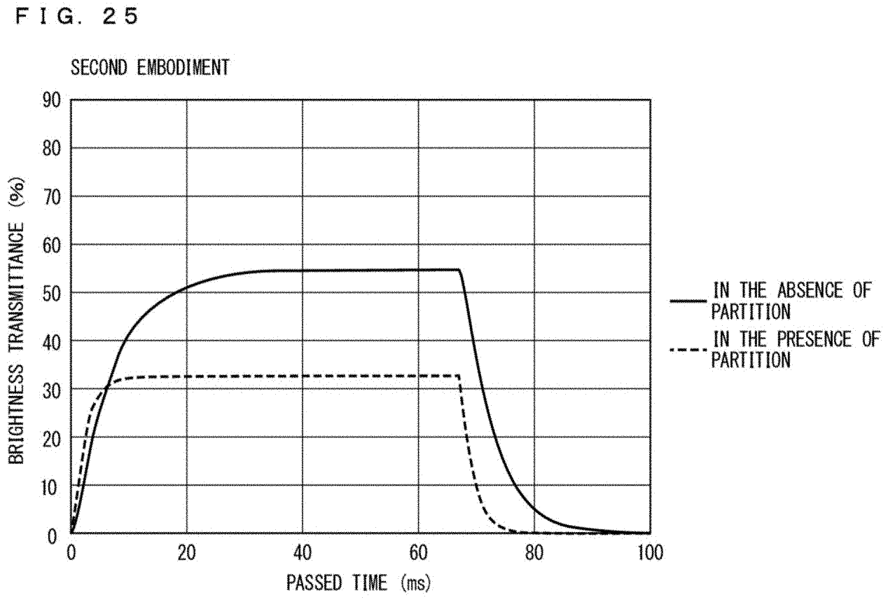

FIG. 25 is a graph showing response curves obtained by evaluating response characteristics using the structure model in the absence of a partition illustrated in FIG. 23 and the structure model in the presence of a partition illustrated in FIG. 24.

The response characteristics were evaluated in the same manner as in the first embodiment.

As shown in FIG. 25, rising and falling of a response curve corresponding to use of the structure model 2600 in the presence of the partition 2624 illustrated in FIG. 24 are respectively steeper than rising and falling of a response curve corresponding to use of the structure model 2500 in the absence of a partition illustrated in FIG. 23.

Table 4 shows a rising period and a falling period determined by the use of the structure model 2500 illustrated in FIG. 23 in the absence of a partition and corresponding periods determined by the use of the structure model 2600 illustrated in FIG. 24 in the presence of the partition 2624.

TABLE 4
Second embodiment

| | Electrode | Gap between | Cell | Rising | Falling | Brightness |
|---|---|---|---|---|---|---|
| System | width | electrodes | gap | period | period | transmittance |
| Without partition | 3.0 μm | 9.0 μm | 3.0 μm | 16.4 ms | 12.4 ms | 66.4% |
| With partition | 3.0 μm | 9.0 μm | 3.0 μm | 5.0 ms | 5.2 ms | 32.7% |

As understood from Table 4, the falling period determined by the use of the structure model 2600 illustrated in FIG. 24 in the presence of the partition 2624 is about one-third of the falling period determined by the use of the structure model 2500 illustrated in FIG. 23 in the absence of a partition.

### 3. Third Embodiment

3.1 Main Difference Between First Embodiment and Third Embodiment

A third embodiment relates to a liquid crystal display of the horizontal field system.

The first embodiment and the third embodiment differ from each other mainly in the following. In the first embodiment, the partition 1081 is arranged on the image signal line slit electrode 1124 and the common potential line slit electrode 1125. In the third embodiment, while a partition is arranged on the image signal line slit electrode 1124, a partition is not arranged on the common potential line slit electrode 1125. Structures or modifications thereof employed in liquid crystal displays of the other embodiments may also be employed in the liquid crystal display of the third embodiment within a range in which structures resulting in the foregoing main difference can be employed without any interference.

3.2 Liquid Crystal Display, Liquid Crystal Panel, and Display Region

The schematic view of FIG. 1 is also a perspective view illustrating the liquid crystal display of the third embodiment. The schematic view of FIG. 2 is also a sectional view illustrating a section of a liquid crystal panel provided in the liquid crystal display of the third embodiment. The schematic view of FIG. 3 is also a plan view illustrating a TFT substrate, a printed board, and an integrated circuit chip provided in the liquid crystal display of the third embodiment.

3.3 Configuration of TFT Substrate

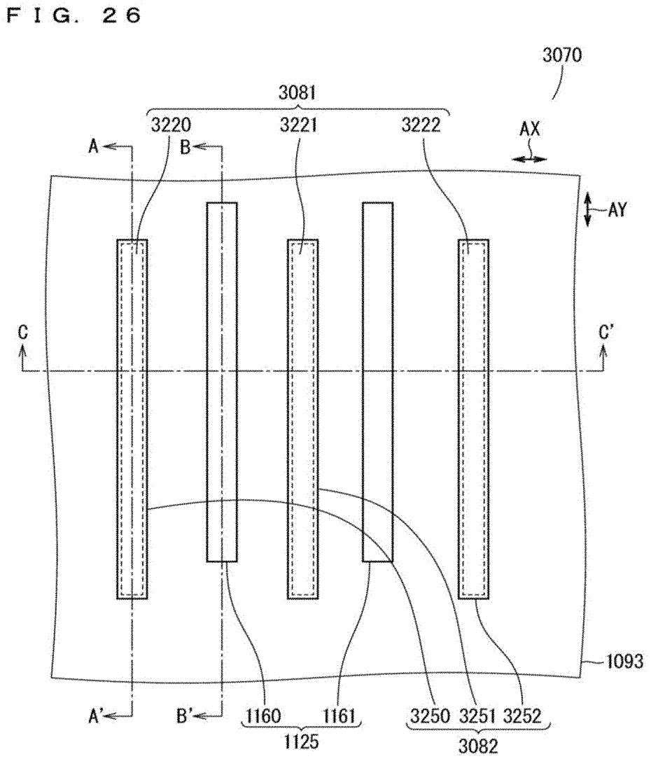

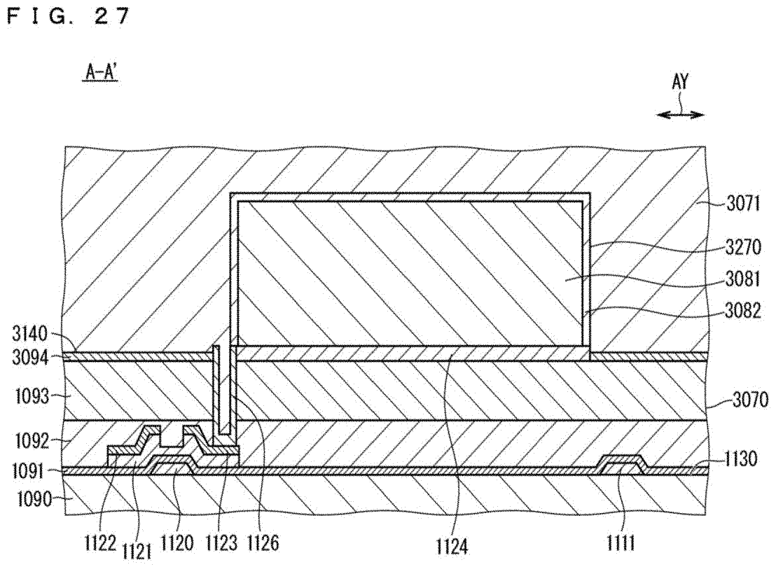

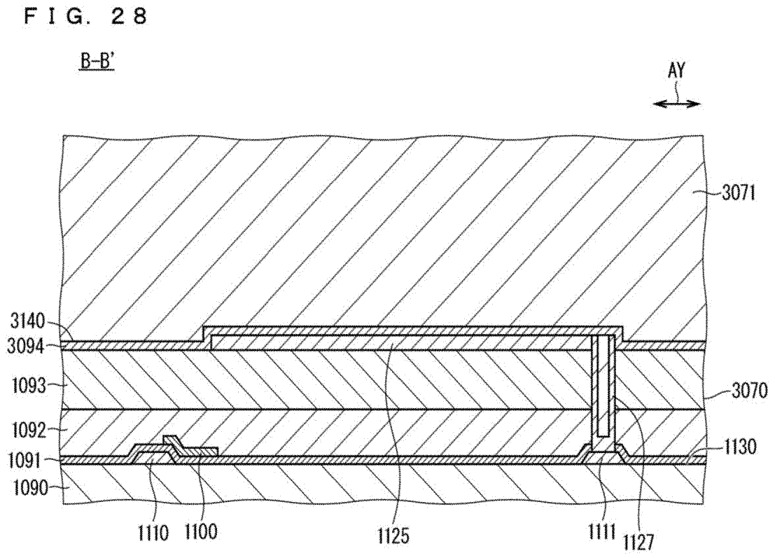

The schematic view of FIG. 4 is also a plan view illustrating planar arrangement of a line, an electrode, and a semiconductor channel layer provided in the liquid crystal display of the third embodiment. The schematic view of FIG. 26 is a plan view illustrating planar arrangement of an organic planarizing film, an electrode, a partition, and an alignment film provided in the liquid crystal display of the third embodiment. FIGS. 27, 28, and 29 are sectional views each illustrating sections of the TFT substrate and a liquid crystal layer provided in the liquid crystal display of the third embodiment.

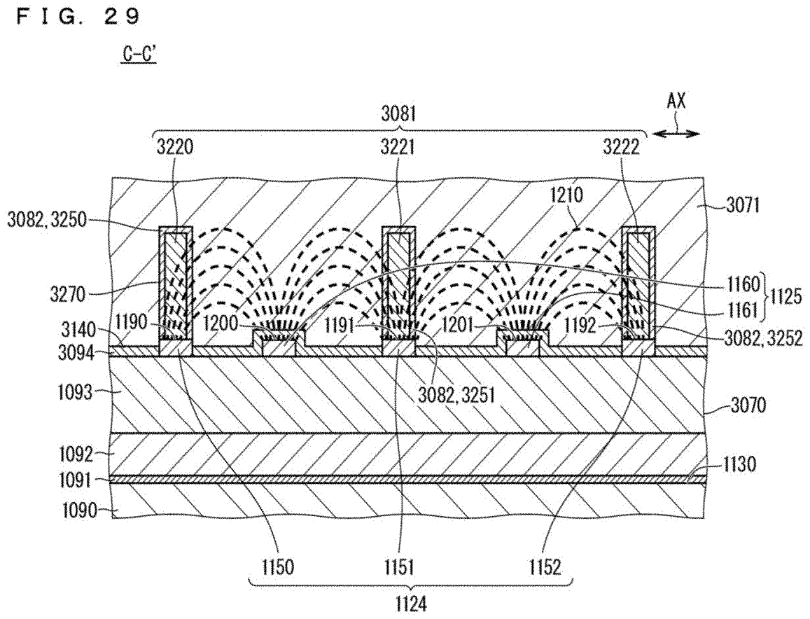

FIG. 27 illustrates a section taken at a position along a cutting line A-A′ in FIGS. 4 and 26. FIG. 28 illustrates a section taken at a position along a cutting line B-B′ in FIGS. 4 and 26. FIG. 29 illustrates a section taken at a position along a cutting line C-C′ in FIGS. 4 and 26.

FIGS. 4, 26, 27, 28, and 29 illustrate the each pixel region 1060 illustrated in FIG. 3.

A TFT substrate 3070 illustrated in FIGS. 4, 26, 27, 28, and 29 becomes the TFT substrate 1030 illustrated in FIGS. 1, 2, and 3. A liquid crystal layer 3071 illustrated in FIGS. 27, 28, and 29 becomes the liquid crystal layer 1031 illustrated in FIG. 2.

FIG. 4 illustrates the image signal line 1100, the scanning line 1110, the common potential line 1111, the scanning line electrode 1120, the semiconductor channel layer 1121, the image signal line electrode 1122, the image signal line electrode 1123, the image signal line slit electrode 1124, the common potential line slit electrode 1125, the image signal line through hole group 1126, and the common potential line through hole group 1127 provided in the TFT substrate 3070, which are structures corresponding to those of the first embodiment.

FIG. 26 illustrates the organic planarizing film 1093 and the common potential line slit electrode 1125 provided in the TFT substrate 3070, which are structures corresponding to those of the first embodiment. FIG. 26 further illustrates a partition 3081 and an alignment film 3082 provided in the TFT substrate 3070.

FIG. 27 illustrates the glass substrate 1090, the scanning line insulating film 1091, the interlayer insulating film 1092, the organic planarizing film 1093, the common potential line 1111, the scanning line electrode 1120, the semiconductor channel layer 1121, the image signal line electrode 1122, the image signal line electrode 1123, the image signal line slit electrode 1124, and the image signal line through hole group 1126 provided in the TFT substrate 3070, which are structures corresponding to those of the first embodiment. FIG. 27 further illustrates an alignment film 3094, a partition 3081, and an alignment film 3082 provided in the TFT substrate 3070.

FIG. 28 illustrates the glass substrate 1090, the scanning line insulating film 1091, the interlayer insulating film 1092, the organic planarizing film 1093, the image signal line 1100, the scanning line 1110, the common potential line 1111, the common potential line slit electrode 1125, and the common potential line through hole group 1127 provided in the TFT substrate 3070, which are structures corresponding to those of the first embodiment. FIG. 28 further illustrates the alignment film 3094 provided in the TFT substrate 3070.

FIG. 29 illustrates the glass substrate 1090, the scanning line insulating film 1091, the interlayer insulating film 1092, the organic planarizing film 1093, the image signal line slit electrode 1124, and the common potential line slit electrode 1125 provided in the TFT substrate 3070, which are structures corresponding to those of the first embodiment. FIG. 29 further illustrates the alignment film 3094, the partition 3081, and the alignment film 3082 provided in the TFT substrate 3070.

The scanning line insulating film 1091, the scanning line electrode 1120, the semiconductor channel layer 1121, the image signal line electrode 1122, and the image signal line electrode 1123 form a TFT. The image signal line slit electrode 1124 and the common potential line slit electrode 1125 form a pixel electrode.

The image signal line slit electrode 1124 includes the line-like electrodes 1150, 1151, and 1152 illustrated in FIGS. 4 and 29, which are structures corresponding to those of the first embodiment. The common potential line slit electrode 1125 includes the line-like electrodes 1160 and 1161 illustrated in FIGS. 4 and 29, which are structures corresponding to those of the first embodiment.

As illustrated in FIGS. 27, 28, and 29, the alignment film 3094 is stacked on the organic planarizing film 1093 and the common potential line slit electrode 1125 and arranged over the upper main surface 1130 of the glass substrate 1090. The alignment film 3094 has an upper main surface 3140 forming the upper main surface of the TFT substrate 3070 and contacting the liquid crystal layer 3071. The upper main surface 3140 of the alignment film 3094 is subjected to alignment process by means of a rubbing or photo-alignment method, for example. Thus, the upper main surface 3140 of the alignment film 3094 has an alignment capability of aligning liquid crystal molecules in the liquid crystal layer 3071 in a particular alignment direction.

The partition 3081 desirably has a height of two-thirds or more of a liquid crystal cell gap as a gap between a part of the TFT substrate 3070 other than the partition 3081 and the alignment film 3082, and the CF substrate 1032.

3.4 Generation of Horizontal Field

Like in the first embodiment, in response to application of an ON signal to the scanning line electrode 1120 illustrated in FIGS. 4 and 27, a driving voltage is applied between the image signal line slit electrode 1124 illustrated in FIGS. 4, 27, and 29 and the common potential line slit electrode 1125 illustrated in FIGS. 4, 26, 28, and 29.

When the driving voltage is applied between the image signal line slit electrode 1124 as a first pixel electrode and the common potential line slit electrode 1125 as a second pixel electrode, a horizontal field is generated between the field concentrated part 1200 as a second field concentrated part occupying a substantially entire upper surface of the line-like electrode 1160, and the field concentrated parts 1190 and 1191 as a first field concentrated part respectively occupying substantially entire upper surfaces of the line-like electrodes 1150 and 1151 adjacent to the line-like electrode 1160, as illustrated in FIG. 29. Further, a horizontal field is generated between the field concentrated part 1201 as the second field concentrated part occupying a substantially entire upper surface of the line-like electrode 1161, and the field concentrated parts 1191 and 1192 as the first field concentrated part respectively occupying substantially entire upper surfaces of the line-like electrodes 1151 and 1152 adjacent to the line-like electrode 1161. The generated horizontal fields pass through the liquid crystal layer 3071, as indicated by the electric lines of force 1210 illustrated in FIG. 29.

3.5 Partition

The partition 3081 includes a line-like partition 3220, a line-like partition 3221, and a line-like partition 3222 illustrated in FIGS. 26 and 29. The line-like partitions 3220, 3221, and 3222 are arranged on the line-like electrodes 1150, 1151, and 1152 respectively and are substantially parallel to the direction of the alignment film 3094. The line-like partitions 3220, 3221, and 3222 may be formed only in partial regions on the line-like electrodes 1150, 1151, and 1152 respectively. As illustrated in FIG. 26, each of the line-like partitions 3220, 3221, and 3222 has a line-like planar shape as viewed in the thickness direction of the TFT substrate 3070 and extends in the extension direction indicated by the arrow AY, like each of the field concentrated parts 1190, 1191, and 1192. As illustrated in FIG. 29, the line-like partitions 3220, 3221, and 3222 are arranged on the field concentrated parts 1190, 1191, and 1192 respectively. As illustrated in FIG. 29, each of the line-like partitions 3220, 3221, and 3222 partitions the liquid crystal layer 3071 in a partitioning direction indicated by the arrow AX.

Meanwhile, as illustrated in FIG. 29, a line-like partition is not arranged on the field concentrated parts 1200 and 1201.

The alignment film 3082 includes a line-like alignment film 3250, a line-like alignment film 3251, and a line-like alignment film 3251 illustrated in FIGS. 26 and 29. As illustrated in FIGS. 26 and 29, the line-like alignment films 3250, 3251, and 3251 cover the line-like partitions 3220, 3221, and 3222 respectively. As illustrated in FIGS. 27 and 29, the alignment film 3082 has a surface 3270 contacting the liquid crystal layer 3071. The surface 3270 of the alignment film 3082 is subjected to alignment process by means of a rubbing or photo-alignment method, for example. Thus, the surface 3270 of the alignment film 3082 has an alignment capability of aligning liquid crystal molecules in the liquid crystal layer 3071 in a particular direction. A direction in which liquid crystal molecules are aligned in the surface 3270 of the alignment film 3082 as a second alignment film agrees with a direction in which liquid crystal molecules are aligned in the upper main surface 3140 of the alignment film 3094 as a first alignment film. The alignment film 3082 is desirably a photo-alignment film subjected to alignment process by means of a photo-alignment method.

Like in the first embodiment, a line-like partition having a forward tapered shape may be used as an alternative, Further, a line-like electrode or a line-like partition further functioning as a light shield may be used as an alternative.

3.6 Analysis of Response Speed During Falling Time by Simulation

In the following description, response speed during the falling time in the presence of a partition such as the partition 3081 is analyzed by simulation to show that response time during the falling time in the presence of a partition such as the partition 3081 is about half of response time during the falling time in the absence of a partition such as the partition 3081.

A used simulator is LCDMaster 2D (Ver. 8.5.2) available from SHINTECH, Inc. Table 1 given above shows the physical property values of the liquid crystal material MS-5355XX-K forming a liquid crystal layer in a structure model used in the simulation. Table 2 given above shows common parameters common to structure models used in the simulation. The structure models used in the simulation were simplified to a maximum within a range in which the appropriateness of the structure models can be guaranteed.

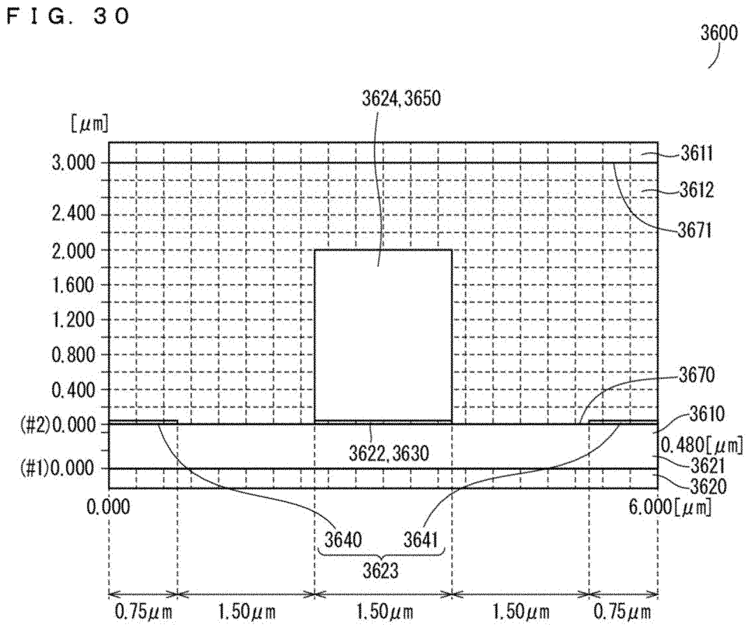

FIG. 30 is a sectional view illustrating a section of a structure model used for analyzing response speed during the falling time by simulation in the presence of a partition.

A structure model 3600 illustrated in FIG. 30 is produced by modeling a minimum recurring unit of a liquid crystal cell of the IPS system to which partition is added, and includes a lower substrate 3610, an upper counter substrate 3611, and a liquid crystal layer 3612. The lower substrate 3610 includes a lower glass substrate 3620, an organic planarizing film 3621, an image signal line slit electrode 3622, a common potential line slit electrode 3623, and a partition 3624. The image signal line slit electrode 3622 includes a line-like electrode 3630. The common potential line slit electrode 3623 includes a line-like electrode 3640 and a line-like electrode 3641. The partition 3624 includes a line-like partition 3650.

The liquid crystal material MS-5355XX-K is poured in between an upper main surface 3670 of the lower substrate 3610 and a lower main surface 3671 of the upper counter substrate 3611 to form the liquid crystal layer 3612 made of the liquid crystal material MS-5355XX-K. An alignment film not illustrated covering the upper main surface 3670 of the lower substrate 3610 is subjected to alignment process for aligning liquid crystal molecules in the liquid crystal layer 3612 in a first direction. An alignment film not illustrated covering the lower main surface 3671 of the upper counter substrate 3611 is subjected to alignment process for aligning the liquid crystal molecules in the liquid crystal layer 3612 in a second direction perpendicular to the first direction. Each of the line-like electrodes 3630, 3640, and 3641 has a width of 1.5 μM. A gap between two adjacent ones of the line-like electrodes 3630, 3640, and 3641 is 1.5 μm. A liquid crystal cell gap is 3.0 μm.

The line-like partition 3650 is arranged on the line-like electrodes 3630.

The line-like partition 3650 has a width of 1.5 μm like the line-like electrode 3630, and has a height of 2.0 μm lower than the liquid crystal cell gap. This forms a gap of a height of 1.0 μm between the line-like partition 3650 and the upper counter substrate 3611.

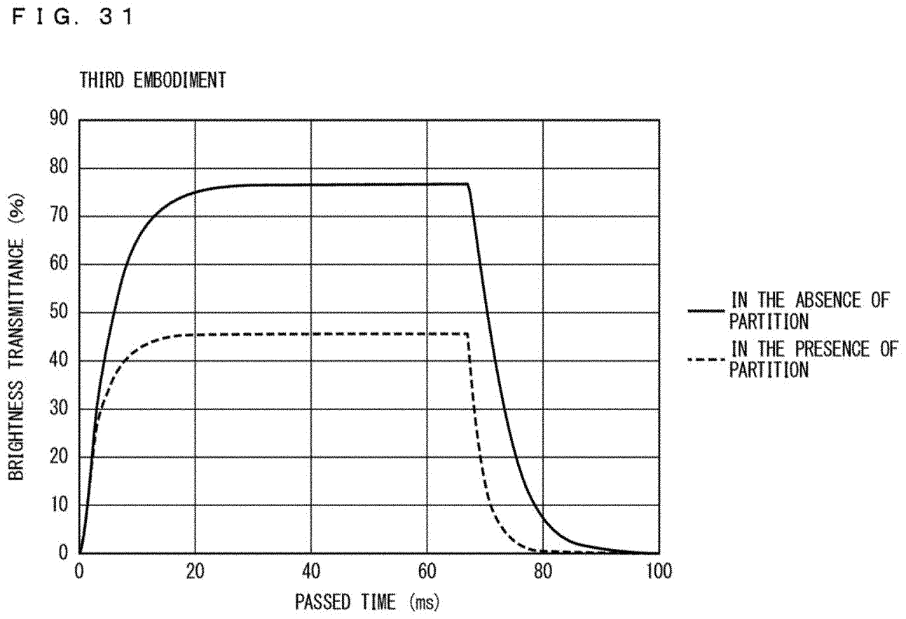

FIG. 31 is a graph showing response curves obtained by evaluating response characteristics using the structure model in the absence of a partition illustrated in FIG. 13 and the structure model in the presence of a partition illustrated in FIG. 30.

The response characteristics were evaluated in the same manner as in the first embodiment.

As illustrated in FIG. 31, rising and falling of a response curve corresponding to use of the structure model 3600 in the presence of the partition 3624 illustrated in FIG. 30 are respectively steeper than rising and falling of a response curve corresponding to use of the structure model 1500 in the absence of a partition illustrated in FIG. 13.

Table 5 shows a rising period and a falling period determined by the use of the structure model 1500 illustrated in FIG. 13 in the absence of a partition and corresponding periods determined by the use of the structure model 3600 illustrated in FIG. 30 in the presence of the partition 3624.

TABLE 5
Third embodiment

| | Electrode | Gap between | Cell | Rising | Falling | Brightness |
|---|---|---|---|---|---|---|
| System | width | electrodes | gap | period | period | transmittance |
| Without partition | 1.5 μm | 1.5 μm | 3.0 μm | 12.2 ms | 12.4 ms | 77.0% |
| With partition | 1.5 μm | 1.5 μm | 3.0 μm | 8.8 ms | 6.0 ms | 45.7% |

As understood from Table 5, the falling period determined by the use of the structure model 3600 illustrated in FIG. 30 in the presence of the partition 3624 is about half of the falling period determined by the use of the structure model 1500 illustrated in FIG. 13 in the absence of a partition.

3.7 Others

The image signal line slit electrode 1124 is equivalent in terms of potential difference to the common potential line slit electrode 1125. Thus, the effect of shortening a falling period can also be achieved by omitting a partition from above the image signal line slit electrode 1124 and arranging a partition on the common potential line slit electrode 1125 instead of arranging a partition on the image signal line slit electrode 1124 and omitting a partition from above the common potential line slit electrode 1125 as illustrated in FIG. 29.

### 4. Fourth Embodiment

4.1 Main Difference Between Second Embodiment and Fourth Embodiment

A fourth embodiment relates to a liquid crystal display of the horizontal field system.

The second embodiment and the fourth embodiment differ from each other mainly in the following. In the second embodiment, the partition 2081 is arranged on the field concentrated parts 2190, 2191, 2192, and 2193 at the image signal line slit electrode 2124 and on the field concentrated parts 2200, 2201, and 2202 at the common potential line lower electrode 2125, as illustrated in FIG. 22. In the fourth embodiment, while a partition is arranged on the field concentrated parts 2190, 2191, 2192, and 2193 at the image signal line slit electrode 2124, a partition is not arranged on the field concentrated parts 2200, 2201, and 2202 at the common potential line lower electrode 2125. Structures or modifications thereof employed in liquid crystal displays of the other embodiments may also be employed in the liquid crystal display of the fourth embodiment within a range in which structures resulting in the foregoing main difference can be employed without any interference.

4.2 Liquid Crystal Display, Liquid Crystal Panel, and Display Region of TFT Substrate

The schematic view of FIG. 1 is also a perspective view illustrating the liquid crystal display of the fourth embodiment. The schematic view of FIG. 2 is also a sectional view illustrating a section of a liquid crystal panel provided in the liquid crystal display of the fourth embodiment. The schematic view of FIG. 3 is also a plan view illustrating a TFT substrate, a printed board, and an integrated circuit chip provided in the liquid crystal display of the fourth embodiment.

4.3 Configuration of TFT Substrate

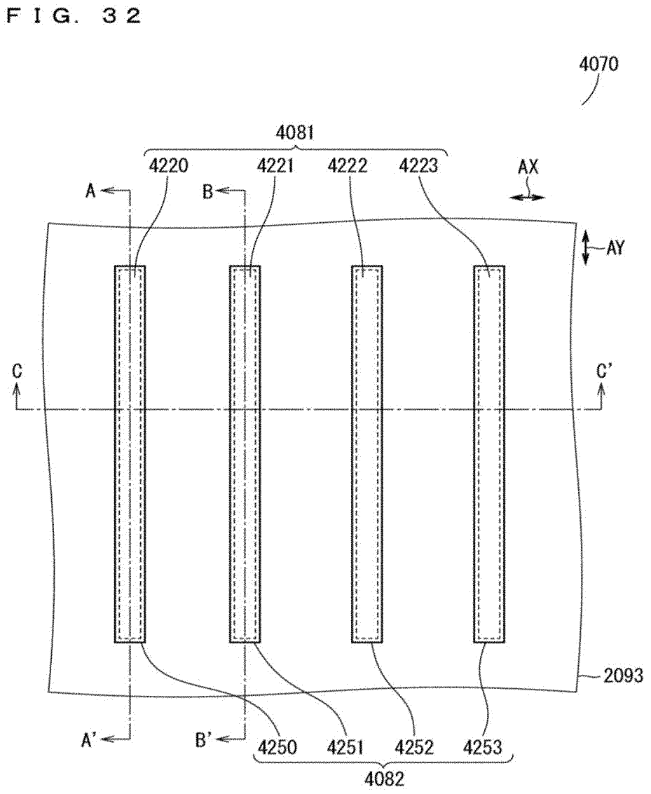

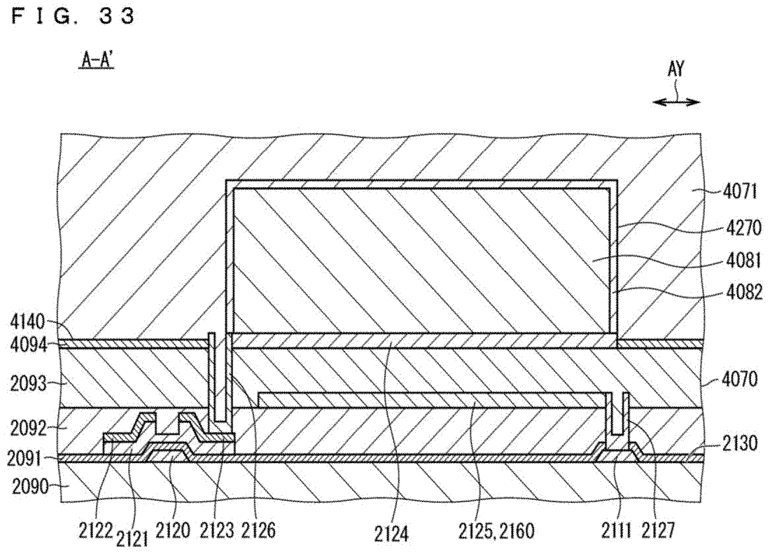

The schematic view of FIG. 18 is a plan view illustrating planar arrangement of a line, an electrode, and a semiconductor channel layer provided in the liquid crystal display of the fourth embodiment. The schematic view of FIG. 32 is a plan view illustrating planar arrangement of an organic planarizing film, a partition, and an alignment film provided in the liquid crystal display of the fourth embodiment. FIGS. 33, 34, and 35 are sectional views each illustrating sections of the TFT substrate and a liquid crystal layer provided in the liquid crystal display of the fourth embodiment.

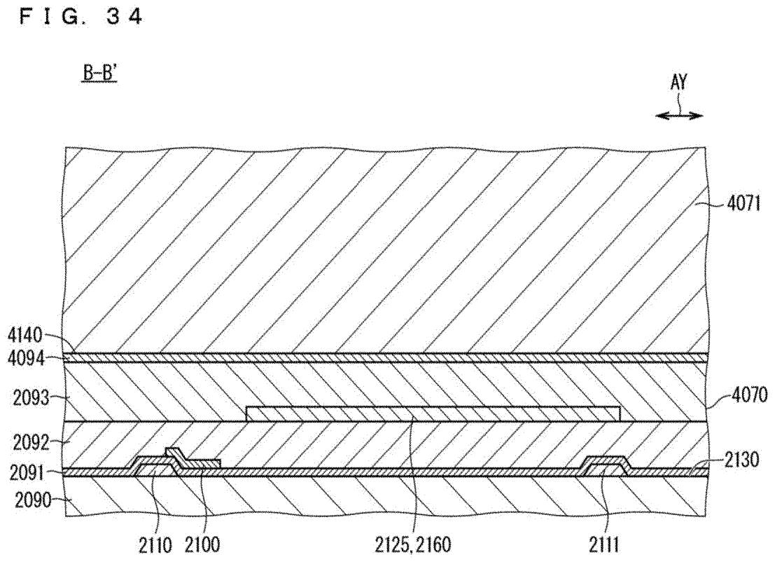

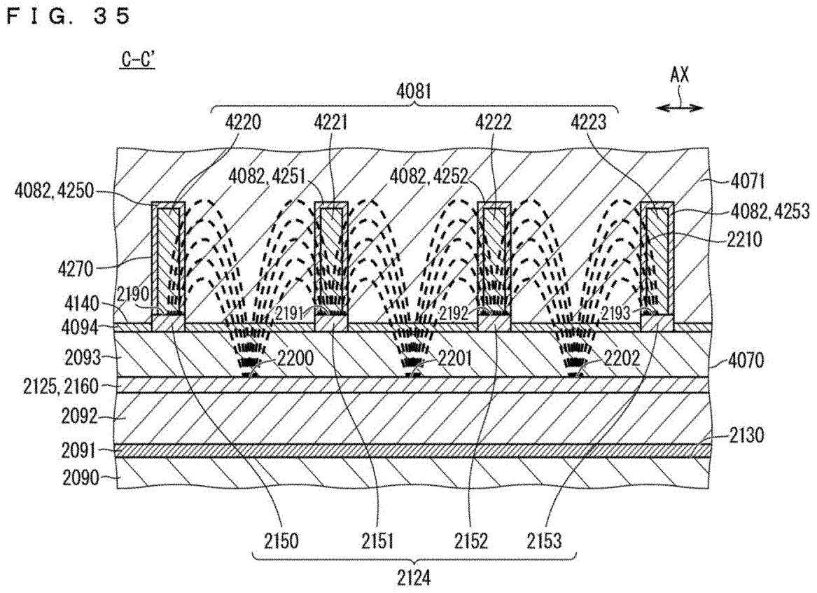

FIG. 33 illustrates a section taken at a position along a cutting line A-A′ in FIGS. 18 and 32. FIG. 34 illustrates a section taken at a position along a cutting line B-B′ in FIGS. 18 and 32. FIG. 35 illustrates a section taken at a position along a cutting line C-C′ in FIGS. 18 and 32.

A TFT substrate 4070 illustrated in FIGS. 18, 32, 33, 34, and 35 becomes the TFT substrate 1030 illustrated in FIGS. 1, 2, and 3. A liquid crystal layer 4071 illustrated in FIGS. 33, 34, and 35 becomes the liquid crystal layer 1031 illustrated in FIG. 2.

FIG. 18 illustrates the image signal line 2100, the scanning line 2110, the common potential line 2111, the scanning line electrode 2120, the semiconductor channel layer 2121, the image signal line electrode 2122, the image signal line electrode 2123, the image signal line slit electrode 2124, the common potential line lower electrode 2125, the image signal line through hole group 2126, and the common potential line through hole 2127 provided in the TFT substrate 4070, which are structures corresponding to those of the second embodiments.

FIG. 32 illustrates the organic planarizing film 2093 provided in the TFT substrate 4070, which is a structure corresponding to that of the second embodiment. FIG. 32 further illustrates a partition 4081 and an alignment film 4082 provided in the TFT substrate 4070.

FIG. 33 illustrates the glass substrate 2090, the scanning line insulating film 2091, the interlayer insulating film 2092, the organic planarizing film 2093, the common potential line 2111, the scanning line electrode 2120, the semiconductor channel layer 2121, the image signal line electrode 2122, the image signal line electrode 2123, the image signal line slit electrode 2124, the common potential line lower electrode 2125, the image signal line through hole group 2126, and the common potential line through hole 2127 provided in the TFT substrate 4070, which are structures corresponding to those of the second embodiment. FIG. 33 further illustrates an alignment film 4094, the partition 4081, and the alignment film 4082 provided in the TFT substrate 4070.

FIG. 34 illustrates the glass substrate 2090, the scanning line insulating film 2091, the interlayer insulating film 2092, the organic planarizing film 2093, the image signal line 2100, the scanning line 2110, the common potential line 2111, and the common potential line lower electrode 2125 provided in the TFT substrate 4070, which are structures corresponding to those of the second embodiment. FIG. 34 further illustrates the alignment film 4094 provided in the TFT substrate 4070.

FIG. 35 illustrates the glass substrate 2090, the scanning line insulating film 2091, the interlayer insulating film 2092, the organic planarizing film 2093, the image signal line slit electrode 2124, and the common potential line lower electrode 2125 provided in the TFT substrate 4070, which are structures corresponding to those of the second embodiment. FIG. 35 further illustrates the alignment film 4094, the partition 4081, and the alignment film 4082 provided in the TFT substrate 4070.

The scanning line insulating film 2091, the scanning line electrode 2120, the semiconductor channel layer 2121, the image signal line electrode 2122, and the image signal line electrode 2123 form a TFT. The image signal line slit electrode 2124 and the common potential line lower electrode 2125 form a pixel electrode.

The common potential line lower electrode 2125 includes the sheet-like electrode 2160 illustrated in FIGS. 18, 33, 34, and 35, which is a structure corresponding to that of the second embodiment. The image signal line slit electrode 2124 includes the line-like electrodes 2150, 2151, 2152, and 2153 illustrated in FIGS. 18 and 35, which are structures corresponding to those of the second embodiment.

As illustrated in FIGS. 33, 34, and 35, the alignment film 4094 is stacked on the organic planarizing film 2093 and arranged over the upper main surface 2130 of the glass substrate 2090. The alignment film 4094 has an upper main surface 4140 forming the upper main surface of the TFT substrate 4070 and contacting the liquid crystal layer 4071. The upper main surface 4140 of the alignment film 4094 is subjected to alignment process by means of a rubbing or photo-alignment method, for example. Thus, the upper main surface 4140 of the alignment film 4094 has an alignment capability of aligning liquid crystal molecules in the liquid crystal layer 4071 in a particular alignment direction.

The partition 4081 desirably has a height of two-thirds or more of a liquid crystal cell gap as a gap between a part of the TFT substrate 4070 other than the partition 4081 and the alignment film 4082, and the CF substrate 1032.

4.4 Generation of Horizontal Field

Like in the second embodiment, in response to application of an ON signal to the scanning line electrode 2120 illustrated in FIGS. 18 and 33, a driving voltage is applied between the image signal line slit electrode 2124 illustrated in FIGS. 18, 33, and 35 and the common potential line lower electrode 2125 illustrated in FIGS. 18, 34, and 35.

When the driving voltage is applied between the image signal line slit electrode 2124 as a first pixel electrode and the common potential line lower electrode 2125 as a second pixel electrode, the common potential line lower electrode 2125 becomes involved in a field from the image signal line slit electrode 2124. More specifically, as illustrated in FIG. 35, a fringe field is generated between the field concentrated part 2200 as a second field concentrated part occupying a part of the upper main surface of the sheet-like electrode 2160, and the field concentrated parts 2190 and 2191 as a first field concentrated part respectively occupying substantially entire upper surfaces of the line-like electrodes 2150 and 2151 adjacent to the field concentrated part 2200. A fringe field is generated between the field concentrated part 2201 as the second field concentrated part occupying a part of the upper main surface of the sheet-like electrode 2160, and the field concentrated parts 2191 and 2192 as the first field concentrated part respectively occupying substantially entire upper surfaces of the line-like electrodes 2151 and 2152 adjacent to the field concentrated part 2201. Further, a fringe field is generated between the field concentrated part 2202 as the second field concentrated part occupying a part of the upper main surface of the sheet-like electrode 2160, and the field concentrated parts 2192 and 2193 as the first field concentrated part respectively occupying substantially entire upper surfaces of the line-like electrodes 2152 and 2153 adjacent to the field concentrated part 2202. Each of the field concentrated parts 2200, 2201, and 2202 has a line-like planar shape as viewed in the thickness direction of the TFT substrate 4070 and extends in an extension direction indicated by the arrow AY. As illustrated in FIG. 35, the field concentrated parts 2200, 2201, and 2202 are arranged in a direction indicated by the arrow AX. As illustrated in FIG. 35, the field concentrated part 2200 is at an intermediate position between the line-like electrode 2150 and the line-like electrode 2151. The field concentrated part 2201 is at an intermediate position between the line-like electrode 2151 and the line-like electrode 2152. The field concentrated part 2202 is at an intermediate position between the line-like electrode 2152 and the line-like electrode 2153. The generated fringe fields pass through the liquid crystal layer 4071, as indicated by the electric lines of force 2210 illustrated in FIG. 35.

4.5 Partition

The partition 4081 includes a line-like partition 4220, a line-like partition 4221, a line-like partition 4222, and a line-like partition 4223 illustrated in FIGS. 32 and 35. The line-like partitions 4220, 4221, 4222, and 4223 are arranged on the line-like electrodes 2150, 2151, 2152, and 2153 respectively and extend in a direction substantially parallel to the direction of the alignment film 4094. The line-like partitions 4220, 4221, 4222, and 4223 may be formed only in partial regions on the line-like electrodes 2150, 2151, 2152, and 2153 respectively. As illustrated in FIG. 32, each of the line-like partitions 4220, 4201, 4202, and 4203 has a line-like planar shape as viewed in the thickness direction of the TFT substrate 4070 and extends in the extension direction indicated by the arrow AY, like each the field concentrated parts 2190, 2191, 2192, and 2193. As illustrated in FIG. 35, the line-like partitions 4220, 4221, 4222, and 4223 are arranged on the field concentrated parts 2190, 2191, 2192, and 2193 respectively. As illustrated in FIG. 35, each of the line-like partitions 4220, 4221, 4222, and 4223 partitions the liquid crystal layer 4071 in a partitioning direction indicated by the arrow AX.

Meanwhile, as illustrated in FIG. 35, a line-like partition is not arranged on the field concentrated parts 2200, 2201, and 2202.

The alignment film 4082 includes a line-like alignment film 4250, a line-like alignment film 4251, a line-like alignment film 4252, and a line-like alignment film 4253 illustrated in FIGS. 32 and 35. As illustrated in FIGS. 32 and 35, the line-like alignment films 4250, 4251, 4252, and 4253 cover the line-like partitions 4220, 4221, 4222, and 4223 respectively. As illustrated in FIGS. 33 and 35, the alignment film 4082 has a surface 4270 contacting the liquid crystal layer 4071. The surface 4270 of the alignment film 4082 is subjected to alignment process by means of a rubbing or photo-alignment method, for example. Thus, the surface 4270 of the alignment film 4082 has an alignment capability of aligning liquid crystal molecules in the liquid crystal layer 4071 in a particular alignment direction. A direction in which liquid crystal molecules are aligned in the surface 4270 of the alignment film 4082 as a second alignment film agrees with a direction in which liquid crystal molecules are aligned in the upper main surface 4140 of the alignment film 4094 as a first alignment film. The alignment film 4082 is desirably a photo-alignment film subjected to alignment process by means of a photo-alignment method.

Like in the second embodiment, a line-like partition having a forward tapered shape may be used as an alternative, Further, a line-like electrode or a line-like partition further functioning as a light shield may be used as an alternative.

4.6 Analysis of Response Speed During Falling Time by Simulation

In the following description, response speed during the falling time in the presence of a partition such as the partition 4081 is analyzed by simulation to show that response time during the falling time in the presence of a partition such as the partition 4081 is shorter than response time during the falling time in the absence of a partition such as the partition 4081.

A used simulator is LCDMaster 2D (Ver. 8.5.2) available from SHINTECH, Inc. Table 1 given above shows the physical property values of the liquid crystal material MS-5355XX-K forming a liquid crystal layer in a structure model used in the simulation. Table 2 given above shows common parameters common to structure models used in the simulation. The structure models used in the simulation were simplified to a maximum within a range in which the appropriateness of the structure models can be guaranteed.

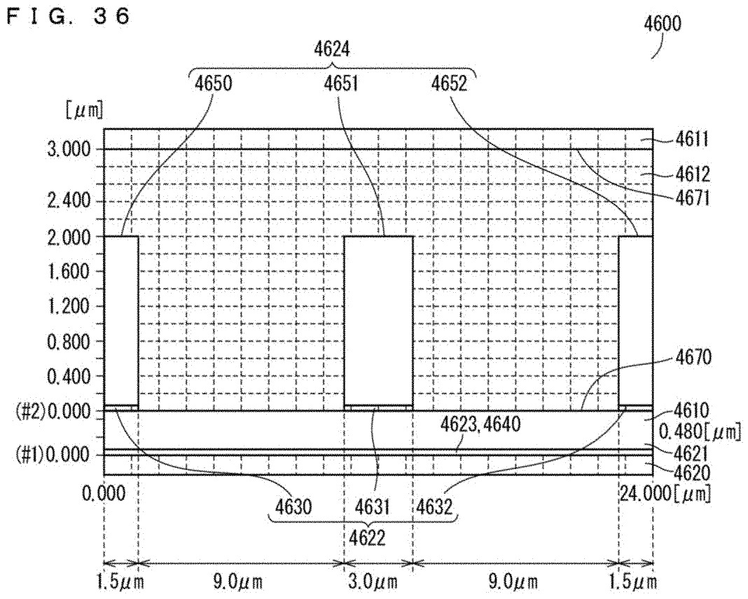

FIG. 36 is a sectional view illustrating a section of a structure model used for analyzing response speed during the falling time by simulation in the presence of a partition.

A structure model 4600 illustrated in FIG. 36 is produced by modeling a minimum recurring unit of a liquid crystal cell of the FFS system to which partition is added, and includes a lower substrate 4610, an upper counter substrate 4611, and a liquid crystal layer 4612. The lower substrate 4610 includes a lower glass substrate 4620, an organic planarizing film 4621, an image signal line slit electrode 4622, a common potential line lower electrode 4623, and a partition 4624. The image signal line slit electrode 4622 includes a line-like electrode 4630, a line-like electrode 4631, and a line-like electrode 4632. The common potential line lower electrode 4623 includes a sheet-like electrode 4640.

The liquid crystal material MS-5355XX-K is poured in between an upper main surface 4670 of the lower substrate 4610 and a lower main surface 4671 of the upper counter substrate 4611 to form the liquid crystal layer 4612 made of the liquid crystal material MS-5355XX-K. An alignment film not illustrated covering the upper main surface 4670 of the lower substrate 4610 is subjected to alignment process for aligning liquid crystal molecules in the liquid crystal layer 4612 in a first direction. An alignment film not illustrated covering the lower main surface 4671 of the upper counter substrate 4611 is subjected to alignment process for aligning the liquid crystal molecules in the liquid crystal layer 4612 in a second direction perpendicular to the first direction. Each of the line-like electrodes 4630, 4631, and 4632 has a width of 3.0 μm. A gap between two adjacent ones of the line-like electrodes 4630, 4631, and 4632 is 9.0 μm. A liquid crystal cell gap is 3.0 μm.

A line-like partition 4650, a line-like partition 4651, and a line-like partition 4652 are arranged on the line-like electrodes 4630, 4631, and 4632 respectively.

Each of line-like partitions 4650, 4651, and 4652 has a height of 2.0 μm lower than the liquid crystal cell gap. This forms a gap of a height of 1.0 μm between each of the line-like partitions 4650, 4651, and 4652, and the upper counter substrate 4611.

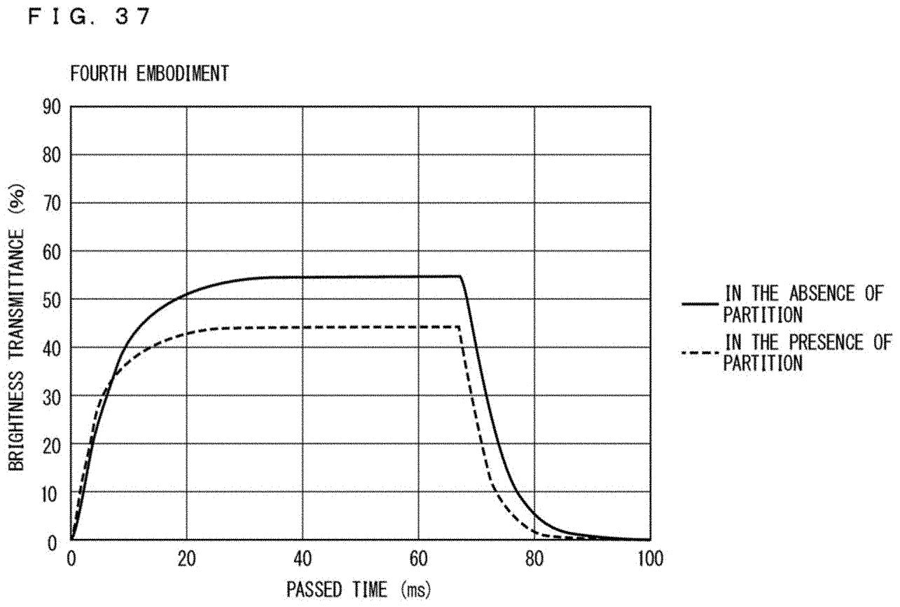

FIG. 37 is a graph showing response curves obtained by evaluating response characteristics using the structure model in the absence of a partition illustrated in FIG. 23 and the structure model in the presence of a partition illustrated in FIG. 36.

The response characteristics were evaluated in the same manner as in the first embodiment.

As illustrated in FIG. 37, rising and falling of a response curve corresponding to use of the structure model 4600 in the presence of the partition 4624 illustrated in FIG. 36 are respectively steeper than rising and falling of a response curve corresponding to use of the structure model 2500 in the absence of a partition illustrated in FIG. 23.

Table 6 shows a rising period and a falling period determined by the use of the structure model 2500 illustrated in FIG. 23 in the absence of a partition and corresponding periods determined by the use of the structure model 4600 illustrated in FIG. 36 in the presence of the partition 4624.

TABLE 6
Fourth embodiment

| | Electrode | Gap between | Cell | Rising | Falling | Brightness |
|---|---|---|---|---|---|---|
| System | width | electrodes | gap | period | period | transmittance |
| Without partition | 3.0 μm | 9.0 μm | 3.0 μm | 16.4 ms | 12.4 ms | 66.4% |
| With partition | 3.0 μm | 9.0 μm | 3.0 μm | 13.0 ms | 9.2 ms | 44.3% |

As understood from Table 6, the falling period determined by the use of the structure model 4600 illustrated in FIG. 36 in the presence of the partition 4624 is shorter than the falling period determined by the use of the structure model 2500 illustrated in FIG. 23 in the absence of a partition.

### 5. Fifth Embodiment

5.1 Main Difference Between Second Embodiment and Fifth Embodiment

A fifth embodiment relates to a liquid crystal display of the horizontal field system.

The second embodiment and the fifth embodiment differ from each other mainly in the following. In the second embodiment, the partition 2081 is arranged on the field concentrated parts 2190, 2191, 2192, and 2193 at the image signal line slit electrode 2124 and on the field concentrated parts 2200, 2201, and 2202 at the common potential line lower electrode 2125. In the fifth embodiment, while a partition is arranged on the field concentrated parts 2200, 2201, and 2202 at the common potential line lower electrode 2125, a partition is not arranged on the field concentrated parts 2190, 2191, 2192, and 2193 at the image signal line slit electrode 2124. Structures or modifications thereof employed in liquid crystal displays of the other embodiments may also be employed in the liquid crystal display of the fifth embodiment within a range in which structures resulting in the foregoing main difference can be employed without any interference.

5.2 Liquid Crystal Display, Liquid Crystal Panel, and Display Region of TFT Substrate

The schematic view of FIG. 1 is also a perspective view illustrating the liquid crystal display of the fifth embodiment. The schematic view of FIG. 2 is also a sectional view illustrating a section of a liquid crystal panel provided in the liquid crystal display of the fifth embodiment. The schematic view of FIG. 3 is also a plan view illustrating a TFT substrate, a printed board, and an integrated circuit chip provided in the liquid crystal display of the fifth embodiment.

5.3 Configuration of TFT Substrate

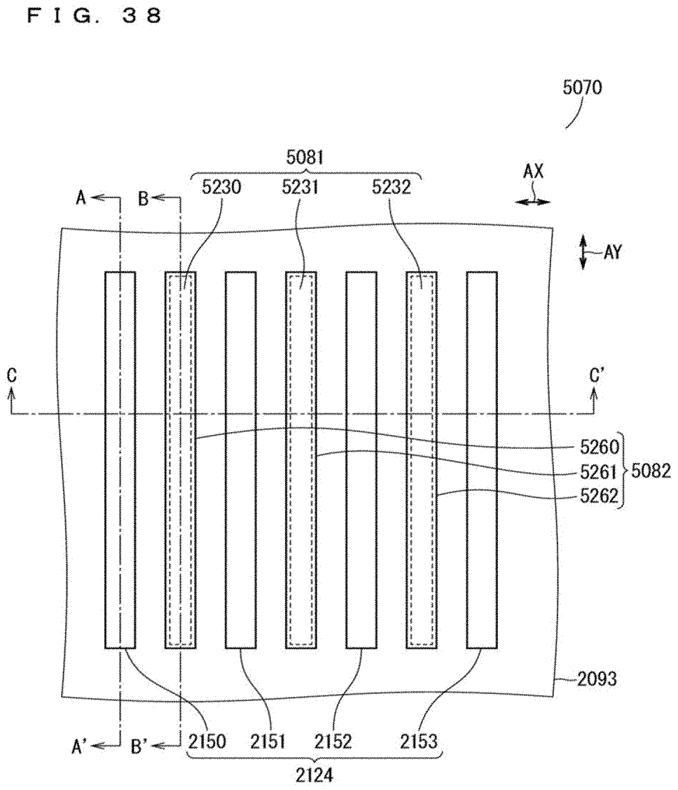

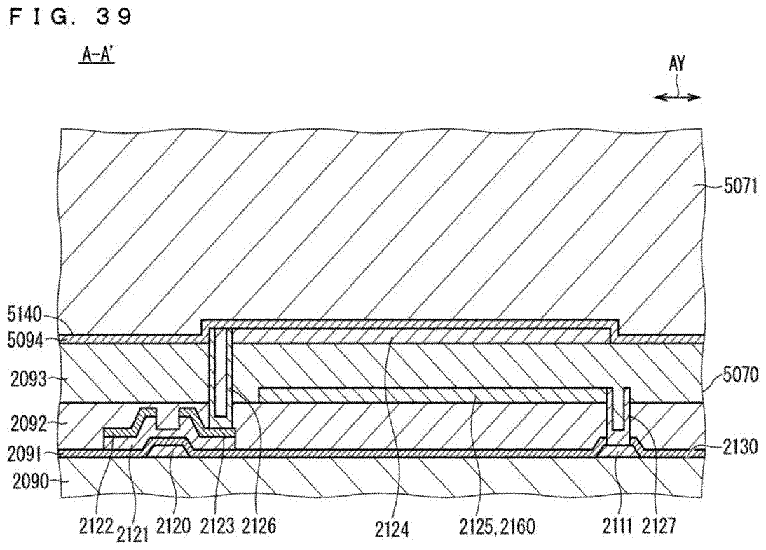

The schematic view of FIG. 18 is a plan view illustrating planar arrangement of a line, an electrode, and a semiconductor channel layer provided in the liquid crystal display of the fifth embodiment. The schematic view of FIG. 38 is a plan view illustrating planar arrangement of an organic planarizing film, an electrode, a partition, and an alignment film provided in the liquid crystal display of the fifth embodiment. FIGS. 39, 40, and 41 are sectional views each illustrating sections of the TFT substrate and a liquid crystal layer provided in the liquid crystal display of the fifth embodiment.

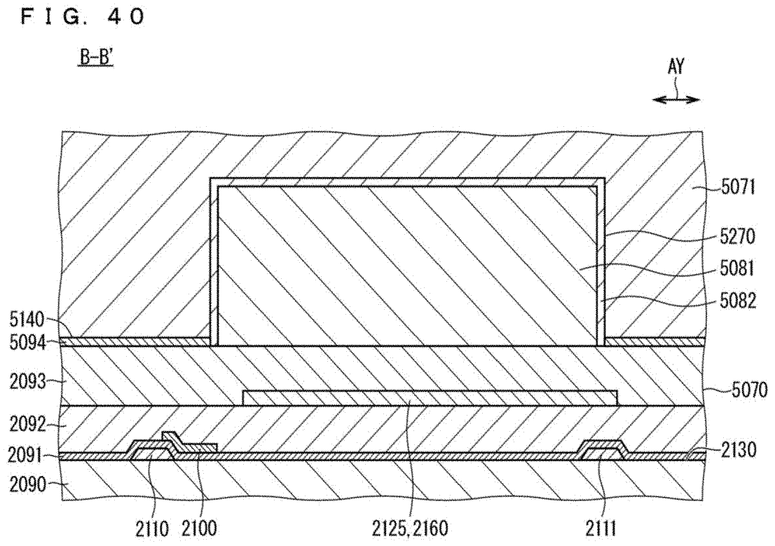

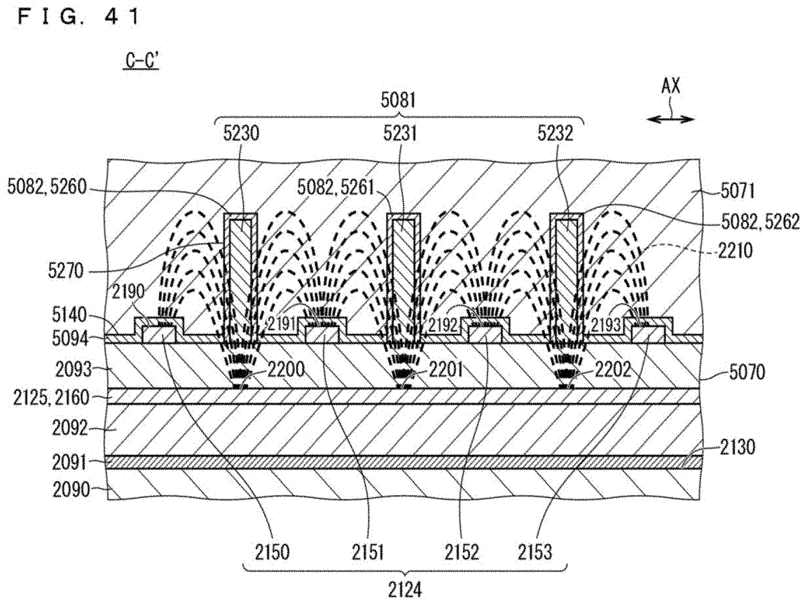

FIG. 39 illustrates a section taken at a position along a cutting line A-A′ in FIGS. 18 and 38. FIG. 40 illustrates a section taken at a position along a cutting line B-B′ in FIGS. 18 and 38. FIG. 41 illustrates a section taken at a position along a cutting line C-C′ in FIGS. 18 and 38.

FIGS. 18, 38, 39, 40, and 41 illustrate the each pixel region 1060 illustrated in FIG. 3.

A TFT substrate 5070 illustrated in FIGS. 18, 38, 39, 40, and 41 becomes the TFT substrate 1030 illustrated in FIGS. 1, 2, and 3. A liquid crystal layer 5071 illustrated in FIGS. 39, 40, and 41 becomes the liquid crystal layer 1031 illustrated in FIG. 2

FIG. 18 illustrates the image signal line 2100, the scanning line 2110, the common potential line 2111, the scanning line electrode 2120, the semiconductor channel layer 2121, the image signal line electrode 2122, the image signal line electrode 2123, the image signal line slit electrode 2124, the common potential line lower electrode 2125, the image signal line through hole group 2126, and the common potential line through hole 2127 provided in the TFT substrate 5070, which are structures corresponding to those of the second embodiment.

FIG. 38 illustrates the organic planarizing film 2093 and the image signal line slit electrode 2124 provided in the TFT substrate 5070, which are structures corresponding to those of the second embodiment. FIG. 38 further illustrates a partition 5081 and an alignment film 5082 provided in the TFT substrate 4070.

FIG. 39 illustrates the glass substrate 2090, the scanning line insulating film 2091, the interlayer insulating film 2092, the organic planarizing film 2093, the common potential line 2111, the scanning line electrode 2120, the semiconductor channel layer 2121, the image signal line electrode 2122, the image signal line electrode 2123, the image signal line slit electrode 2124, the common potential line lower electrode 2125, the image signal line through hole group 2126, and the common potential line through hole 2127 provided in the TFT substrate 5070, which are structures corresponding to those of the second embodiment. FIG. 39 further illustrates an alignment film 5094 provided in the TFT substrate 5070.

FIG. 40 illustrates the glass substrate 2090, the scanning line insulating film 2091, the interlayer insulating film 2092, the organic planarizing film 2093, the image signal line 2100, the scanning line 2110, the common potential line 2111, and the common potential line lower electrode 2125 provided in the TFT substrate 5070, which are structures corresponding to those of the second embodiment. FIG. 40 further illustrates the alignment film 5094, the partition 5081, and the alignment film 5082 provided in the TFT substrate 5070.

FIG. 41 illustrates the glass substrate 2090, the scanning line insulating film 2091, the interlayer insulating film 2092, the organic planarizing film 2093, the image signal line slit electrode 2124, and the common potential line lower electrode 2125 provided in the TFT substrate 5070, which are structures corresponding to those of the second embodiment. FIG. 41 further illustrates the alignment film 5094, the partition 5081, and the alignment film 5082 provided in the TFT substrate 5070.

The scanning line insulating film 2091, the scanning line electrode 2120, the semiconductor channel layer 2121, the image signal line electrode 2122, and the image signal line electrode 2123 form a TFT. The image signal line slit electrode 2124 and the common potential line lower electrode 2125 form a pixel electrode.

The common potential line lower electrode 2125 includes the sheet-like electrode 2160 illustrated in FIGS. 18, 39, 40, and 41, which is a structure corresponding to that of the second embodiment. The image signal line slit electrode 2124 includes the line-like electrodes 2150, 2151, 2152, and 2153 illustrated in FIGS. 18 and 41, which are structures corresponding to those of the second embodiment.

As illustrated in FIGS. 39, 40, and 41, the alignment film 5094 is stacked on the organic planarizing film 2093 and the image signal line slit electrode 2124 and arranged over the upper main surface 2130 of the glass substrate 2090. The alignment film 5094 has an upper main surface 5140 forming the upper main surface of the TFT substrate 5070 and contacting the liquid crystal layer 5071. The upper main surface 5140 of the alignment film 5094 is subjected to alignment process by means of a rubbing or photo-alignment method, for example. Thus, the upper main surface 5140 of the alignment film 5094 has an alignment capability of aligning liquid crystal molecules in the liquid crystal layer 5071 in a particular alignment direction.

The partition 5081 desirably has a height of two-thirds or more of a liquid crystal cell gap as a gap between a part of the TFT substrate 5070 other than the partition 5081 and the alignment film 5082, and the CF substrate 1032.

5.4 Generation of Horizontal Field

Like in the second embodiment, in response to application of an ON signal to the scanning line electrode 2120 illustrated in FIGS. 18 and 39, a driving voltage is applied between the image signal line slit electrode 2124 illustrated in FIGS. 18, 38, 39, and 41 and the common potential line lower electrode 2125 illustrated in FIGS. 18, 39, 40, and 41.

When the driving voltage is applied between the image signal line slit electrode 2124 as a first pixel electrode and the common potential line lower electrode 2125 as a second pixel electrode, the common potential line lower electrode 2125 becomes involved in a field from the image signal line slit electrode 2124. More specifically, as illustrated in FIG. 41, a fringe field is generated between the field concentrated part 2200 as a second field concentrated part occupying a part of the upper main surface of the sheet-like electrode 2160, and the field concentrated parts 2190 and 2191 as a first field concentrated part respectively occupying substantially entire upper surfaces of the line-like electrodes 2150 and 2151 adjacent to the field concentrated part 2200. As illustrated in FIG. 41, a fringe field is generated between the field concentrated part 2201 as the second field concentrated part occupying a part of the upper main surface of the sheet-like electrode 2160, and the field concentrated parts 2191 and 2192 as the first field concentrated part respectively occupying substantially entire upper surfaces of the line-like electrodes 2151 and 2152 adjacent to the field concentrated part 2201. Further, as illustrated in FIG. 41, a fringe field is generated between the field concentrated part 2202 as the second field concentrated part occupying a part of the upper main surface of the sheet-like electrode 2160, and the field concentrated parts 2192 and 2193 as the first field concentrated part respectively occupying substantially entire upper surfaces of the line-like electrodes 2152 and 2153 adjacent to the field concentrated part 2202. Each of the field concentrated parts 2200, 2201, and 2202 has a line-like planar shape as viewed in the thickness direction of the TFT substrate 5070 and extends in an extension direction indicated by the arrow AY. As illustrated in FIG. 41, the field concentrated parts 2200, 2201, and 2202 are arranged in a direction indicated by the arrow AX. As illustrated in FIG. 41, the field concentrated part 2200 is at an intermediate position between the line-like electrode 2150 and the line-like electrode 2151. The field concentrated part 2201 is at an intermediate position between the line-like electrode 2151 and the line-like electrode 2152. The field concentrated part 2202 is at an intermediate position between the line-like electrode 2152 and the line-like electrode 2153. The generated fringe fields pass through the liquid crystal layer 5071, as indicated by the electric lines of force 2210 illustrated in FIG. 41.

5.5 Partition

The partition 5081 includes a line-like partition 5230, a line-like partition 5231, and a line-like partition 5232 illustrated in FIGS. 38 and 41. The line-like partitions 5230, 5231, and 5232 are arranged between the line-like electrodes 2150, 2151, 2152, and 2153 and extend in a direction substantially parallel to the direction of the alignment film 5094. As illustrated in FIG. 38, each of the line-like partitions 5230, 5231, and 5232 has a line-like planar shape as viewed in the thickness direction of the TFT substrate 5070 and extends in the extension direction indicated by the arrow AY, like each of the field concentrated parts 2200, 2201, and 2202. As illustrated in FIG. 41, the line-like partitions 5230, 5231, and 5232 are arranged on the field concentrated parts 2200, 2201, and 2202 respectively. As illustrated in FIG. 41, each of the line-like partitions 5230, 5231, and 5232 partitions the liquid crystal layer 5071 in a partitioning direction indicated by the arrow AX.

Meanwhile, as illustrated in FIG. 41, a line-like partition is not arranged on the field concentrated parts 2190, 2191, 2192, and 2193.

The alignment film 5082 includes a line-like alignment film 5260, a line-like alignment film 5261, and a line-like alignment film 5262 illustrated in FIGS. 38 and 41. As illustrated in FIGS. 38 and 41, the line-like alignment films 5260, 5261, and 5262 cover the line-like partitions 5230, 5231, and 5232 respectively. As illustrated in FIGS. 40 and 41, the alignment film 5082 has a surface 5270 contacting the liquid crystal layer 5071. The surface 5270 of the alignment film 5082 is subjected to alignment process by means of a rubbing or photo-alignment method, for example. Thus, the surface 5270 of the alignment film 5082 has an alignment capability of aligning liquid crystal molecules in the liquid crystal layer 5071 in a particular alignment direction. A direction in which liquid crystal molecules are aligned in the surface 5270 of the alignment film 5082 as a second alignment film agrees with a direction in which liquid crystal molecules are aligned in the upper main surface 5140 of the alignment film 5094 as a first alignment film. The alignment film 5082 is desirably a photo-alignment film subjected to alignment process by means of a photo-alignment method.

Like in the second embodiment, a line-like partition having a forward tapered shape may be used as an alternative, Further, a line-like electrode or a line-like partition further functioning as a light shield may be used as an alternative.

5.6 Analysis of Response Speed During Falling Time by Simulation

In the following description, response speed during the falling time in the presence of a partition such as the partition 5081 is analyzed by simulation to show that response time during the falling time in the presence of a partition such as the partition 5081 is shorter than response time during the falling time in the absence of a partition such as the partition 5081.

A used simulator is LCDMaster 2D (Ver. 8.5.2) available from SHINTECH, Inc. Table 1 given above shows the physical property values of the liquid crystal material MS-5355XX-K forming a liquid crystal layer in a structure model used in the simulation. Table 2 given above shows common parameters common to structure models used in the simulation. The structure models used in the simulation were simplified to a maximum within a range in which the appropriateness of the structure models can be guaranteed.

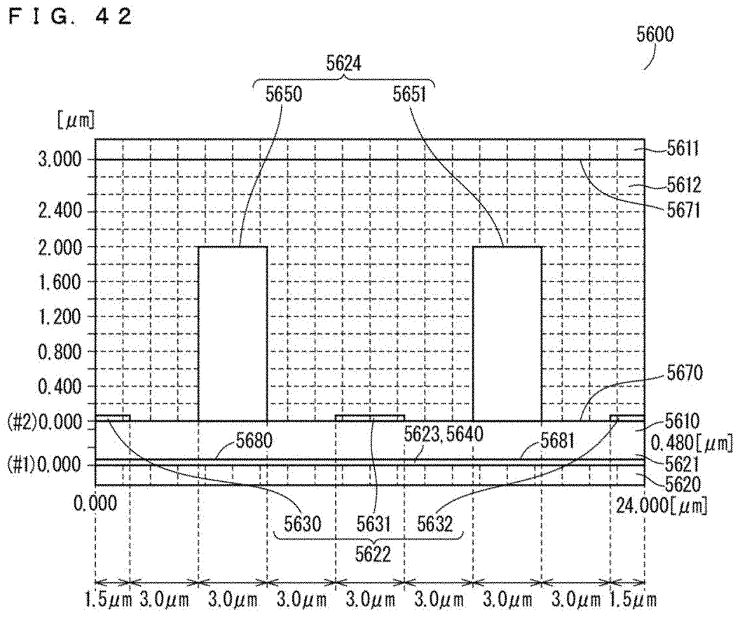

FIG. 42 is a sectional view illustrating a section of a structure model used for analyzing response speed during the falling time by simulation in the presence of a partition.

A structure model 5600 illustrated in FIG. 42 is produced by modeling a minimum recurring unit of a liquid crystal cell of the FFS system to which partition is added, and includes a lower substrate 5610, an upper counter substrate 5611, and a liquid crystal layer 5612. The lower substrate 5610 includes a lower glass substrate 5620, an organic planarizing film 5621, an image signal line slit electrode 5622, a common potential line lower electrode 5623, and a partition 5624. The image signal line slit electrode 5622 includes a line-like electrode 5630, a line-like electrode 5631, and a line-like electrode 5632. The common potential line lower electrode 5623 includes a sheet-like electrode 5640. The partition 5624 includes a line-like partition 5650 and a line-like partition 5651.

The liquid crystal material MS-5355XX-K is poured in between an upper main surface 5670 of the lower substrate 5610 and a lower main surface 5671 of the upper counter substrate 5611 to form the liquid crystal layer 5612 made of the liquid crystal material MS-5355XX-K. An alignment film not illustrated covering the upper main surface 5670 of the lower substrate 5610 is subjected to alignment process for aligning liquid crystal molecules in the liquid crystal layer 5612 in a first direction. An alignment film not illustrated covering the lower main surface 5671 of the upper counter substrate 5611 is subjected to alignment process for aligning the liquid crystal molecules in the liquid crystal layer 5612 in a second direction perpendicular to the first direction. Each of the line-like electrodes 5630, 5631, and 5632 has a width of 3.0 μm. A gap between two adjacent ones of the line-like electrodes 5630, 5631, and 5632 is 9.0 μm. A liquid crystal cell gap is 3.0 μm.

As illustrated in FIG. 42, the line-like partition 5650 is arranged on a field concentrated part 5680 at an intermediate position between the position of the line-like electrode 5630 and the position of the line-like electrode 5631. The line-like partition 5651 is arranged on a field concentrated part 5681 at an intermediate position between the position of the line-like electrode 5631 and the position of the line-like electrode 5632. Each of line-like partitions 5650 and 5651 has a width of 3.0 μm and a height of 2.0 μm lower than the liquid crystal cell gap. This forms a gap of a height of 1.0 μm between each of the line-like partitions 5650 and 5651, and the upper counter substrate 5611.

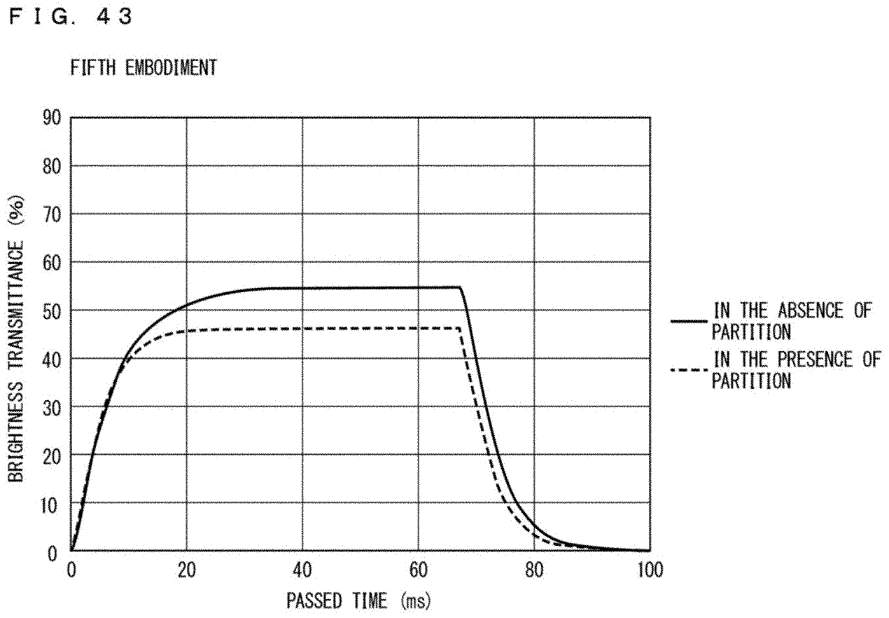

FIG. 43. is a graph showing response curves obtained by evaluating response characteristics using the structure model in the absence of a partition illustrated in FIG. 23 and the structure model in the presence of a partition illustrated in FIG. 42.

The response characteristics were evaluated in the same manner as in the first embodiment.

As illustrated in FIG. 43, rising and falling of a response curve corresponding to use of the structure model 5600 in the presence of the partition 5624 illustrated in FIG. 42 are respectively steeper than rising and falling of a response curve corresponding to use of the structure model 2500 in the absence of a partition illustrated in FIG. 23.

Table 7 shows a rising period and a falling period determined by the use of the structure model 2500 illustrated in FIG. 23 in the absence of a partition and corresponding periods determined by the use of the structure model 5600 illustrated in FIG. 42 in the presence of the partition 5624.

TABLE 7
Fifth embodiment

| | Electrode | Gap between | Cell | Rising | Falling | Brightness |
|---|---|---|---|---|---|---|
| System | width | electrodes | gap | period | period | transmittance |
| Without partition | 3.0 μm | 9.0 μm | 3.0 μm | 16.4 ms | 12.4 ms | 66.4% |
| With partition | 3.0 μm | 9.0 μm | 3.0 μm | 11.4 ms | 10.6 ms | 46.2% |

As understood from Table 7, the falling period determined by the use of the structure model 5600 illustrated in FIG. 42 in the presence of the partition 5624 is shorter than the falling period determined by the use of the structure model 2500 illustrated in FIG. 23 in the absence of a partition.

### 6. Sixth Embodiment

6.1 Main Difference Between Second Embodiment and Sixth Embodiment

A sixth embodiment relates to a liquid crystal display of the horizontal field system.

The second embodiment and the sixth embodiment differ from each other mainly in the following. In the second embodiment, the liquid crystal layer 2071 is made of positive-type liquid crystal. By contrast, in the sixth embodiment, a liquid crystal layer is made of negative-type liquid crystal. Structures or modifications thereof employed in liquid crystal displays of the other embodiments may also be employed in the liquid crystal display of the sixth embodiment within a range in which structures resulting in the foregoing main difference can be employed without any interference.

6.2 Liquid Crystal Display

The liquid crystal display of the sixth embodiment is the same as the liquid crystal display of the second embodiment except that the liquid crystal layer 2071 made of positive-type liquid crystal is replaced with a liquid crystal layer made of negative-type liquid crystal. Further, a partition extends in a direction along a lower polarizing axis.

The theoretical analysis of response speed during the falling time described in the first embodiment shows that replacing the liquid crystal layer 2071 made of positive-type liquid crystal with a liquid crystal layer made of negative-type liquid crystal merely results in change in an initial alignment direction by 90°, so that shortening of response time using a partition is still expected. This also applies to a case where the liquid crystal layer made of positive-type liquid crystal provided in each of the first and third to fifth embodiments is replaced with a liquid crystal layer made of negative-type liquid crystal.

6.3 Analysis of Response Speed During Falling Time by Simulation

The following describes analysis of response speed during the falling time by the simulation described in the second embodiment conducted after replacing a liquid crystal layer made of positive-type liquid crystal with a liquid crystal layer made of negative-type liquid crystal.

A used simulator is LCDMaster 2D (Ver. 8.5.2) available from SHINTECH, Inc. Table 8 shows the physical property values of a liquid crystal material forming a liquid crystal layer in a structure model used in the simulation. Table 2 given above shows common parameters common to structure models used in the simulation with exception that a rubbing angle and a lower polarizing axis angle is changed from 83° to −7.

TABLE 8

| | Wavelength | | |
|---|---|---|---|
| | (nm) | Ordinary light (no) | Extraordinary light (ne) |
| Refractive index | 450 | 1.504 | 1.638 |
| | 550 | 1.492 | 1.614 |
| | 650 | 1.486 | 1.602 |

| | | |
|---|---|---|
| Relative | εp | 2.9 |
| permittivity | εs | 7.5 |
| Elastic constant | K11 | 14.6 |
| (pN) | K22 | 9.8 |
| | K33 | 19.1 |
| Viscosity | γ1 | 0.099 |
| constant (Pa · s) | | |

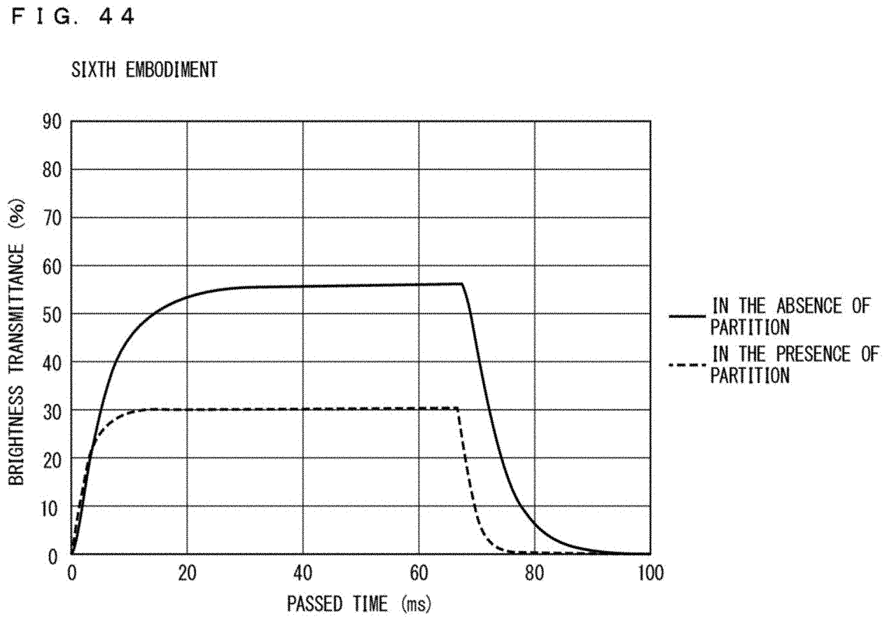

FIG. 44 is a graph showing response curves resulting from replacement of a liquid crystal layer made of positive-type liquid crystal with a liquid crystal layer made of negative-type liquid crystal and obtained by evaluating response characteristics using the structure model 2500 illustrated in FIG. 23 and the structure model 2600 illustrated in FIG. 24.

As shown in FIG. 44, rising and falling of a response curve corresponding to use of the structure model 2600 illustrated in FIG. 24 are respectively steeper than rising and falling of a response curve corresponding to use of the structure model 2500 illustrated in FIG. 23.

Table 9 shows a rising period and a falling period determined by the use of the structure model 2500 illustrated in FIG. 23 and corresponding periods determined by the use of the structure model 2600 illustrated in FIG. 24.

TABLE 9
Sixth embodiment

| | Electrode | Gap between | Cell | Rising | Falling | Brightness |
|---|---|---|---|---|---|---|
| System | width | electrodes | gap | period | period | transmittance |
| Without partition | 3.0 μm | 9.0 μm | 3.0 μm | 15.0 ms | 13.0 ms | 56.1% |
| With partition | 3.0 μm | 9.0 μm | 3.0 μm | 6.4 ms | 4.4 ms | 30.3% |

As understood from Table 9, the falling period determined by the use of the structure model 2600 illustrated in FIG. 24 is about one-third of the falling period determined by the use of the structure model 2500 illustrated in FIG. 23.

The embodiments of the present invention can be combined freely, and each embodiment can be modified or omitted, where appropriate, within a range of the invention.

While the invention has been shown and described in detail, the foregoing description is in all aspects illustrative and does not restrict the invention. It is therefore understood that numerous modifications not illustrated can be devised without departing from the scope of the invention.

### EXPLANATION OF REFERENCE SIGNS

1124, 2124 Image signal line slit electrode, 1125 Common potential line slit electrode, 2125 Common potential line lower electrode, 1081, 2081, 3081, 4081, 5081 Partition, 1071, 2071, 3071, 4071, 5071 Liquid crystal layer

1-13. (canceled)

14. A liquid crystal display comprising:
a first substrate;
a second substrate; and
a liquid crystal layer caught between the first substrate and the second substrate and containing liquid crystal molecules,
the first substrate including:
a first alignment film having a main surface forming a main surface of the first substrate, contacting the liquid crystal layer, and having an alignment capability of aligning the liquid crystal molecules in a particular alignment direction;
a first pixel electrode with line-like segments extending in a particular direction; and
a second pixel electrode extending in an extension direction substantially parallel to the first pixel electrode and including line-like segments arranged alternately with the line-like segments of the first pixel electrode,
the first substrate including:
line-like partitions arranged on the line-like segments of the first pixel electrode and substantially parallel to a direction of the first alignment film;
the first substrate including:
a second alignment film covering the line-like partitions, and having a surface contacting the liquid crystal layer, and having an alignment capability of aligning the liquid crystal molecules in the particular alignment direction.

15. The liquid crystal display according to claim 14, wherein
the line-like partitions are first line-like partitions,
the first substrate further includes second line-like partitions arranged on the line-like segments of the second pixel electrode and substantially parallel to the direction of the first alignment film, and
the second alignment film further covers the second line-like partitions.

16. The liquid crystal display according to claim 14, wherein
the line-like partitions are formed only in partial regions on the line-like segments of the first pixel electrode.

17. The liquid crystal display according to claim 15, wherein
the second line-like partitions are formed only in partial regions on the line-like segments of the second pixel electrode.

18. The liquid crystal display according to claim 14, wherein
the liquid crystal layer is made of negative-type liquid crystal.

19. The liquid crystal display according to claim 14, wherein
the line-like partitions each have a height of two-thirds or more of a gap between a part of the first substrate other than the line-like partitions and the second alignment film, and the second substrate.

20. The liquid crystal display according to claim 15, wherein
the second line-like partitions each have a height of two-thirds or more of a gap between a part of the first substrate other than the first line-like partitions, the second line-like partitions and the second alignment film, and the second substrate.

21. The liquid crystal display according to claim 14, wherein
the second alignment film is a photo-alignment film.

22. The liquid crystal display according to claim 14, wherein
the second alignment film has a side surface pointed in a direction tilted from an extension direction of the first substrate and subjected to alignment process using an ultraviolet ray.

23. A liquid crystal display comprising:
a first substrate;
a second substrate; and
a liquid crystal layer caught between the first substrate and the second substrate and containing liquid crystal molecules,
the first substrate including:
a first alignment film having a main surface forming a main surface of the first substrate, contacting the liquid crystal layer, and having an alignment capability of aligning the liquid crystal molecules in a particular alignment direction;
a first pixel electrode with line-like segments extending in a particular direction; and
a second pixel electrode with a sheet-like electrode involved in a field from the first pixel electrode,
the first substrate further including:
an insulating film that separates the first pixel electrode from the second pixel electrode in the thickness direction of the first substrate to insulate the first pixel electrode from the second pixel electrode,
the first substrate including:
line-like partitions arranged on the line-like segments of the first pixel electrode and extending in a direction substantially parallel to a direction of the first alignment film,
the first substrate including:
a second alignment film covering the line-like partitions, and having a surface contacting the liquid crystal layer, and having an alignment capability of aligning the liquid crystal molecules in the particular alignment direction.

24. The liquid crystal display according to claim 23, wherein
the line-like partitions are first line-like partitions,
the first substrate further includes second line-like partitions arranged between the line-like segments of the first pixel electrode and extending in the direction substantially parallel to the direction of the first alignment film, and
the second alignment film further covers the second line-like partitions.

25. The liquid crystal display according to claim 23, wherein
the line-like partitions are formed only in partial regions on the line-like segments of the first pixel electrode.

26. The liquid crystal display according to claim 23, wherein
the liquid crystal layer is made of negative-type liquid crystal.

27. The liquid crystal display according to claim 23, wherein
the line-like partitions each have a height of two-thirds or more of a gap between a part of the first substrate other than the line-like partitions and the second alignment film, and the second substrate.

28. The liquid crystal display according to claim 24, wherein
the second line-like partitions each have a height of two-thirds or more of a gap between a part of the first substrate other than the first line-like partitions, the second line-like partitions and the second alignment film, and the second substrate.

29. The liquid crystal display according to claim 23, wherein
the second alignment film is a photo-alignment film.

30. The liquid crystal display according to claim 23, wherein
the second alignment film has a side surface pointed in a direction tilted from an extension direction of the first substrate and subjected to alignment process using an ultraviolet ray.

31. A liquid crystal display comprising:
a first substrate;
a second substrate; and
a liquid crystal layer caught between the first substrate and the second substrate and containing liquid crystal molecules,
the first substrate including:
a first alignment film having a main surface forming a main surface of the first substrate, contacting the liquid crystal layer, and having an alignment capability of aligning the liquid crystal molecules in a particular alignment direction;
a first pixel electrode with line-like segments extending in a particular direction; and
a second pixel electrode with a sheet-like electrode involved in a field from the first pixel electrode,
the first substrate further including:
an insulating film that separates the first pixel electrode from the second pixel electrode in the thickness direction of the first substrate to insulate the first pixel electrode from the second pixel electrode,
the first substrate including:
line-like partitions arranged between the line-like segments of the first pixel electrode and extending in a direction substantially parallel to a direction of the first alignment film,
the first substrate including:
a second alignment film covering the line-like partitions, and having a surface contacting the liquid crystal layer, and having an alignment capability of aligning the liquid crystal molecules in the particular alignment direction.

32. The liquid crystal display according to claim 31, wherein
the line-like partitions each have a height of two-thirds or more of a gap between a part of the first substrate other than the line-like partitions and the second alignment film, and the second substrate.

33. The liquid crystal display according to claim 31, wherein
the second alignment film has a side surface pointed in a direction tilted from an extension direction of the first substrate and subjected to alignment process using an ultraviolet ray.
